(19) United States
(12) Patent Application Publication
(10) Pub. No.: US 2019/0363411 A1
(43) Pub. Date: Nov. 28, 2019

(54) DEVICE TEMPERATURE REGULATOR

(71) Applicant: DENSO CORPORATION, Kariya-city (JP)

(72) Inventors: Masayuki TAKEUCHI, Kariya-city (JP); Yasumitsu OMI, Kariya-city (JP); Takeshi YOSHINORI, Kariya-city (JP); Koji MIURA, Kariya-city (JP)

(21) Appl. No.: 16/537,225

(22) Filed: Aug. 9, 2019

Related U.S. Application Data
(63) Continuation of application No. PCT/JP2018/004464, filed on Feb. 8, 2018.

(30) Foreign Application Priority Data
Mar. 16, 2017 (JP) 2017-051489
Jun. 22, 2017 (JP) 2017-122281
Jul. 12, 2017 (JP) 2017-136552
Dec. 7, 2017 (JP) 2017-235120

(51) Int. Cl. H01M 10/6569; H01M 10/63; H01M 10/625; H01M 10/6552; H01M 10/6568; H01M 10/6566

(52) U.S. Cl. CPC H01M 10/6569; H01M 10/63; H01M 10/625; B60K 11/04; H01M 10/6568; H01M 10/6566; H01M 10/6552

(57) ABSTRACT

A device heat exchanger is capable of exchanging heat between a target device and a working fluid. A condenser may be disposed above the device heat exchanger in the gravitational direction, a gas phase passage communicates the condenser with an upper connection portion of the device heat exchanger, and a liquid phase passage communicates the condenser with a lower connection portion of the device heat exchanger. A fluid passage communicates the upper connection portion of the device heat exchanger with the lower connection portion of the device heat exchanger, without including the condenser on a route of the fluid passage. A heating portion is capable of heating the liquid-phase working fluid flowing through the fluid passage, and a controller operates the heating portion when heating the target device and stops an operation of the heating portion when cooling the target device.

### CROSS REFERENCE TO RELATED APPLICATION

The present application is a continuation application of International Patent Application No. PCT/JP2018/004464 filed on Feb. 8, 2018, which designated the U.S. and claims the benefit of priority from Japanese Patent Applications No. 2017-051489 filed on Mar. 16, 2017, No. 2017-122281 filed on Jun. 22, 2017, No. 2017-136552 filed on Jul. 12, 2017, and No. 2017-235120 filed on Dec. 7, 2017. The entire disclosures of all of the above applications are incorporated herein by reference.

### TECHNICAL FIELD

The present disclosure relates to a device temperature regulator for regulating the temperature of a target device.

### BACKGROUND

Conventionally, there is a known device temperature regulator that regulates the temperature of a target device using a loop thermosiphon system. The device temperature regulator may include a device heat exchanger that exchanges heat between an assembled battery as a target device and a working fluid, and a condenser disposed above the device heat exchanger.

### SUMMARY

According to an aspect of the present disclosure, a device temperature regulator may be configured to regulate a temperature of a target device by a phase change between a liquid phase and a gas phase of a working fluid. A fluid passage that communicates an upper connection portion of the device heat exchanger with a lower connection portion of the device heat exchanger may be provided without including a condenser on a route of the fluid passage, a heating portion may be capable of heating the liquid-phase working fluid flowing through the fluid passage, and a controller may be configured to operate the heating portion when heating the target device, and to stop an operation of the heating portion when cooling the target device.

According to another aspect of the present disclosure, a device temperature regulator may include a fluid passage that communicates an upper connection portion of a device heat exchanger with a lower connection portion of the device heat exchanger, a heating portion configured to be capable of heating the liquid-phase working fluid flowing through the fluid passage, and a controller configured to operate the heating portion when heating the target device. The heating portion may be provided in a portion of the fluid passage that extends vertically in the gravitational direction.

According to another aspect of the present disclosure, a device temperature regulator may include a fluid passage that communicates an upper connection portion of a device heat exchanger with a lower connection portion of the device heat exchanger, and a heat supply member provided in the fluid passage at a position in a height direction that overlaps a height of a liquid level of the working fluid inside the device heat exchanger. The heat supply member may be capable of selectively supplying cold heat or hot heat to the working fluid flowing through the fluid passage.

### BRIEF DESCRIPTION OF DRAWINGS

FIG. 1 is a configuration diagram of a device temperature regulator according to a first embodiment;

FIG. 2 is a perspective view of a device heat exchanger included in the device temperature regulator;

FIG. 3 is a cross-sectional view taken along the line III-Ill of FIG. 1;

FIG. 4 is a cross-sectional view taken along the line IV-IV of FIG. 3;

FIG. 5 is a graph for explaining output characteristics of an assembled battery;

FIG. 6 is a graph for explaining input characteristics of the assembled battery;

FIG. 7 is an explanatory diagram for explaining the flow of a working fluid formed when cooling a target device;

FIG. 8 is an explanatory diagram for explaining the flow of a working fluid formed when warming up the target device;

FIG. 9 is a configuration diagram of a device temperature regulator according to a second embodiment;

FIG. 10 is a configuration diagram of a device temperature regulator according to a third embodiment;

FIG. 11 is a configuration diagram of a device temperature regulator according to a fourth embodiment;

FIG. 12 is a configuration diagram of a device temperature regulator according to a fifth embodiment;

FIG. 13 is a configuration diagram of the device temperature regulator according to the fifth embodiment;

FIG. 14 is a configuration diagram of a device temperature regulator according to a sixth embodiment;

FIG. 15 is a configuration diagram of a device temperature regulator according to a seventh embodiment;

FIG. 16 is a configuration diagram of a device temperature regulator according to an eighth embodiment;

FIG. 17 is a configuration diagram of a device temperature regulator according to a ninth embodiment;

FIG. 18 is a configuration diagram of a device temperature regulator according to a tenth embodiment;

FIG. 19 is a configuration diagram of a device temperature regulator according to an eleventh embodiment;

FIG. 20 is a configuration diagram of a device temperature regulator according to a twelfth embodiment;

FIG. 21 is a configuration diagram of a device temperature regulator according to a thirteenth embodiment;

FIG. 22 is a configuration diagram of a device temperature regulator according to a fourteenth embodiment;

FIG. 23 is a cross-sectional view of a device heat exchanger included in a device temperature regulator according to a fifteenth embodiment;

FIG. 24 is a cross-sectional view of a device heat exchanger included in a device temperature regulator according to a sixteenth embodiment;

FIG. 25 is a cross-sectional view of a device heat exchanger included in a device temperature regulator according to a seventeenth embodiment;

FIG. 26 is a cross-sectional view of a device heat exchanger included in a device temperature regulator according to an eighteenth embodiment;

FIG. 27 is a configuration diagram of a device temperature regulator according to a nineteenth embodiment;

FIG. 28 is a cross-sectional view of a part of the device temperature regulator according to the nineteenth embodiment;

FIG. 29 is a configuration diagram of a device temperature regulator according to a twentieth embodiment;

FIG. 30 is a configuration diagram of the device temperature regulator according to the twentieth embodiment;

FIG. 31 is a cross-sectional view of a part of a device temperature regulator according to a twenty-first embodiment;

FIG. 32 is a configuration diagram of a device temperature regulator according to a twenty-second embodiment;

FIG. 33 is a configuration diagram of a device temperature regulator according to a twenty-third embodiment;

FIG. 34 is an explanatory diagram for explaining the flow of a working fluid formed when the target device is warmed up;

FIG. 35 is a cross-sectional view of the device heat exchanger when the driving of the heating portion is stopped;

FIG. 36 is a cross-sectional view of the device heat exchanger when the heating portion is driven;

FIG. 37 is a cross-sectional view of the device heat exchanger immediately after the driving of the heating portion is stopped;

FIG. 38 is a flowchart showing warming-up control processing in the twenty-third embodiment;

FIG. 39 is a graph showing changes in the temperature distribution of the target device during warm-up in the twenty-third embodiment;

FIG. 40 is a flowchart of warming-up control processing in a twenty-fourth embodiment;

FIG. 41 is a cross-sectional view of the device heat exchanger when driving of the heating portion is stopped;

FIG. 42 is a cross-sectional view of the device heat exchanger when the heating portion is driven;

FIG. 43 is a cross-sectional view of the device heat exchanger when the heating capacity of the heating portion is decreased;

FIG. 44 is a configuration diagram of a device temperature regulator according to a twenty-fifth embodiment;

FIG. 45 is a configuration diagram of a device temperature regulator according to a twenty-sixth embodiment;

FIG. 46 is a configuration diagram of a device temperature regulator according to a twenty-seventh embodiment;

FIG. 47 is a configuration diagram of the device temperature regulator according to the twenty-seventh embodiment;

FIG. 48 is a configuration diagram of a device temperature regulator according to a twenty-eighth embodiment;

FIG. 49 is a configuration diagram of the device temperature regulator according to the twenty-eighth embodiment;

FIG. 50 is a configuration diagram of a device temperature regulator according to a twenty-ninth embodiment;

FIG. 51 is a configuration diagram of the device temperature regulator according to the twenty-ninth embodiment;

FIG. 52 is a configuration diagram of a device temperature regulator according to a thirtieth embodiment;

FIG. 53 is a configuration diagram of the device temperature regulator according to the thirtieth embodiment;

FIG. 54 is a configuration diagram of a device temperature regulator according to a thirty-first embodiment;

FIG. 55 is a configuration diagram of the device temperature regulator according to the thirty-first embodiment;

FIG. 56 is a configuration diagram of a device temperature regulator according to a thirty-second embodiment;

FIG. 57 is a configuration diagram of the device temperature regulator according to the thirty-second embodiment;

FIG. 58 is a configuration diagram of a device temperature regulator according to a thirty-third embodiment; and

FIG. 59 is a configuration diagram of a device temperature regulator according to a thirty-fourth embodiment.

### DESCRIPTION OF EMBODIMENTS

A device temperature regulator of a comparative example of the present disclosure may include a device heat exchanger that exchanges heat between an assembled battery as a target device and a working fluid, a condenser disposed above the device heat exchanger in the gravitational direction, and a gas phase passage and a liquid phase passage each of which connects the device heat exchanger and the condenser. In addition, the device temperature regulator also may include a heating portion that is capable of heating the working fluid, inside the device heat exchanger.

In the device temperature regulator described above, when cooling the assembled battery, the working fluid inside the device heat exchanger absorbs heat from the assembled battery to evaporate, and then flows into the condenser through the gas phase passage. The liquid-phase working fluid condensed in the condenser flows into the device heat exchanger through the liquid phase passage. In this way, the device temperature regulator is configured to cool the assembled battery by the circulation of the working fluid.

The device temperature regulator may heat the working fluid by the heating portion provided inside the device heat exchanger when warming up the assembled battery. The heated working fluid may be vaporized inside the device heat exchanger and thereafter condensed by dissipating its heat into the assembled battery. In this way, the device temperature regulator is configured to heat the assembled battery by the phase change of the working fluid inside the device heat exchanger.

The device temperature regulator may be provided with the heating portion inside the device heat exchanger. In this case, when warming up the assembled battery, the working fluid located in the vicinity of the heating portion may be locally vaporized inside the device heat exchanger, while the working fluid located far from the heating portion may not be heated in some cases. Thus, in this device temperature regulator, variations in the temperature of the working fluid may become significant inside the device heat exchanger, so that the device temperature regulator may have difficulty in uniformly warming up the assembled battery. Consequently, some battery cells constituting the assembled battery might not be sufficiently warmed up, thus resulting in degraded input and output characteristics of the assembled battery, and thereby leading to the degradation or breakage of the assembled battery.

In the device temperature regulator described above, evaporation and condensation of the working fluid may occur only inside the device heat exchanger when warming up the assembled battery. That is, the working fluid vaporized by being heated in the heating portion inside the device heat exchanger flows upward in the gravitational direction, and then the working fluid condensed by dissipating heat into the assembled battery flows downward in the gravitational direction. Therefore, since the liquid-phase working fluid and the gas-phase working fluid are caused to flow facing each other, the circulation of the working fluid might be inhibited inside the device heat exchanger to impair the warm-up efficiency of the assembled battery. The above-mentioned issues may be not limited to the case where the target device is the assembled battery and are considered to occur in other devices in the same manner.

The present disclosure is to provide a device temperature regulator capable of regulating a temperature of a target device with high efficiency.

According to an exemplar embodiment of the present disclosure, a device temperature regulator may be configured to regulate a temperature of a target device by a phase change between a liquid phase and a gas phase of a working fluid. The device temperature regulator may include: a device heat exchanger configured to be capable of exchanging heat between the target device and the working fluid such that the working fluid evaporates when cooling the target device and that the working fluid condenses when warming up the target device; an upper connection portion into or from which the working fluid flows, the upper connection portion being provided in a portion of the device heat exchanger at an upper side in a gravitational direction; a lower connection portion into or from which the working fluid flows, the lower connection portion being provided in a portion of the device heat exchanger at a position lower than the upper connection portion in the gravitational direction; a condenser disposed above the device heat exchanger in the gravitational direction, the condenser being configured to condense the working fluid by dissipating heat from the working fluid evaporated by the device heat exchanger; a gas phase passage that communicates an inflow port through which a gas-phase working fluid flows into the condenser with the upper connection portion of the device heat exchanger; a liquid phase passage that communicates an outflow port, through which a liquid-phase working fluid flows from the condenser, with the lower connection portion of the device heat exchanger; a fluid passage that communicates the upper connection portion of the device heat exchanger with the lower connection portion of the device heat exchanger, without including the condenser in a route of the fluid passage; a heating portion being capable of heating the liquid-phase working fluid flowing through the fluid passage; and a controller configured to operate the heating portion when heating the target device, and to stop an operation of the heating portion when cooling the target device.

According to another an exemplar embodiment of the present disclosure, a device temperature regulator may be configured to regulate a temperature of a target device by a phase change between a liquid phase and a gas phase of a working fluid. The device temperature regulator may include: a device heat exchanger configured to be capable of exchanging heat between the target device and the working fluid such that the working fluid condenses when warming up the target device; an upper connection portion into or from which the working fluid flows, the upper connection portion being provided in a portion of the device heat exchanger at an upper side in a gravitational direction of the device heat exchanger; a lower connection portion into or from which the working fluid flows, the lower connection portion being provided in a portion of the device heat exchanger at a position lower than the upper connection portion in the gravitational direction; a fluid passage that communicates the upper connection portion of the device heat exchanger with the lower connection portion of the device heat exchanger; a heating portion configured to be capable of heating the liquid-phase working fluid flowing through the fluid passage; and a controller configured to operate the heating portion when heating the target device.

According to another exemplar embodiment of the present disclosure, a device temperature regulator may be configured to regulate a temperature of a target device by a phase change between a liquid phase and a gas phase of a working fluid. The device temperature regulator may include: a device heat exchanger configured to be capable of exchanging heat between the target device and the working fluid such that the working fluid evaporates when cooling the target device and that the working fluid condenses when warming up the target device; an upper connection portion into or from which the working fluid flows, the upper connection portion being provided in a portion of the device heat exchanger at an upper side in a gravitational direction; a lower connection portion into or from which the working fluid flows, the lower connection portion being provided in a portion of the device heat exchanger at a position lower than the upper connection portion in the gravitational direction; a fluid passage that communicates the upper connection portion of the device heat exchanger with the lower connection portion of the device heat exchanger; and a heat supply member provided in the fluid passage at a position in a height direction that overlaps a height of a liquid level of the working fluid inside the device heat exchanger. The heat supply member may be capable of selectively supplying cold heat or hot heat to the working fluid flowing through the fluid passage.

Hereinafter, detail embodiments of the present disclosure will be described with reference to the accompanying drawings. Note that in the following respective embodiments, the same or equivalent parts are indicated by the same reference characters throughout the figures, and thus the description thereof will be omitted.

### First Embodiment

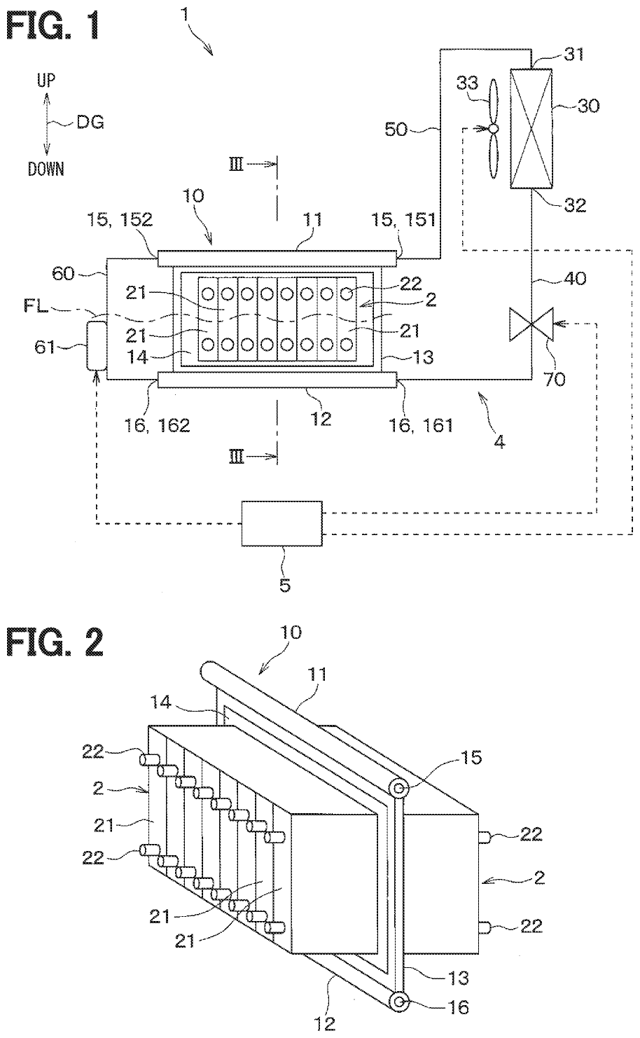

A device temperature regulator of the present embodiment is mounted on electric vehicles (hereinafter simply referred to as “vehicles”), such as electric cars or hybrid cars. As shown in FIG. 1, a device temperature regulator 1 functions as a cooling device that cools a secondary battery 2 (hereinafter referred to as an “assembled battery 2”) mounted on the vehicle. The device temperature regulator 1 also functions as a warm-up device that warms up the assembled battery 2.

Now, the assembled battery 2 as a target device that is to be temperature-regulated by the device temperature regulator 1 will be described.

In a vehicle with the device temperature regulator 1 mounted thereon, an electric power stored in a power storage device (in other words, a battery pack), which includes the assembled battery (batteries) 2 as a main component, is supplied to a vehicle running motor via an inverter or the like. The assembled battery 2 self-generates heat when being supplied with an electric power, for example, during the travel of the vehicle. When the temperature of the assembled battery 2 becomes high, the assembled battery 2 cannot only exhibit its function sufficiently, but also deteriorates acceleratedly. Thus, to lessen the self-generated heat, the output and input of the assembled battery 2 has to be restricted. For this reason, a cooler is required to keep the assembled battery 2 at a predetermined temperature or lower in order to secure the output and input of the assembled battery 2.

In seasons when the outside air temperature is high, such as summer, the battery temperature rises during parking and leaving of the vehicle as well as during the travel of the vehicle. As the assembled battery 2 is disposed, for example, under the floor or trunk room of the vehicle in many cases, the amount of heat per unit time applied to the assembled battery 2 is not so significant. However, the battery temperature gradually rises when being left under some conditions for a long time. If the assembled battery 2 is left under a high temperature, then the lifetime of the assembled battery 2 is shortened. Thus, the assembled battery 2 is desired to have its temperature maintained at the predetermined temperature or lower even during the parking of the vehicle or the like.

The assembled battery 2 is constituted of a plurality of battery cells 21. If the temperatures of the battery cells 21 are varied differently, the battery cells 21 deteriorate unevenly, so that the electrical energy storage performance of the assembled battery 2 is degraded. This is because the assembled battery 2 includes a series connection of the battery cells 21, whereby the input and output characteristics of the assembled battery 2 are determined in accordance with the characteristics of the most deteriorated battery cell 21. For this reason, to make the assembled battery 2 exhibit the desired performance over a long period of time, it is important to equalize the temperatures of the plurality of battery cells 21, specifically, to reduce variations in the temperature among the plurality of battery cells 21.

In general, air-cooled cooling means with a blower or any cooling means using cold heat in a vapor compression refrigeration cycle is used as another cooling device for cooling the assembled battery 2. However, the air-cooled cooling means with the blower blows only the air inside the vehicle cabin and thus has a low cooling capacity. In addition, the blowing with the blower cools the assembled battery 2 by sensible heat of the air, so that a temperature difference between the upstream and downstream of the air flow becomes larger. Consequently, variations in the temperature among the plurality of battery cells 21 cannot be suppressed sufficiently. The cooling means using the cold heat of the refrigeration cycle has a high cooling capacity, but needs the driving of a compressor or the like which consumes more electric power during parking of the vehicle. This leads to an increase in the power consumption, an increase in noise, and the like. Thus, the above-mentioned cooling means is not preferable.

The device temperature regulator 1 of the present embodiment employs a thermosiphon system that regulates the temperature of the assembled battery 2 by the natural circulation of the working fluid without forcedly circulating any working fluid by a compressor.

Next, the configuration of the device temperature regulator 1 will be described. As shown in FIG. 1, the device temperature regulator 1 includes a fluid circulation circuit 4 in which the working fluid circulates, and a controller 5 that controls the operation of the fluid circulation circuit 4.

The fluid circulation circuit 4 is a heat pipe that transfers heat by evaporation and condensation of the working fluid. In detail, the fluid circulation circuit 4 is a loop thermosiphon in which a flow passage for causing a gas-phase working fluid to flow is separated from a flow passage for causing a liquid-phase working fluid to flow. The fluid circulation circuit 4 is configured as a closed fluid circuit in which a device heat exchanger 10, a condenser 30, a liquid phase passage 40, a gas phase passage 50, a fluid passage 60, and the like are connected to each other. The fluid passage 60 is provided with a heating portion 61 for heating the working fluid.

A predetermined amount of working fluid is sealed in the fluid circulation circuit 4 that has its inside evacuated. For example, a chlorofluorocarbon refrigerant, such as HFO-1234yf or HFC-134a used in a vapor compression refrigeration cycle, is adopted as the working fluid. The arrow DG shown in FIG. 1 indicates the gravitational direction in a state where the fluid circulation circuit 4 is mounted on the vehicle.

The charging amount of the working fluid into the fluid circulation circuit 4 is adjusted such that a liquid level of the working fluid is formed in the vicinity of the center in the height direction of the device heat exchanger 10 during warm-up to be described later. FIG. 1 shows an example of the height of the liquid level during warm-up by a dashed-dotted line FL.

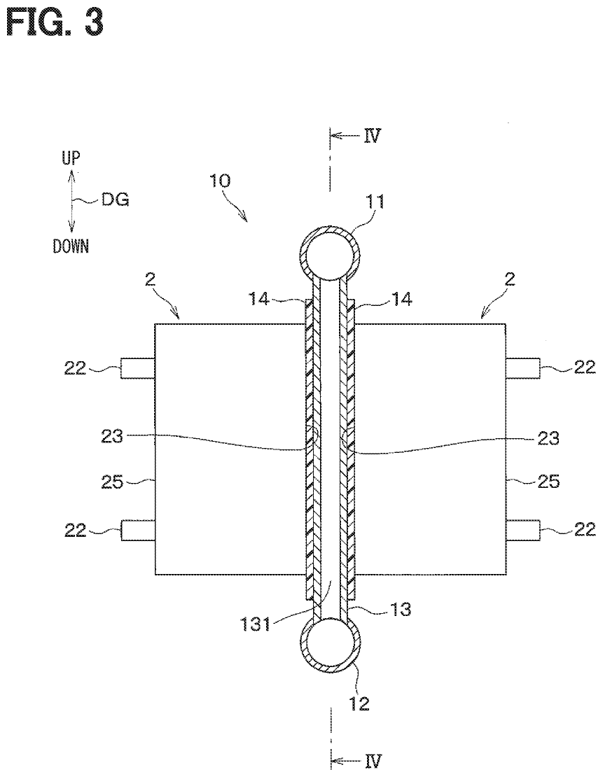

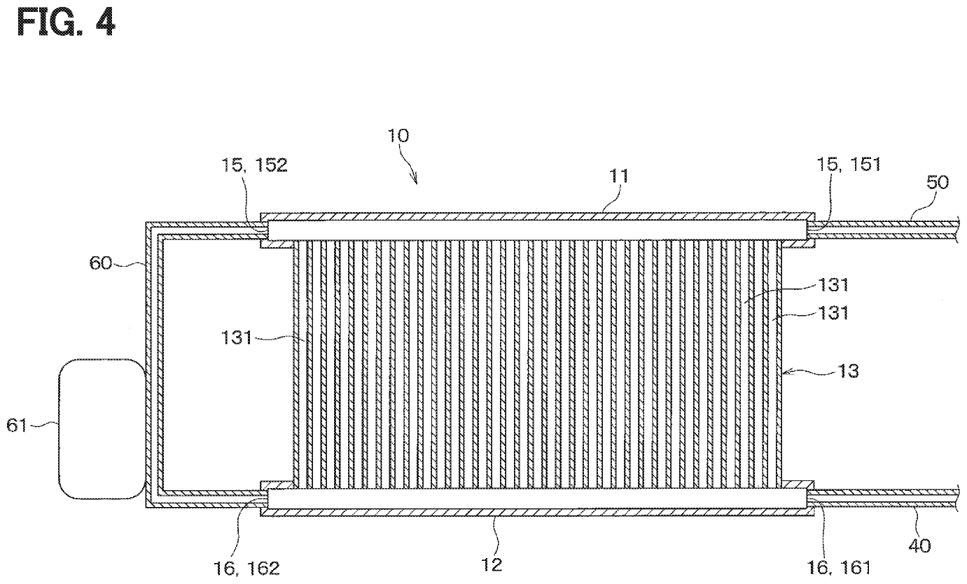

As shown in FIGS. 2 to 4, the device heat exchanger 10 includes a cylindrical upper tank 11, a cylindrical lower tank 12, and a plurality of tubes 131 having flow passages for communicating the upper tank 11 and the lower tank 12. Instead of the plurality of tubes 131, the upper tank 11 and the lower tank 12 may be connected together by a plate-shaped member in which a plurality of flow passages are formed. Each constituent member of the device heat exchanger 10 is formed of metal that has high thermal conductivity, such as aluminum or copper. It should be noted that each of the constituent members of the device heat exchanger 10 can also be made of material that has high thermal conductivity other than metal. A portion of the device heat exchanger 10 composed of the plurality of tubes 131 or plate-shaped member is hereinafter referred to as a heat exchanging portion 13.

The upper tank 11 is positioned on the upper side in the gravitational direction of the device heat exchanger 10. The lower tank 12 is positioned on the lower side in the gravitational direction of the device heat exchanger 10.

The assembled battery 2 is installed outside the heat exchanging portion 13 via an electrically insulating, heat conductive sheet 14. The heat conductive sheet 14 ensures insulation between the heat exchanging portion 13 and the assembled battery 2 and reduces the thermal resistance between the heat exchanging portion 13 and the assembled battery 2. In the present embodiment, the assembled battery 2 is installed such that a surface 23 of the assembled battery 2 opposite to a surface 25 thereof with terminals 22 provided thereon is installed onto the heat exchanging portion 13 via the heat conductive sheet 14. The plurality of battery cells 21 constituting the assembled battery 2 are arranged in a direction intersecting with the gravitational direction. Thus, the plurality of battery cells 21 are uniformly cooled and heated by heat exchange with the working fluid inside the device heat exchanger 10.

As mentioned in the following fifteenth to eighteenth embodiments, a method of installing the assembled battery 2 is not limited to that shown in FIGS. 1 to 3. Alternatively, another surface of the assembled battery 2 may be set on the heat exchanging portion 13 via the heat conductive sheet 14. The number, shape, and the like of each of the battery cells 21 included in the assembled battery 2 are not limited to those shown in FIGS. 1 to 3. The number, shape, and the like of the battery cells 21 may be arbitrarily selected.

The device heat exchanger 10 is provided with an upper connection portion 15 and a lower connection portion 16. Both the upper connection portion 15 and the lower connection portion 16 are pipe connection portions for causing the working fluid to flow into or out of the device heat exchanger 10.

The upper connection portion 15 is provided in a portion on the upper side in the gravitational direction of the device heat exchanger 10. In the present embodiment, the upper connection portions 15 are provided on both sides of the upper tank 11. In the description below, the upper connection portion 15 provided at one end of the upper tank 11 is referred to as a first upper connection portion 151, and the upper connection portion 15 provided at the other end of the upper tank 11 is referred to as a second upper connection portion 152.

The lower connection portion 16 is provided in a portion on the lower side in the gravitational direction of the device heat exchanger 10. In the present embodiment, the lower connection portions 16 are provided on both sides of the lower tank 12. In the description below, the lower connection portion 16 provided at one end of the lower tank 12 is referred to as a first lower connection portion 161, and the lower connection portion 16 provided at the other end of the lower tank 12 is referred to as a second lower connection portion 162.

The gas phase passage 50 is connected to the first upper connection portion 151. The gas phase passage 50 is a passage that communicates an inflow port 31 of the condenser 30 with the first upper connection portion 151 of the device heat exchanger 10. The liquid phase passage 40 is connected to the first lower connection portion 161. The liquid phase passage 40 is a passage through which an outflow port 32 of the condenser 30 communicates with the first lower connection portion 151 of the device heat exchanger 10. The gas phase passage 50 and the liquid phase passage 40 are named for convenience, and do not mean passages through which only the gas-phase or liquid-phase working fluid flows. That is, both the gas phase and the liquid-phase working fluids may flow through each of the gas phase passage 50 and the liquid phase passage 40. The shape and the like of the gas phase passage 50 and the liquid phase passage 40 can be appropriately changed in consideration of the mountability on the vehicle.

The condenser 30 is disposed above the device heat exchanger 10 in the gravitational direction. The inflow port 31 is provided in a portion on the upper side of the condenser 30, and the outflow port 32 is provided in a portion on the lower side of the condenser 30. The condenser 30 is a heat exchanger for exchanging heat between a predetermined heat-receiving fluid and the gas-phase working fluid flowing from the inflow port 31 into the inside of the condenser 30 through the gas phase passage 50.

The condenser 30 of the present embodiment is an air-cooled heat exchanger that exchanges heat between the air blown from a blower fan 33 and the gas-phase working fluid. That is, in the present embodiment, the predetermined heat-receiving fluid is air. As described in embodiments below, the heat-receiving fluid is not limited to air, and various fluids, such as a refrigerant circulating in a refrigeration cycle or a coolant circulating in a coolant circuit, can be used.

The blower fan 33 can cause the air outside the vehicle cabin or inside the vehicle cabin to flow toward the condenser 30. The blower fan 33 has a blowing capacity controlled based on a control signal from the controller 5. The gas-phase working fluid is condensed by dissipating heat into the air passing through the condenser 30. The working fluid which is brought into the liquid phase flows down from the outflow port 32 through the liquid phase passage 40 by its own weight and then flows into the device heat exchanger 10.

A fluid control valve 70 capable of blocking the flow of the working fluid passing through the liquid phase passage 40 is provided at any point in the liquid phase passage 40. The fluid control valve 70 of the present embodiment is a solenoid valve and has its flow passage cross-sectional area adjusted in accordance with a control signal transmitted from the controller 5. When the fluid control valve 70 blocks the flow of the working fluid passing through the liquid phase passage 40, the liquid-phase working fluid is retained in a region from the liquid phase passage 40 up to the condenser 30, which is located above the fluid control valve 70 in the gravitational direction. Thereafter, the heat dissipation of the working fluid is suppressed or substantially stopped by the condenser 30. Therefore, the fluid control valve 70 functions as a heat dissipation suppressing portion capable of suppressing the heat dissipation of the working fluid in the condenser 30.

The fluid passage 60 is connected to a second upper connection portion 152 and a second lower connection portion 162. The fluid passage 60 is a passage that connects the upper connection portion 15 and the lower connection portion 16 in the device heat exchanger 10 without including the condenser 30 on its route. Thus, the fluid passage 60 is also referred to as a bypass passage. As described later in a twentieth embodiment, the fluid passage 60 is not limited to one that connects the second upper connection portion 152 and the second lower connection portion 162, and may connect any point of the gas phase passage 50 with any point of the liquid phase passage 40.

The fluid passage 60 is provided with the heating portion 61 that is capable of heating the liquid-phase working fluid flowing through the fluid passage 60. The heating portion 61 of the present embodiment is constituted of an electric heater which generates heat by energization. The on/off of the energization of the heating portion 61 is controlled in accordance with a control signal from the controller 5. The heating portion 61 is provided in a portion of the fluid passage 60 that extends vertically. Thus, when the heating portion 61 heats the working fluid in the fluid passage 60, the working fluid that has become steam flows through the fluid passage 60 upward in the gravitational direction, and then flows from the second upper connection portion 152 into the device heat exchanger 10.

The controller 5 is constituted of a microcomputer, including a processor and a memory (for example, ROM and RAM) and peripheral circuits thereof. Note that the memory of the controller 5 is constituted of a non-transitory substantive storage medium. The controller 5 controls the operations of respective devices included in the above-mentioned fluid circulation circuit 4, such as the heating portion 61, the blower fan 33, and the fluid control valve 70.

Subsequently, the operation of the device temperature regulator 1 will be described.

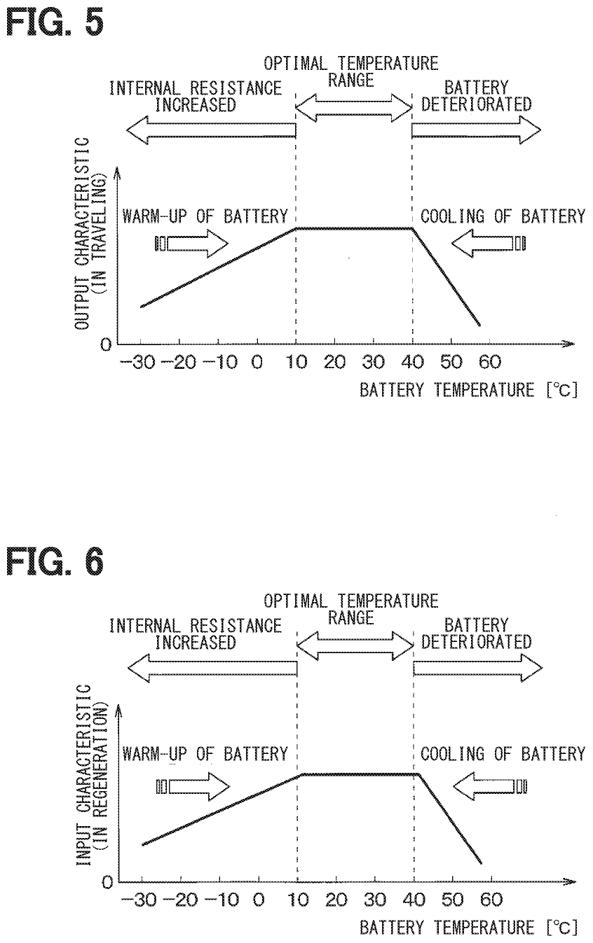

As shown in FIGS. 5 and 6, when the temperature of the assembled battery 2 becomes lower than any temperature in a predetermined optimal temperature range, the assembled battery 2 has its internal resistance increased, resulting in degraded output and input characteristics. When the temperature of the assembled battery 2 becomes higher than any temperature in the predetermined optimal temperature range, the assembled battery 2 might be deteriorated or broken while the output and input characteristics thereof are degraded. Thus, in order for the assembled battery 2 to exhibit a desired performance, it is necessary to warm up the assembled battery 2 when the temperature of the assembled battery 2 is lower than any temperature in the predetermined optimum temperature range, and to cool the assembled battery 2 when the temperature of the assembled battery 2 is higher than any temperature in the predetermined optimum temperature range.

### <Operation During Cooling>

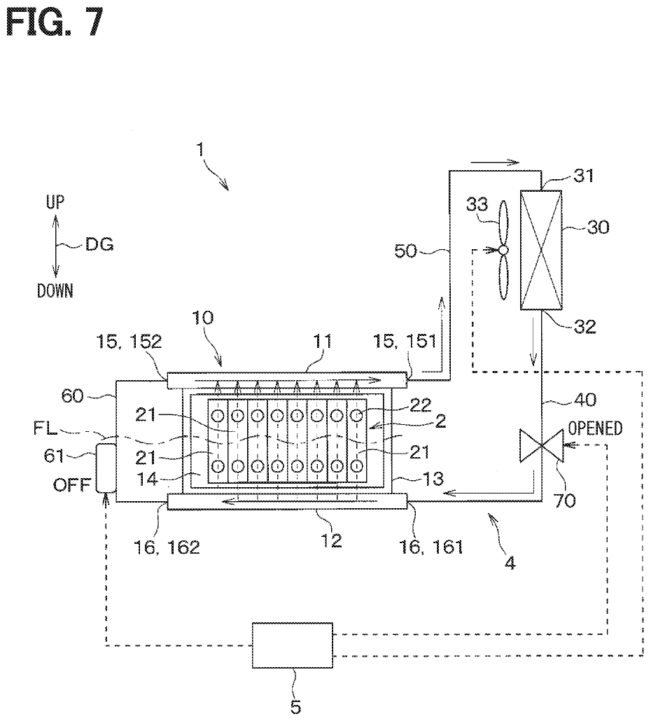

FIG. 7 shows the flows of the working fluid formed when the device temperature regulator 1 cools the assembled battery 2 by solid line and broken line arrows. When cooling the assembled battery 2, the controller 5 turns off the energization of the heating portion 61 and stops the operation of the heating portion 61. The controller 5 opens the fluid control valve 70 to cause the working fluid to flow into the liquid phase passage 40. While the vehicle is stopping, the controller 5 turns on a power source of the blower fan 33 to blow air to the condenser 30. However, when the vehicle is traveling, the controller 5 turns off the power source of the blower fan 33 because the traveling air flows to the condenser 30.

Consequently, the liquid-phase working fluid condensed in the condenser 30 flows through the liquid phase passage 40 by its own weight and then flows into the lower tank 12 of the device heat exchanger 10 from the first lower connection portion 161. The working fluid flowing into the lower tank 12 is divided into a plurality of tubes 131 constituting the heat exchanging portion 13 and then evaporates by exchanging heat with each of the battery cells 21 constituting the assembled battery 2. The battery cells 21 in this process are cooled by the latent heat of evaporation of the working fluid. Thereafter, the working fluids in the gas phase are merged together in the upper tank 11 of the device heat exchanger 10 to flow to the condenser 30 from the first upper connection portion 151 through the gas phase passage 50.

As mentioned above, when cooling the assembled battery 2, the working fluid flows from the condenser 30 to the liquid phase passage 40, the lower tank 12, the heat exchanging portion 13, the upper tank 11, the gas phase passage 50, and the condenser 30 in this order. That is, a loop-shaped flow passage is formed through the device heat exchanger 10 and the condenser 30.

When cooling the assembled battery 2, part of the working fluid is also supplied to the fluid passage 60. However, as the energization of the heating portion 61 is turned off, the working fluid is not vaporized in the fluid passage 60, so that the flow of the working fluid is hardly formed in the fluid passage 60.

### <Operation During Warm-Up>

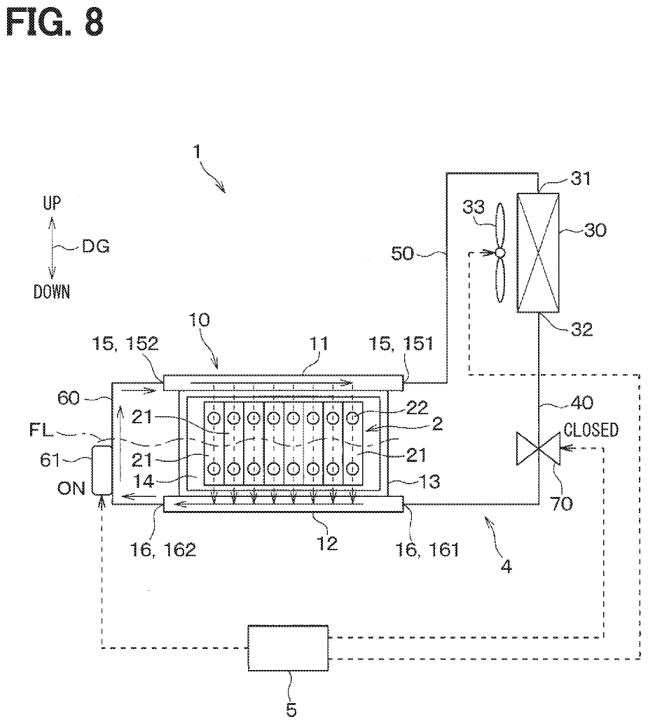

FIG. 8 shows the flows of the working fluid formed when the device temperature regulator 1 warms up the assembled battery 2 by solid line and broken line arrows. When the assembled battery 2 is warmed up, the controller 5 turns on the energization of the heating portion 61 to actuate the heating portion 61. The controller 5 closes the fluid control valve 70, thereby blocking the flow of the working fluid in the liquid phase passage 40.

When the heating portion 61 operates, the working fluid in the fluid passage 60 is vaporized. The steam working fluid flows through the fluid passage 60 upward in the gravitational direction and then flows from the second upper connection portion 152 into the upper tank 11 of the device heat exchanger 10. The gas-phase working fluid has the property of flowing toward a portion having a lower temperature. Thus, the gas-phase working fluid is divided into the plurality of tubes 131 in contact with the battery cells 21 having a low temperature and then condensed by heat exchange with each of the low-temperature battery cells 21. The battery cells 21 in this process are warmed up (i.e., heated) by the latent heat of condensation of the working fluid. Thereafter, the working fluids in the gas phase are merged together in the lower tank 12 of the device heat exchanger 10 and flow from the second lower connection portion 162 to the fluid passage 60. As mentioned above, when warming up the assembled battery 2, the working fluid flows from the fluid passage 60 to the upper tank 11, the heat exchanging portion 13, the lower tank 12, and the fluid passage 60 in this order. That is, the loop-shaped flow passage is formed through the device heat exchanger 10 and the fluid passage 60 without passing through the condenser 30.

When warming up the assembled battery 2, part of the gas-phase working fluid is also supplied to the gas phase passage 50 and the condenser 30. However, as the fluid control valve 70 is closed, the liquid-phase working fluid is retained in a region from the liquid phase passage 40 up to the condenser 30, which is located above the fluid control valve 70 in the gravitational direction. Thus, the heat dissipation of the working fluid by the condenser 30 is suppressed or substantially stopped, so that the flow of the working fluid is hardly formed in the gas phase passage 50 and the liquid phase passage 40.

As mentioned above, during the warm-up, the liquid-phase working fluid is also retained in a region from the liquid phase passage 40 up to the condenser 30, which is located above the fluid control valve 70 in the gravitational direction. In this state, the sealing amount of the working fluid to the fluid circulation circuit 4 and the attachment position of the fluid control valve 70 are adjusted such that the liquid level FL of the working fluid is formed near the center of the heat exchanging portion 13 in the device heat exchanger 10.

The device temperature regulator 1 of the present embodiment reversely switches the flow of the working fluid flowing through the tubes 131 of the device heat exchanger 10 between the cooling time and the warm-up time. In this way, the device temperature regulator 1 regulates the temperature of the assembled battery 2 by the phase change between the liquid phase and the gas phase of the working fluid flowing through the device heat exchanger 10. At this time, the device temperature regulator 1 uses the device heat exchanger 10 as the evaporator during cooling and the device heat exchanger 10 as the condenser 30 during warm-up, thereby enabling the cooling and warm-up using the same device heat exchanger 10.

The device temperature regulator 1 of the present embodiment described above exhibits the following operations and effects.

(1) The device temperature regulator 1 of the present embodiment is configured to heat the working fluid flowing through the fluid passage 60 provided outside the device heat exchanger 10 by using the heating portion 61 when warming up the assembled battery 2. Thus, the steam of the working fluid vaporized in the fluid passage 60 is supplied to the device heat exchanger 10, so that variations in the steam temperature of the working fluid can be suppressed inside the device heat exchanger 10. Therefore, the device temperature regulator 1 can uniformly warm up the assembled battery 2. Consequently, the device temperature regulator can prevent the degradation in the input and output characteristics of the assembled battery 2 and can also suppress the deterioration and breakage of the assembled battery 2.
(2) In the device temperature regulator 1 of the present embodiment, when cooling the assembled battery 2, the working fluid circulates from the condenser 30 to the liquid phase passage 40, the lower connection portion 16, the device heat exchanger 10, the upper connection portion 15, the gas phase passage 50, and the condenser 30 in this order. On the other hand, when warming up the assembled battery 2, the working fluid circulates from the fluid passage 60 to the upper connection portion 15, the device heat exchanger 10, the lower connection portion 16, and the fluid passage 60 in this order. That is, the device temperature regulator 1 forms the loop-shaped flow passage through which the working fluid flows when either cooling or warming up the assembled battery 2. Consequently, the liquid-phase working fluid and the gas-phase working fluid are prevented from flowing through one flow passage while facing each other. Therefore, the device temperature regulator 1 can perform the warm-up and cooling of the assembled battery 2 with high efficiency by smoothly circulating the working fluid.
(3) In the device temperature regulator 1 of the present embodiment, a space for providing the heating portion 61 is ensured in the height direction of the fluid passage 60 that connects the upper connection portion 15 and the lower connection portion 16 in the device heat exchanger 10, thus reducing the need to provide the heating portion 61 under the device heat exchanger 10. Therefore, the device temperature regulator 1 can improve its mountability on the vehicle.
(4) The device temperature regulator 1 of the present embodiment includes the fluid control valve 70 that functions as the heat dissipation suppressing portion capable of suppressing the heat dissipation of the working fluid in the condenser 30. Thus, by closing the fluid control valve 70 when warming up the assembled battery 2, the liquid-phase working fluid is retained in the region from the fluid control valve 70 to the condenser 30, thereby suppressing the heat dissipation of the working fluid by the condenser 30. Together with this, the circulation of the working fluid through the gas phase passage 50, the condenser 30, and the liquid phase passage 40 is suppressed. Thus, the working fluid can flow through the loop on the fluid passage 60 side when warming up the assembled battery 2. Therefore, the device temperature regulator 1 can perform the warm-up of the assembled battery 2 with high efficiency by smoothly circulating the working fluid.
(5) In the present embodiment, the heating portion 61 is provided in a portion of the fluid passage 60 that extends vertically. Thus, the working fluid heated and vaporized by the heating portion 61 quickly flows through the fluid passage 60 upward in the gravitational direction. Due to this, the gas-phase working fluid is prevented from flowing backward from the fluid passage 60 to the second lower connection portion 162 side. Therefore, the device temperature regulator 1 can perform the warm-up of the assembled battery 2 with high efficiency by smoothly circulating the working fluid. Thus, only the differences from the first embodiment will be described below.

### Second Embodiment

A second embodiment will be described. The second embodiment is obtained by changing the configuration for cooling the working fluid within the device temperature regulator 1 in the first embodiment and is substantially the same as the first embodiment in other configurations of the device temperature regulator 1. Thus, only the differences from the first embodiment will be described below.

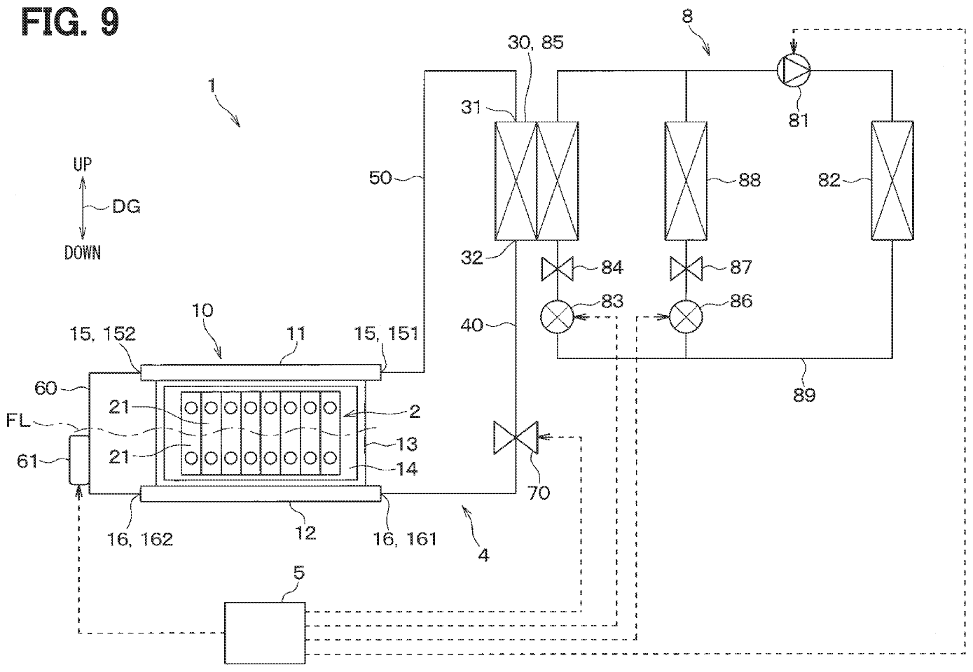

As shown in FIG. 9, the device temperature regulator 1 of the second embodiment includes a refrigeration cycle 8. The refrigeration cycle 8 includes a compressor 81, a high-pressure side heat exchanger 82, a first flow rate restriction portion 83, a first expansion valve 84, a refrigerant-working fluid heat exchanger 85, a second flow rate restriction portion 86, a second expansion valve 87, a low-pressure side heat exchanger 88, and a refrigerant pipe 89 connecting these components. The refrigerant used in the refrigeration cycle 8 may be the same as or different from the working fluid used in the device temperature regulator 1.

The compressor 81 draws and compresses the refrigerant from the refrigerant pipes 89 on the refrigerant-working fluid heat exchanger 85 side and the low-pressure side heat exchanger 88 side. The compressor 81 is driven by power transmitted from a running engine, an electric motor, or the like of a vehicle (not shown).

The high-pressure gas-phase refrigerant discharged from the compressor 81 flows into the high-pressure side heat exchanger 82. The high-pressure gas-phase refrigerant flowing into the high-pressure side heat exchanger 82 is condensed by dissipating heat through heat exchange with the outside air when flowing through the flow passage in the high-pressure side heat exchanger 82.

Part of the liquid-phase refrigerant condensed in the high-pressure side heat exchanger 82 passes through a first flow rate restriction portion 83 to be decompressed when passing through the first expansion valve 84, and then flows into the refrigerant-working fluid heat exchanger 85 in an atomized gas-liquid two-phase state. The first flow rate restriction portion 83 is capable of adjusting the amount of refrigerant flowing from the first expansion valve 84 into the refrigerant-working fluid heat exchanger 85. While passing through the flow passage of the refrigerant-working fluid heat exchanger 85, the refrigerant flowing into the refrigerant-working fluid heat exchanger 85 cools the working fluid flowing through the condenser 30 included in the fluid circulation circuit 4 of the device temperature regulator 1, by the latent heat of evaporation of the refrigerant. That is, the condenser 30 of the fluid circulation circuit 4 in the device temperature regulator 1 of the present embodiment and the refrigerant-working fluid heat exchanger 85 of the refrigeration cycle 8 are integrally formed to thereby exchange heat between the working fluid flowing through the fluid circulation circuit 4 and the refrigerant flowing through the refrigeration cycle 8. The refrigerant having passed through the refrigerant-working fluid heat exchanger 85 is drawn into the compressor 81 via an accumulator (not shown).

The other part of the liquid-phase refrigerant condensed in the high-pressure side heat exchanger 82 passes through the second flow rate restriction portion 86 to be decompressed when passing through the second expansion valve 87, and then flows into the low-pressure side heat exchanger 88 in an atomized gas-liquid two-phase state. The second flow rate restriction portion 86 is capable of adjusting the amount of refrigerant flowing from the second expansion valve 87 into the low-pressure side heat exchanger 88. The low-pressure side heat exchanger 88 is used, for example, in an air conditioner for performing air-conditioning of the interior of a vehicle cabin. In this case, the refrigerant flowing into the low-pressure side heat exchanger 88 cools the air blown into the vehicle cabin by the latent heat of evaporation of the refrigerant. The refrigerant that has passed through the low-pressure side heat exchanger 88 is also drawn into the compressor 81 via an accumulator (not shown).

In the second embodiment described above, the condenser 30 included in the fluid circulation circuit 4 and the refrigerant-working fluid heat exchanger 85 included in the refrigeration cycle 8 are integrally formed to thereby cool the working fluid flowing through the fluid circulation circuit 4 by heat exchange with the refrigerant flowing through the refrigeration cycle 8.

Thus, the amount of refrigerant flowing through the refrigerant-working fluid heat exchanger 85 included in the refrigeration cycle 8 is adjusted by the first flow rate restriction portion 83 and the like, making it possible to adjust the amount of cold heat to be supplied to the working fluid flowing through the condenser 30 of the device temperature regulator 1. Therefore, in the second embodiment, the cooling capacity of the device temperature regulator 1 for the assembled battery 2 can be appropriately adjusted in accordance with the amount of heat generated by the assembled battery 2.

The above-mentioned refrigeration cycle 8 may be a heat pump cycle as well as the cooler cycle. The above-mentioned refrigeration cycle 8 may be a stand-alone system for use in cooling the assembled battery 2, which is separated from an air conditioner for performing air-conditioning of the interior of the vehicle cabin.

### Third Embodiment

A third embodiment will be described. The third embodiment is obtained by changing the configuration for cooling the working fluid within the device temperature regulator 1 in the first and second embodiments and is substantially the same as the first and second embodiments in other configurations of the device temperature regulator 1. Thus, only the differences from the first and second embodiments will be described below.

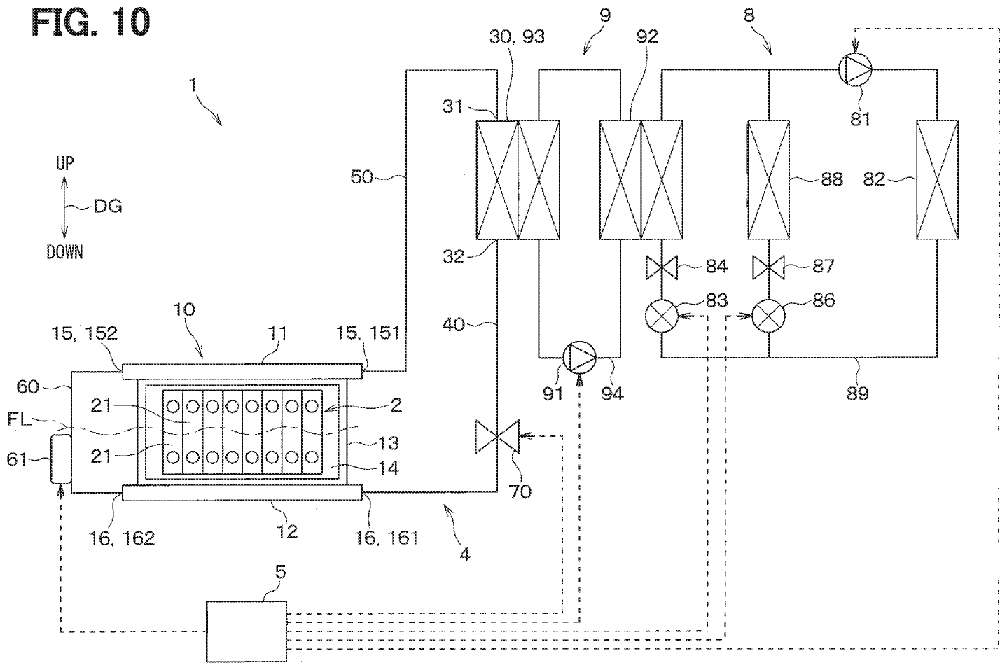

As shown in FIG. 10, the device temperature regulator 1 of the third embodiment includes a coolant circuit 9. The coolant circuit 9 includes a water pump 91, a coolant radiator 92, a coolant-working fluid heat exchanger 93, and a coolant pipe 94 connecting them. The coolant flows through the coolant circuit 9.

The water pump 91 pressure-feeds the coolant and circulates the coolant in the coolant circuit 9. The coolant radiator 92 cools the coolant flowing through the flow passage of the coolant radiator 92 by heat exchange with the refrigerant flowing through the evaporator included in the refrigeration cycle 8. That is, the coolant radiator 92 in the coolant circuit 9 of the present embodiment is a chiller integrally formed with the evaporator of the refrigeration cycle 8 and exchanges heat between the coolant flowing through the coolant circuit 9 and the low-pressure refrigerant flowing through the refrigeration cycle 8. The coolant flowing out of the coolant radiator 92 flows into the coolant-working fluid heat exchanger 93.

While passing through the flow passage of the coolant-working fluid heat exchanger 93, the coolant flowing into the coolant-working fluid heat exchanger 93 cools the working fluid flowing through the condenser 30 included in the fluid circulation circuit 4 of the device temperature regulator 1. That is, the condenser 30 of the fluid circulation circuit 4 in the device temperature regulator 1 of the present embodiment and the coolant-working fluid heat exchanger 93 of the coolant circuit 9 are integrally formed to thereby exchange heat between the working fluid flowing through the fluid circulation circuit 4 and the coolant flowing through the coolant circuit 9.

In the third embodiment described above, the condenser 30 included in the fluid circulation circuit 4 and the coolant-working fluid heat exchanger 93 included in the coolant circuit 9 are integrally formed to thereby cool the working fluid flowing through the fluid circulation circuit 4 by heat exchange with the coolant flowing through the coolant circuit 9.

Thus, the temperature of the low-pressure refrigerant flowing through the refrigeration cycle 8 can be set to a temperature that is different from the temperature of the coolant flowing through the coolant circuit 9. Thus, the device temperature regulator 1 can appropriately regulate each of the temperature of the low-pressure refrigerant flowing through the refrigeration cycle 8 and the temperature of the coolant flowing through the coolant circuit 9. Therefore, the device temperature regulator 1 adjusts the amount of cold heat that is supplied from the coolant flowing through the coolant circuit 9 to the working fluid flowing through the condenser 30 of the device temperature regulator 1. Consequently, the cooling capacity of the device temperature regulator 1 for the assembled battery 2 can be appropriately adjusted in accordance with the amount of heat generated from the assembled battery 2.

### Fourth Embodiment

A fourth embodiment will be described. The fourth embodiment is obtained by changing parts of the configuration of the coolant circuit 9 in the third embodiment. The fourth embodiment is substantially the same as the third embodiment in other configurations. Thus, only the differences from the third embodiment will be described.

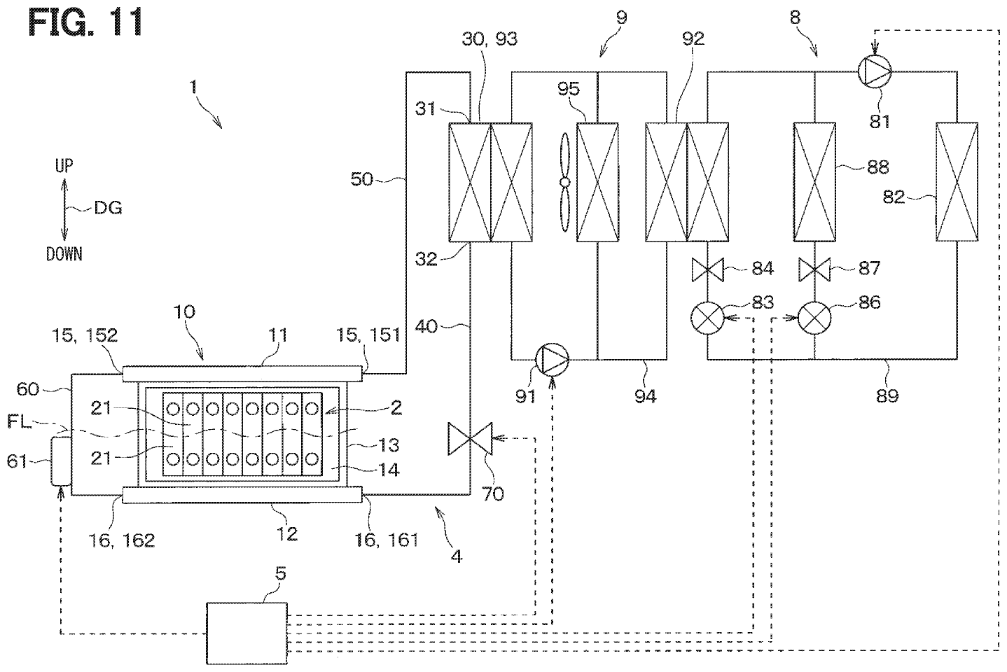

As shown in FIG. 11, the device temperature regulator 1 of the fourth embodiment includes an air-cooled radiator 95 in the coolant circuit 9. The air-cooled radiator 95 cools the coolant flowing through the flow passage of the air-cooled radiator 95 by heat exchange with the outside air. In the coolant circuit 9, the air-cooled radiator 95 and the coolant radiator 92 are connected in parallel.

In the fourth embodiment, the cooling capacity of the coolant flowing through the coolant circuit 9 can be enhanced. Therefore, the device temperature regulator 1 can improve the cooling capacity of the assembled battery 2.

### Fifth Embodiment

A fifth embodiment will be described. The fifth embodiment is obtained by changing parts of the configuration of the fluid circulation circuit 4 in the first embodiment. The fifth embodiment is substantially the same as the first embodiment in other configurations. Thus, only the differences from the first embodiment will be described.

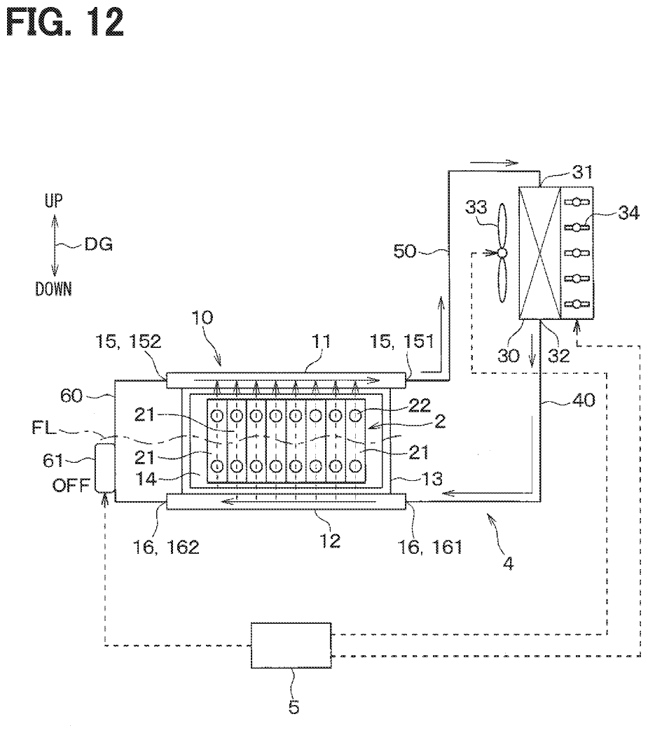

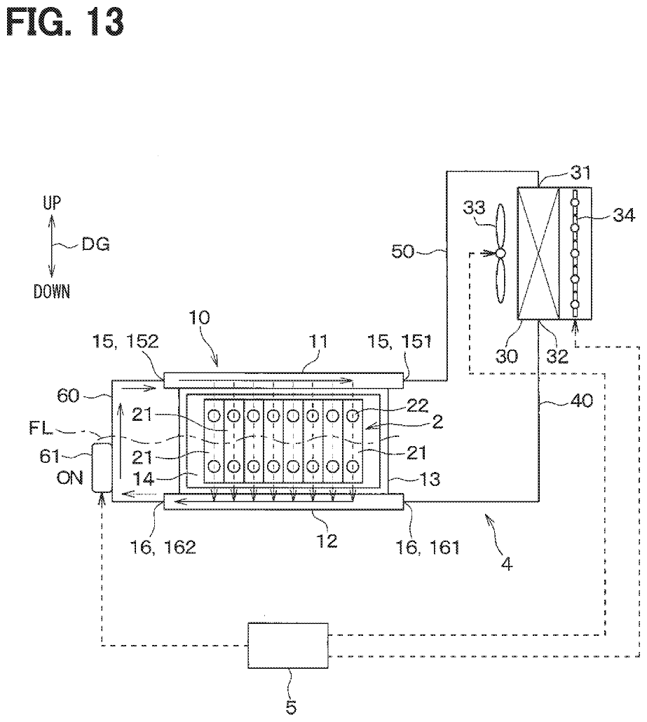

As shown in FIG. 12 and FIG. 13, the device temperature regulator 1 of the fifth embodiment is not provided with the fluid control valve 70 at any point in the liquid phase passage 40. Instead, in the fifth embodiment, the air-cooled condenser 30 is provided with a shutter 34 installed as a door member capable of blocking the ventilation of the air passing through the condenser 30. The open/close operation of the shutter 34 is controlled by a control signal transmitted from the controller 5.

As shown in FIG. 12, when the shutter 34 is opened, the ventilation of the air passing through the condenser 30 is allowed. Thus, the ventilation air or traveling air by the blower fan 33 passes through the condenser 30, so that the working fluid dissipates heat in the condenser 30. Therefore, when cooling the assembled battery 2, the working fluid flows in the fluid circulation circuit 4 of the device temperature regulator 1 from the condenser 30 to the liquid phase passage 40, the lower tank 12, the heat exchanging portion 13, the upper tank 11, the gas phase passage 50, and the condenser 30 in this order.

As shown in FIG. 13, when the shutter 34 is closed, the ventilation of the air passing through the condenser 30 is blocked. Consequently, the heat dissipation of the working fluid by the condenser 30 is suppressed or substantially stopped. Thus, when warming up the assembled battery 2, the working fluid flows in the fluid circulation circuit 4 of the device temperature regulator 1 from the fluid passage 60 to the upper tank 11, the heat exchanging portion 13, the lower tank 12, and the fluid passage 60 in this order. Therefore, the shutter 34 of the present embodiment functions as a heat dissipation suppressing portion capable of suppressing the heat dissipation of the working fluid in the condenser 30.

In the fifth embodiment described above, the shutter 34 is provided in the air-cooled condenser 30, so that the fluid control valve 70 installed at any point in the liquid phase passage 40 can be eliminated in the first to fourth embodiments.

### Sixth Embodiment

A sixth embodiment will be described. The sixth embodiment is obtained by changing parts of the configuration of the fluid circulation circuit 4 in the second embodiment. The sixth embodiment is substantially the same as the second embodiment in other configurations. Thus, only the differences from the second embodiment will be described.

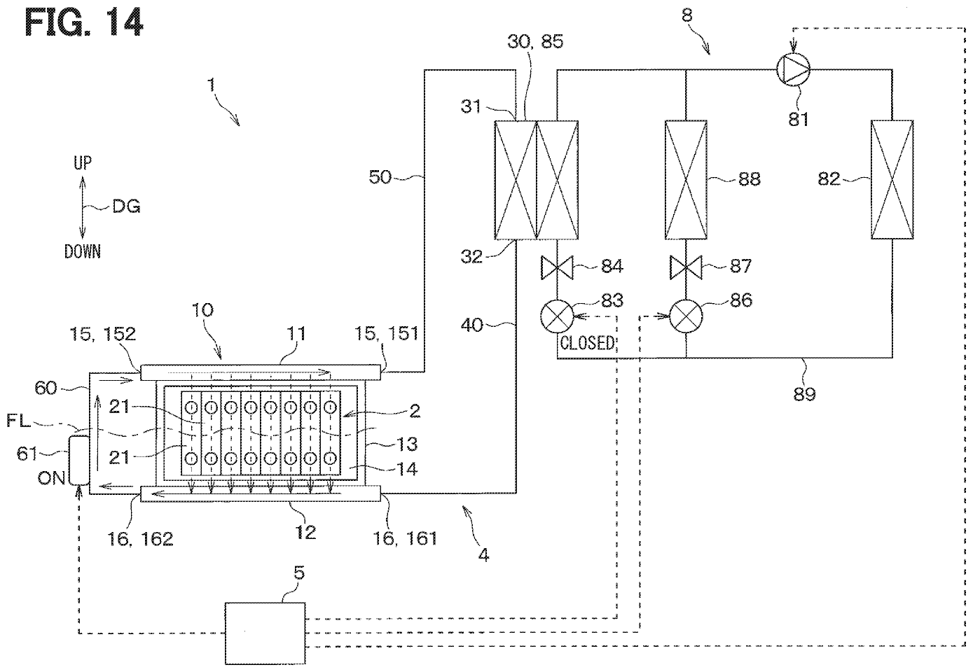

As shown in FIG. 14, the device temperature regulator 1 of the sixth embodiment is not provided with the fluid control valve 70 at any point of the liquid phase passage 40.

Thus, in the sixth embodiment, when warming up the assembled battery 2, the refrigerant flowing from the first expansion valve 84 into the refrigerant-working fluid heat exchanger 85 is blocked by the first flow rate restriction portion 83 installed in the refrigeration cycle 8, instead of the control by the fluid control valve 70. Consequently, the heat dissipation of the working fluid by the condenser 30 is suppressed or substantially stopped. Thus, when warming up the assembled battery 2, the working fluid can flow in the fluid circulation circuit 4 of the device temperature regulator 1 from the fluid passage 60 to the upper tank 11, the heat exchanging portion 13, the lower tank 12, and the fluid passage 60 in this order. Therefore, the first flow rate restriction portion 83 of the present embodiment functions as a heat dissipation suppressing portion capable of suppressing the heat dissipation of the working fluid in the condenser 30.

In the sixth embodiment, in a case where the low-pressure side heat exchanger 88 is not used, the operation of the compressor 81 may be stopped when warming up the assembled battery 2.

In the sixth embodiment described above, the first flow rate restriction portion 83 is controlled to be brought into a closed state when warming up the assembled battery 2, so that the fluid control valve 70 installed at any point of the liquid phase passage 40 can be eliminated in the first to fourth embodiments.

### Seventh Embodiment

A seventh embodiment will be described. The seventh embodiment is obtained by changing parts of the configuration of the fluid circulation circuit 4 in the third embodiment. The seventh embodiment is substantially the same as the third embodiment in other configurations. Thus, only the differences from the third embodiment will be described.

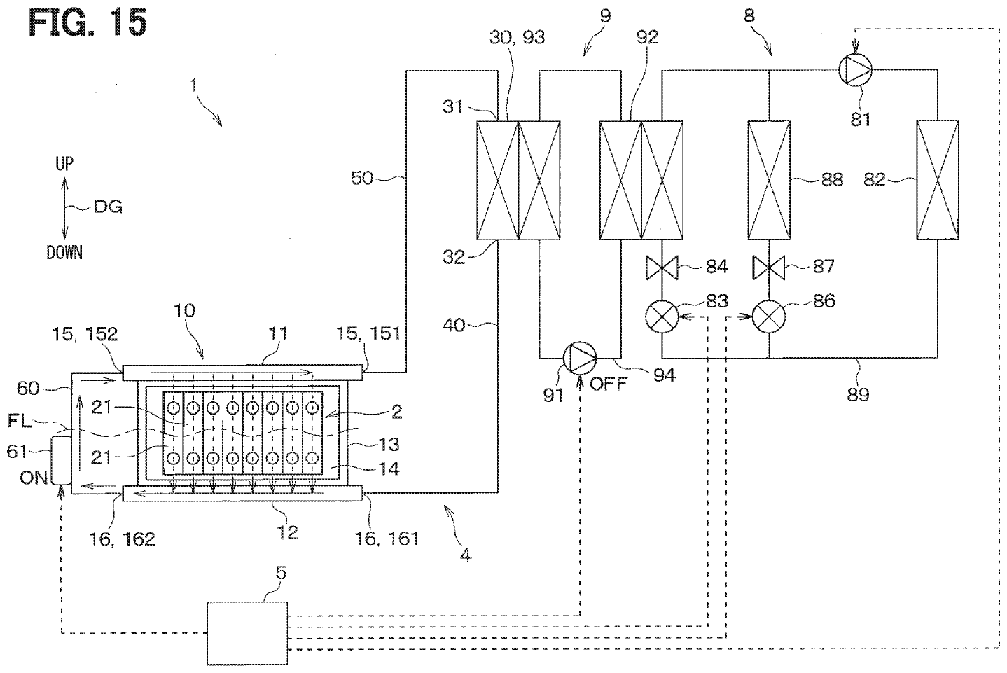

As shown in FIG. 15, the device temperature regulator 1 of the seventh embodiment is not provided with the fluid control valve 70 at any point of the liquid phase passage 40. Thus, in the seventh embodiment, when warming up the assembled battery 2, the flow of the coolant in the coolant-working fluid heat exchanger 93 is blocked by stopping the driving of the water pump 91 installed in the coolant circuit 9, instead of the control by the fluid control valve 70. Consequently, the heat dissipation of the working fluid by the condenser 30 is suppressed or substantially stopped. Thus, when warming up the assembled battery 2, the working fluid can flow in the fluid circulation circuit 4 of the device temperature regulator 1 from the fluid passage 60 to the upper tank 11, the heat exchanging portion 13, the lower tank 12, and the fluid passage 60 in this order. Therefore, the water pump 91 of the present embodiment functions as a heat dissipation suppressing portion capable of suppressing the heat dissipation of the working fluid in the condenser 30.

In the seventh embodiment described above, the driving of the water pump 91 is stopped when warming up the assembled battery 2, so that the fluid control valve 70 installed at any point of the liquid phase passage 40 can be eliminated in the first to fourth embodiments.

### Eighth Embodiment

An eighth embodiment will be described. The eighth embodiment is obtained by changing an attaching position of the fluid control valve 70 in the first embodiment. The eighth embodiment is substantially the same as the first embodiment in other configurations. Thus, only the differences from the first embodiment will be described.

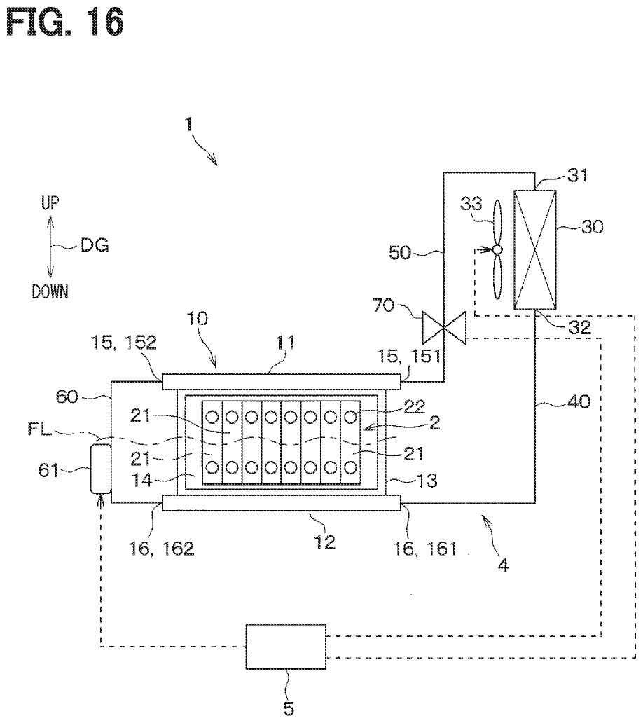

As shown in FIG. 16, the device temperature regulator 1 of the eighth embodiment is provided with the fluid control valve 70 at any point of the gas phase passage 50. Thus, in the eighth embodiment, the condensation of the working fluid by the condenser 30 is stopped when the fluid control valve 70 blocks the flow of the working fluid flowing through the gas phase passage 50 while warming up the assembled battery 2. Consequently, when warming up the assembled battery 2, the working fluid can flow in the fluid circulation circuit 4 of the device temperature regulator 1 from the fluid passage 60 to the upper tank 11, the heat exchanging portion 13, the lower tank 12, and the fluid passage 60 in this order.

### Ninth Embodiment

A ninth embodiment will be described. The ninth embodiment is obtained by changing parts of the configuration of the fluid circulation circuit 4 in the device temperature regulator 1 of the second embodiment. The ninth embodiment is substantially the same as the second embodiment in other configurations. Thus, only the differences from the second embodiment will be described.

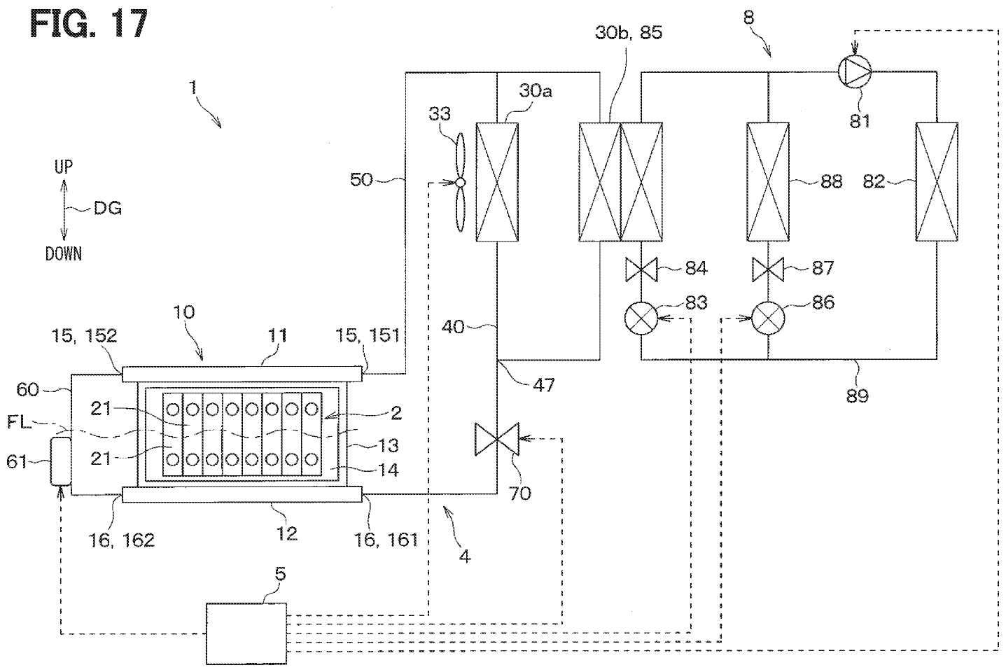

As shown in FIG. 17, the device temperature regulator 1 of the ninth embodiment includes two types of condensers 30a and 30b in the fluid circulation circuit 4. One condenser 30a is the air-cooled condenser 30a described in the first embodiment and the like. The other condenser 30b is integrally formed with the refrigerant-working fluid heat exchanger 85 of the refrigeration cycle 8 described in the second embodiment and the like. The two types of condensers 30a and 30b are connected in parallel. The fluid control valve 70 is provided between a first lower connection portion 161 of the device heat exchanger 10 and a merging portion 47 of the liquid phase passages 40 extending from the two types of condensers 30a and 30b.

In the device temperature regulator 1 of the ninth embodiment, the condensing capacity of the working fluid can be enhanced by the condensers 30a and 30b, thereby improving the cooling performance for the assembled battery 2.

The combination of the plurality of condensers 30a and 30b which are provided in the fluid circulation circuit 4 of the device temperature regulator 1 is not limited to one shown in FIG. 17. Various combinations of a plurality of condensers may be employed.

### Tenth Embodiment

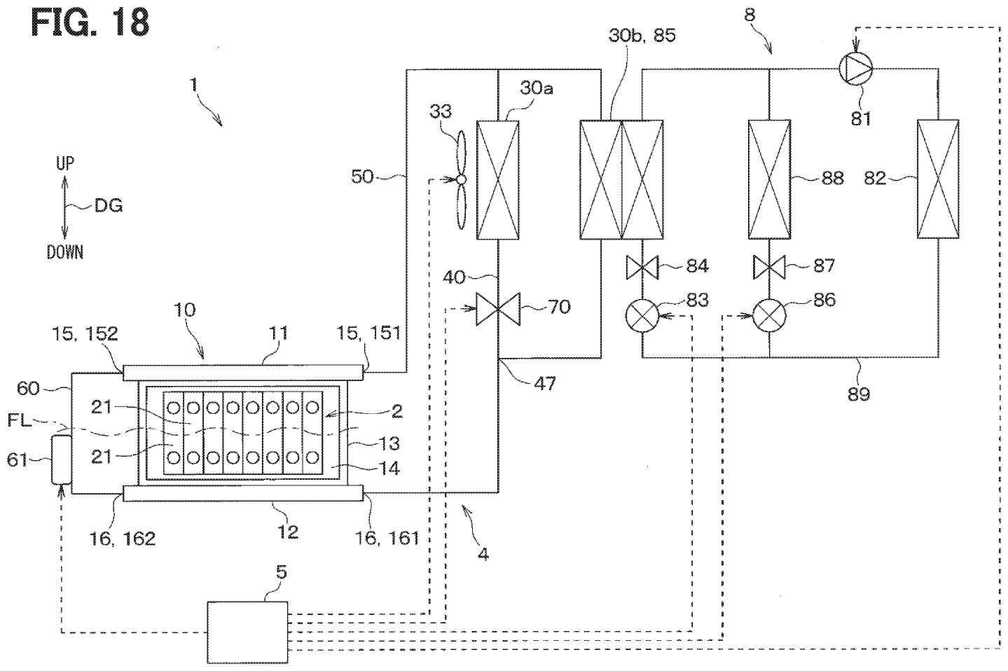

A tenth embodiment will be described. The tenth embodiment is obtained by changing an attaching position of the fluid control valve 70 in the ninth embodiment. The tenth embodiment is substantially the same as the ninth embodiment in other configurations. Thus, only the differences from the ninth embodiment will be described. As shown in FIG. 18, in the tenth embodiment, the fluid control valve 70 is provided between the air-cooled condenser 30a and the merging portion 47 in the liquid phase passage 40.

The air-cooled condenser 30a performs heat exchange using traveling air and the like when the condenser 30a is not provided with the shutter 34. However, when the shutter 34 is provided for the air-cooled condenser 30a, a large space is needed around the condenser 30, which may deteriorate the mountability of the device temperature regulator on the vehicle. In the tenth embodiment, the fluid control valve 70 is provided between the air-cooled condenser 30a and the merging portion 47 of the liquid phase passage 40, thereby reducing the body size of the device temperature regulator 1 and thus improving the mountability of the device temperature regulator 1 onto the vehicle.

The condenser 30b integrally formed with the refrigerant-working fluid heat exchanger 85 of the refrigeration cycle 8 can close the first flow rate restriction portion 83 installed in the refrigeration cycle 8, thus suppressing or substantially stopping the heat dissipation of the working fluid. Therefore, also in the tenth embodiment, when warming up the assembled battery 2, the working fluid can flow from the fluid passage 60 to the upper tank 11, the heat exchanging portion 13, the lower tank 12, and the fluid passage 60 in this order by controlling the fluid control valve 70 and the first flow rate restriction portion 83.

Also in the tenth embodiment, like the first embodiment, when warming up the assembled battery 2, the liquid-phase working fluid is retained in a region above the liquid phase passage 40, which is located above the fluid control valve 70 in the gravitational direction. In this state, the sealing amount of the working fluid into the fluid circulation circuit 4 and the attachment position of the fluid control valve 70 are adjusted such that the liquid level FL of the working fluid is formed near the center of the heat exchanging portion 13 in the device heat exchanger 10.

### Eleventh Embodiment

An eleventh embodiment will be described. The eleventh embodiment is obtained by changing a connection method of the two types of condensers 30 in the ninth embodiment. The eleventh embodiment is substantially the same as the ninth embodiment in other configurations. Thus, only the differences from the ninth embodiment will be described.

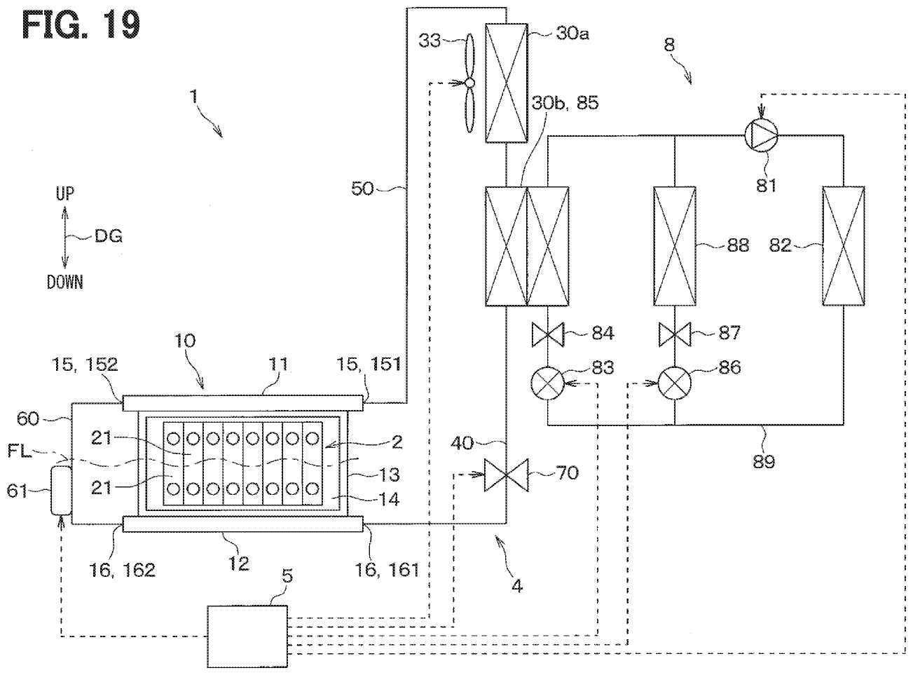

As shown in FIG. 19, the device temperature regulator 1 of the eleventh embodiment includes two types of condensers 30a and 30b in the fluid circulation circuit 4. One condenser 30a is the air-cooled condenser 30. The other condenser 30b is integrally formed with the refrigerant-working fluid heat exchanger 85 of the refrigeration cycle 8. These two types of condensers 30a and 30b are connected in series.

The number of the plurality of condensers 30a and 30b which are provided in the fluid circulation circuit 4 of the device temperature regulator 1 is not limited to one shown in FIG. 19. The number of condensers may be three or more. The connection method of the plurality of condensers 30a and 30b is not limited to one shown in FIG. 19 or the like and may include a combination of a parallel connection and a series connection.

The device temperature regulator 1 of the eleventh embodiment enhances the condensing capacity of the working fluid by the condensers 30 and thereby can improve the cooling performance thereof for the assembled battery 2.

### Twelfth Embodiment

A twelfth embodiment will be described. The twelfth embodiment is obtained by changing the configurations of the fluid passage 60 and the heating portion 61 in the first embodiment. The twelfth embodiment is substantially the same as the first embodiment in other configurations. Thus, only the differences from the first embodiment will be described.

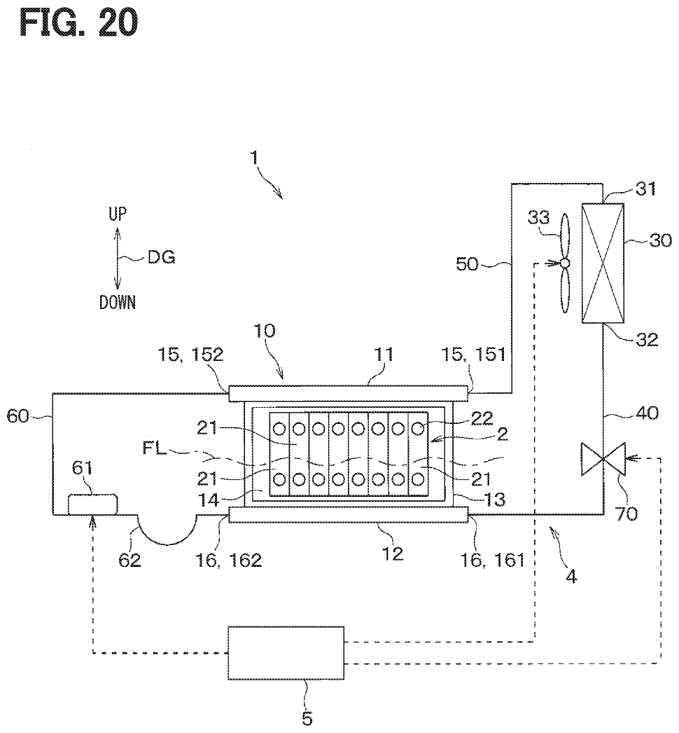

As shown in FIG. 20, in the twelfth embodiment, the heating portion 61 is provided in a portion of the fluid passage 60 that extends substantially horizontally. In this case, if the working fluid heated by the heating portion 61 to become steam flows backward to the second lower connection portion 162 side through the fluid passage 60, the circulation of the working fluid may be degraded.

In the twelfth embodiment, the fluid passage 60 includes a backflow suppression portion 62 that extends downward in the gravitational direction with respect to the heating portion 61, between the heating portion 61 and the second lower connection portion 162 of the device heat exchanger 10. Specifically, in the twelfth embodiment, a portion of the fluid passage 60 is formed in a U-shape. A part of the U-shaped portion of the fluid passage 60 that extends from the center of the U-shaped portion to the heating portion 61 side corresponds to the backflow suppression portion 62.

The backflow suppression portion 62 extends downward in the gravitational direction from the heating portion 61, so that the working fluid heated and vaporized by the heating portion 61 can be prevented from flowing backward to the second lower connection portion 162 side. Therefore, the device temperature regulator 1 can smoothly circulate the working fluid from the fluid passage 60 to the upper tank 11, the heat exchanging portion 13, the lower tank 12, and the fluid passage 60 in this order when warming up the assembled battery 2.

### Thirteenth Embodiment

A thirteenth embodiment will be described. The thirteenth embodiment is obtained by adding a plurality of device heat exchangers 10 to the first embodiment. The thirteenth embodiment is substantially the same as the first embodiment in other configurations. Thus, only the differences from the first embodiment will be described.

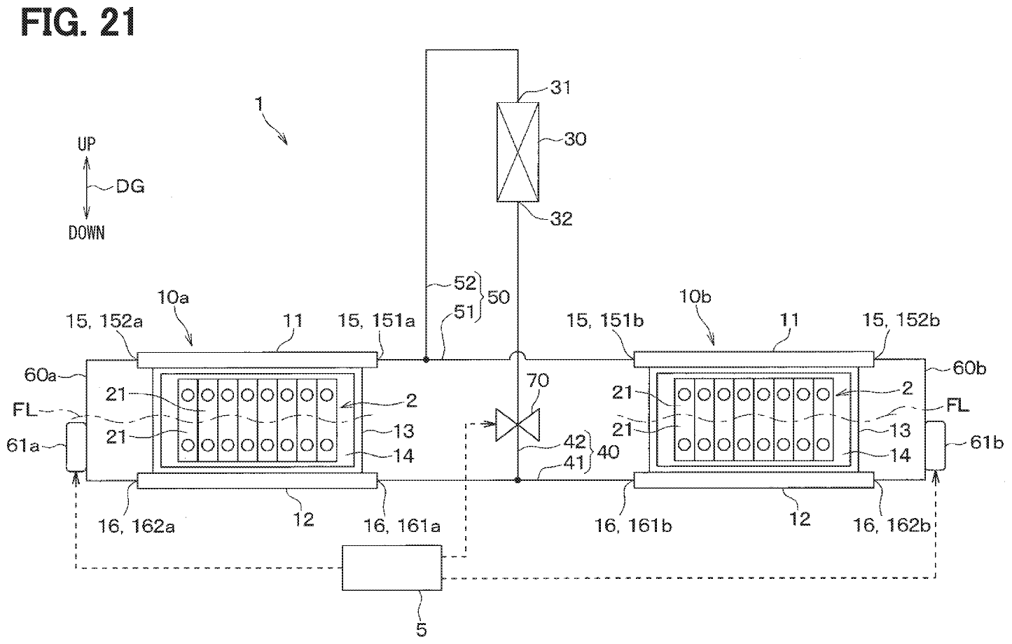

As shown in FIG. 21, the device temperature regulator 1 of the thirteenth embodiment includes a plurality of device heat exchangers 10a and 10b. The gas phase passage 50 includes a first gas phase passage portion 51 and a second gas phase passage portion 52. The first gas phase passage portion 51 connects a first upper connection portion 151a of one device heat exchanger 10a with a first upper connection portion 151b of the other device heat exchanger 10b. The second gas phase passage portion 52 extends upward from any point in the first gas phase passage portion 51 to be connected to the inflow port 31 of the condenser 30. The liquid phase passage 40 includes a first liquid phase passage portion 41 and a second liquid phase passage portion 42. The first liquid phase passage portion 41 connects a first lower connection portion 161a of one device heat exchanger 10a with a first lower connection portion 161b of the other device heat exchanger 10b. The second liquid phase passage portion 42 extends upward from any point in the first liquid phase passage portion 41 to be connected to the outflow port 32 of the condenser 30.

One fluid passage 60a connects the second upper connection portion 152a and the second lower connection portion 162a in the one device heat exchanger 10a. The fluid passage 60a is provided with a heating portion 61a. Another fluid passage 60b connects the second upper connection portion 152b and the second lower connection portion 162b in the other device heat exchanger 10b. The other fluid passage 60b is also provided with another heating portion 61b.

With this configuration, even when the assembled batteries 2 are disposed in a plurality of positions of the vehicle, the device temperature regulator 1 of the thirteenth embodiment can arrange a plurality of device heat exchangers 10 depending on the positions of the assembled batteries 2.

### Fourteenth Embodiment

A fourteenth embodiment will be described. The fourteenth embodiment is also obtained by adding a plurality of device heat exchangers 10 to the first embodiment. The fourteenth embodiment is substantially the same as the first embodiment in other configurations. Thus, only the differences from the first embodiment will be described.

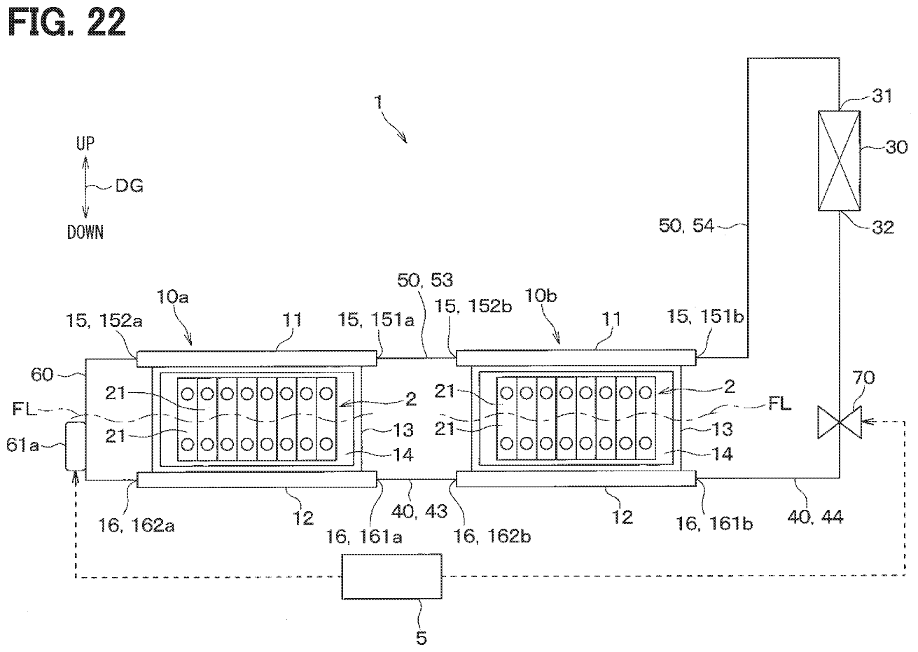

As shown in FIG. 22, the device temperature regulator 1 of the fourteenth embodiment also includes a plurality of device heat exchangers 10a and 10b. The gas phase passage 50 includes a heat exchanger gas phase passage 53 and a condenser gas phase passage 54. The heat exchanger gas phase passage 53 connects the first upper connection portion 151a of one device heat exchanger 10a with the second upper connection portion 152b of the other device heat exchanger 10b. The condenser gas phase passage 54 connects the first upper connection portion 151b of the other device heat exchanger 10b with the inflow port 31 of the condenser 30. The liquid phase passage 40 includes a heat exchanger liquid phase passage 43 and a condenser liquid phase passage 44. The heat exchanger liquid phase passage 43 connects the first lower connection portion 161a of the one device heat exchanger 10a with the second lower connection portion 162b of the other device heat exchanger 10b. The condenser liquid phase passage 44 connects the first lower connection portion 161b of the other device heat exchanger 10b with the outflow port 32 of the condenser 30.

The fluid passage 60a connects the second upper connection portion 152a and the second lower connection portion 162a in the one device heat exchanger 10a. The fluid passage 60a is provided with the heating portion 61a.

Also, with this configuration, even when the assembled batteries 2 are disposed in a plurality of positions of the vehicle, the device temperature regulator 1 of the fourteenth embodiment can arrange a plurality of device heat exchangers 10 depending on the positions of the assembled batteries 2.

### Fifteenth Embodiment

A fifteenth embodiment will be described. The fifteenth and sixteenth embodiments to be described later are obtained by changing an installing method of the assembled battery 2 on the device heat exchanger 10, compared to the above-mentioned first to fourteenth embodiments. The fifteenth and sixteenth embodiments are substantially the same as the first to fourteenth embodiments in other configurations. Thus, only the differences of the fifteenth and sixteenth embodiments from the first to fourteenth embodiments will be described.

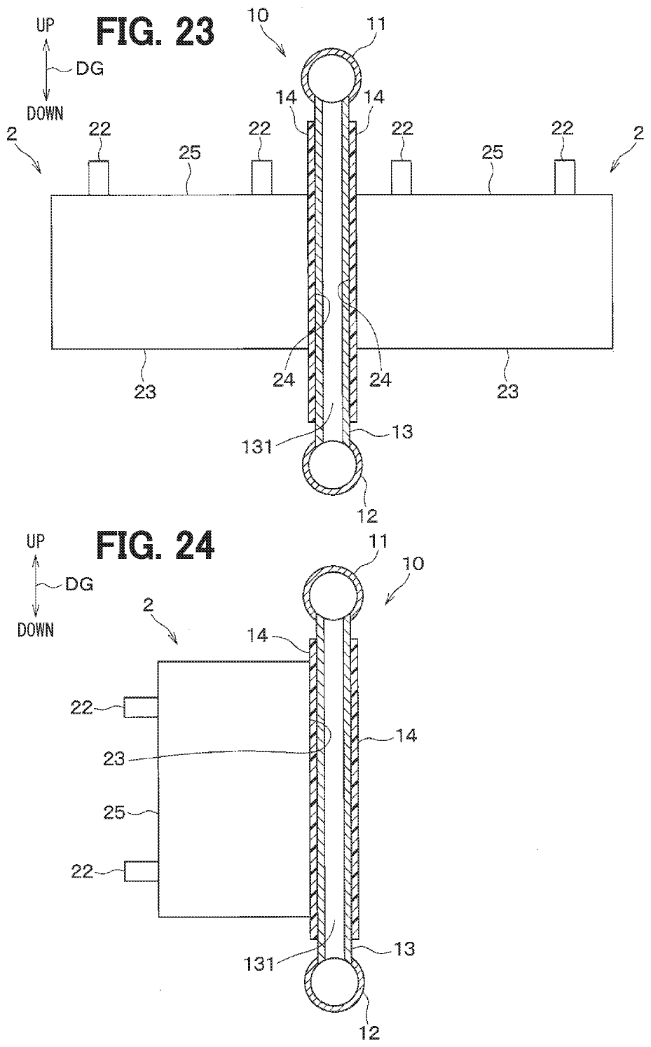

As shown in FIG. 23, in the fifteenth embodiment, each of the assembled batteries 2 is installed such that terminals 22 of each battery cell 21 included in the assembled battery 2 are oriented upward in the gravitational direction. The assembled battery 2 is installed such that a surface 24 of the assembled battery 2 perpendicular to the surface 25 thereof with the terminals 22 provided thereon is attached onto the side surface of the heat exchanging portion 13 of the device heat exchanger 10 via the heat conductive sheet 14.

### Sixteenth Embodiment

As shown in FIG. 24, in the sixteenth embodiment, an assembled battery 2 is installed such that terminals 22 of the respective battery cells 21 included in the assembled battery 2 are oriented in the direction that intersects the gravitational direction. The assembled battery 2 is installed such that the surface 23 of the assembled battery 2 opposite to the surface 25 thereof with the terminals 22 provided thereon is attached onto the side surface of the heat exchanging portion 13 of the device heat exchanger 10 via the heat conductive sheet 14. The assembled battery 2 is installed only on one side surface of the heat exchanging portion 13 and not installed on the other side surface thereof.

### Seventeenth Embodiment

A seventeenth embodiment will be described. The seventeenth and eighteenth embodiments to be described later are obtained by changing the configuration of the device heat exchanger 10 and the installing method of the assembled battery 2 on the device heat exchanger 10, compared to the above-mentioned first to fourteenth embodiments. The seventeenth and eighteenth embodiments are substantially the same as the first to fourteenth embodiments in other configurations. Thus, only the differences of the seventeenth and eighteenth embodiments from the first to fourteenth embodiments will be described.

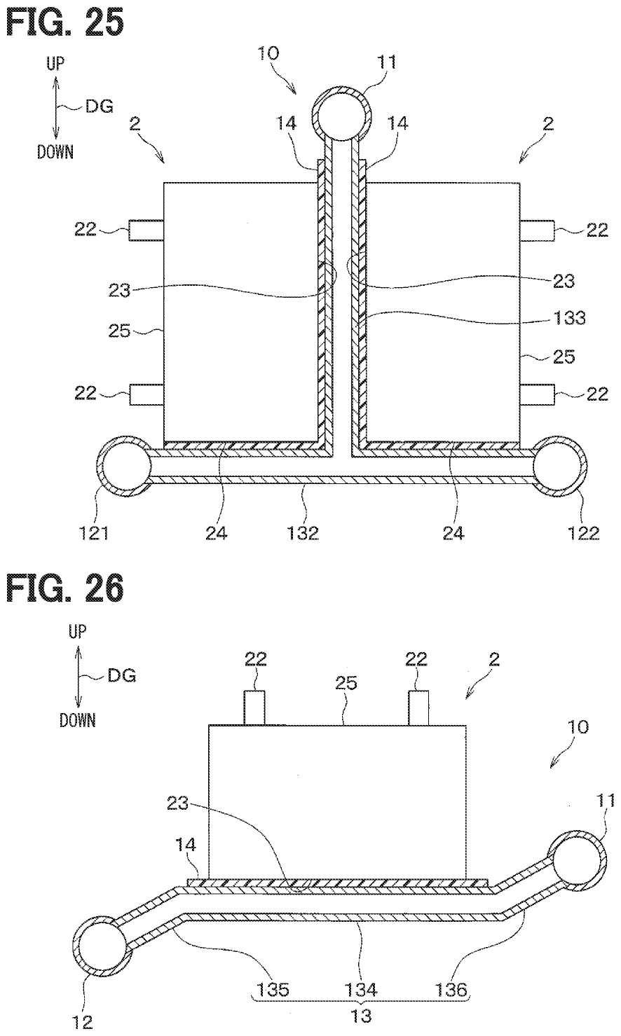

As shown in FIG. 25, in the seventeenth embodiment, the device heat exchanger 10 includes two lower tanks 121 and 122 and one upper tank 11. The device heat exchanger 10 has a horizontal heat exchanging portion 132 connecting the two lower tanks 121 and 122 and a vertical heat exchanging portion 133 provided perpendicularly to the horizontal heat exchanging portion 132. A portion on the lower side in the gravitational direction of the vertical heat exchanging portion 133 is connected to an intermediate position of the horizontal heat exchanging portion 132. Meanwhile, a portion on the upper side in the gravitational direction of the vertical heat exchanging portion 133 is connected to the upper tank 11. The two lower tanks 121 and 122, the one upper tank 11, the horizontal heat exchanging portion 132, and the vertical heat exchanging portion 133 are integrally formed.

The assembled batteries 2 are installed such that terminals 22 of the respective battery cells 21 included in each assembled battery 2 are oriented in the direction that intersects the gravitational direction. The assembled battery 2 is installed such that the surface 24 of the assembled battery 2 perpendicular to the surface 25 thereof with the terminals 22 provided thereon is attached onto the horizontal heat exchanging portion 132 via the heat conductive sheet 14. The assembled battery 2 is installed such that the surface 23 of the assembled battery 2 opposite to the surface 25 thereof with terminals 22 provided thereon is attached onto the vertical heat exchanging portion 133 via the heat conductive sheet 14.

In the seventeenth embodiment, the device heat exchanger 10 can simultaneously cool or warm up the surface 24 of the assembled battery 2 perpendicular to the surface 25 thereof with the terminals 22 provided thereon, as well as the surface 23 of the assembled battery 2 opposite to the surface 25 thereof with the terminals 22 provided thereon.

### Eighteenth Embodiment

As shown in FIG. 26, in the eighteenth embodiment, the heat exchanging portion includes a horizontal portion 134, a first inclined portion 135, and a second inclined portion 136. The horizontal portion 134 extends in the horizontal direction. The first inclined portion 135 extends obliquely downward in the gravitational direction from a part on one side of the horizontal portion 134. The second inclined portion 136 extends obliquely upward in the gravitational direction from another part on the other side of the horizontal portion 134. The lower tank 12 is connected to a part of the first inclined portion 135 opposite to the horizontal portion 134. The upper tank 11 is connected to a part of the second inclined portion 136 opposite to the horizontal portion 134. That is, the upper tank 11 is disposed at a higher position than the lower tank 12. The horizontal portion 134, the first inclined portion 135, the second inclined portion 136, the lower tank 12, and the upper tank 11 are integrally formed.

The assembled battery 2 is installed such that the terminals 22 of the battery cells 21 included in the assembled battery 2 are oriented upward in the gravitational direction. The assembled battery 2 is installed such that the surface 23 of the assembled battery 2 opposite to the surface 25 thereof with the terminals 22 provided thereon is attached onto the horizontal portion 134 of the heat exchanging portion 13 via the heat conductive sheet 14.

The installing method of the assembled battery 2 is not limited to those described in the first to eighteenth embodiments. Alternatively, various installing methods can be adopted. The number, shape, and the like of the respective battery cells 21 included in the assembled battery 2 are not limited to those shown in the first to eighteenth embodiments. Any number, shape, and the like of the battery cells 21 can be employed.

### Nineteenth Embodiment

A nineteenth embodiment will be described. The nineteenth embodiment is obtained by changing parts of the configuration of the fluid passage 60 in the first embodiment. The nineteenth embodiment is substantially the same as the first embodiment in other configurations. Thus, only the differences from the first embodiment will be described.

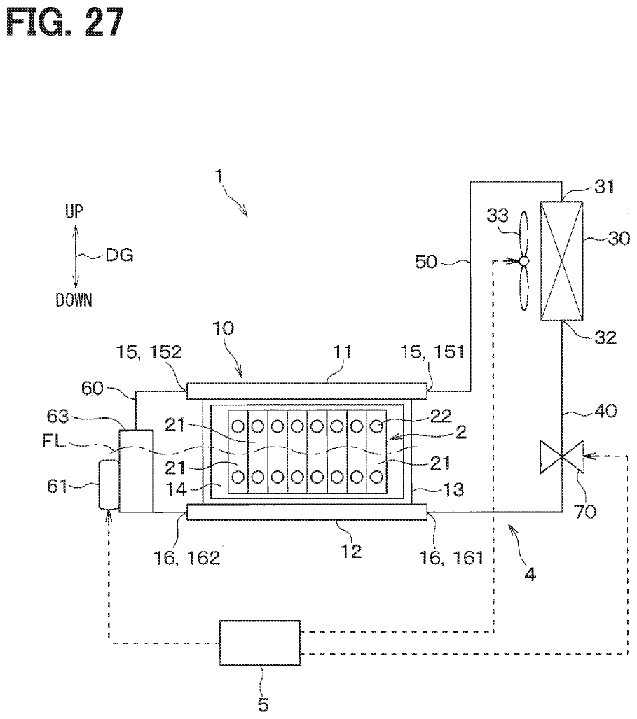

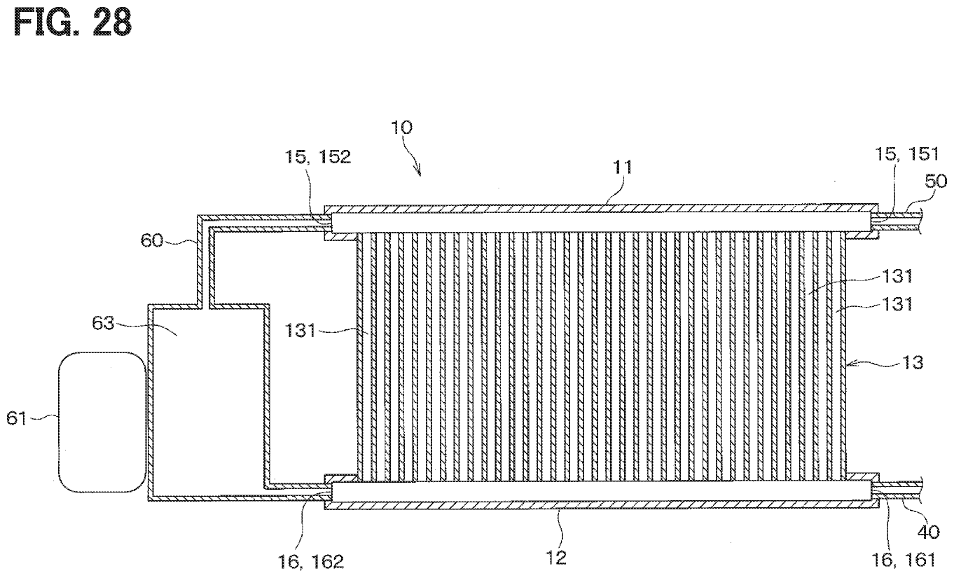

As shown in FIGS. 27 and 28, in the nineteenth embodiment, the fluid passage 60 has, at any point of its route, a liquid reservoir 63 for storing the liquid-phase working fluid flowing through the fluid passage 60. At least a part of the liquid reservoir 63 is located within the height range between the upper connection portion 15 and the lower connection portion 16 of the device heat exchanger 10. Thus, the device temperature regulator 1 stores the amount of working fluid required to cool and warm up the assembled battery 2 in the liquid reservoir 63 and adjusts the height of the liquid level FL of the working fluid in the liquid reservoir 63, thereby making it possible to easily adjust the height of the liquid level FL of the working fluid in the device heat exchanger 10 when heating and cooling the assembled battery 2.

FIG. 28 is a cross-sectional view of the device heat exchanger 10 and the fluid passage 60. The liquid reservoir 63 is formed by enlarging the inner diameter of a part of the route in the fluid passage 60. Thus, the liquid reservoir 63 can be provided with a simple configuration in the fluid passage 60.

The heating portion 61 is provided in a position that enables the heating of the liquid-phase working fluid stored in the liquid reservoir 63. Thus, the heating efficiency of the heating portion 61 for the working fluid can be enhanced.

### Twentieth Embodiment

The twentieth embodiment will be described. The twentieth embodiment is obtained by changing the configuration of the fluid passage 60 and the like in the first embodiment. The twentieth embodiment is substantially the same as the first embodiment in other configurations. Thus, only the differences from the first embodiment will be described.

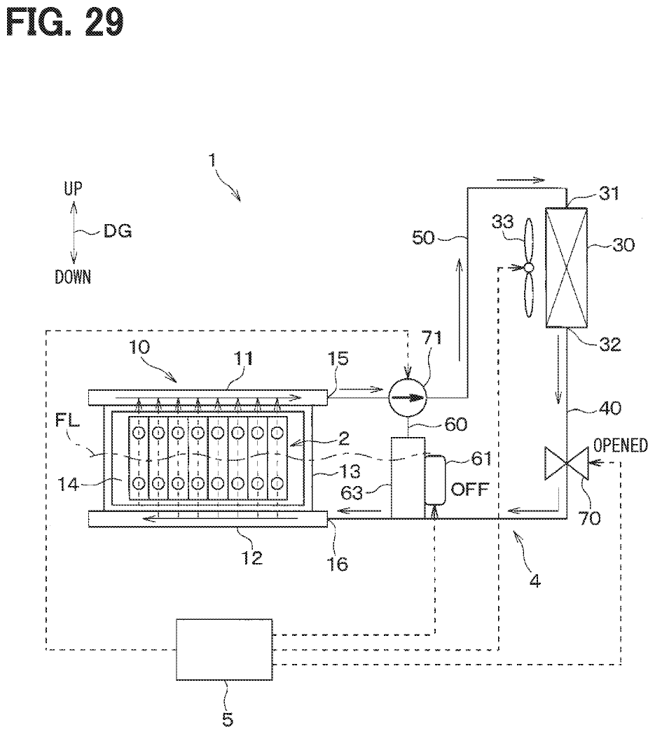

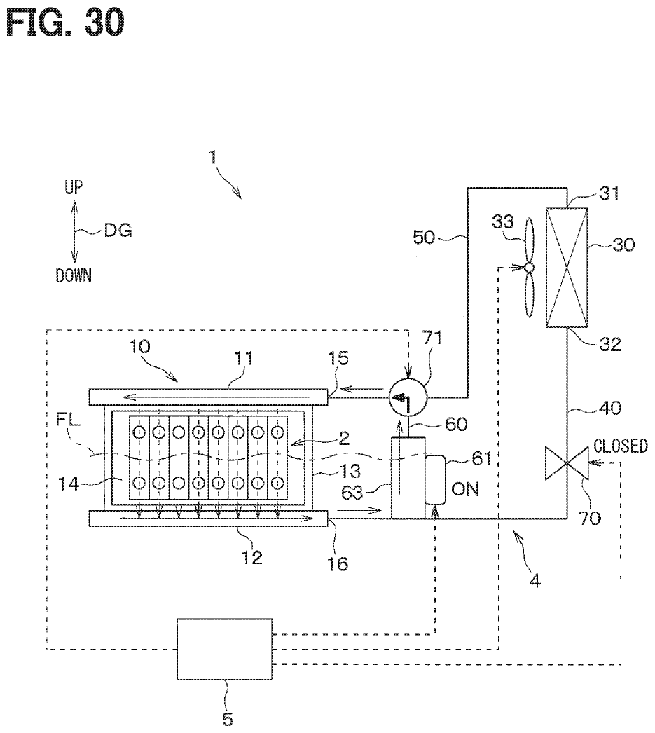

As shown in FIGS. 29 and 30, in the twentieth embodiment, the fluid passage 60 has the liquid reservoir 63. The liquid reservoir 63 included in the fluid passage 60 communicates with the liquid phase passage 40. A portion of the fluid passage 60 on the opposite side to the liquid reservoir 63 communicates with the gas phase passage 50 via a three-way switching valve 71.

FIG. 29 shows the flows of the working fluid formed when the device temperature regulator 1 cools the assembled battery 2 by solid line and broken line arrows. As described in the first embodiment, when cooling the assembled battery 2, the controller 5 turns off the energization of the heating portion 61 and stops the operation of the heating portion 61. The controller 5 opens the fluid control valve 70 so that the working fluid flows to the liquid phase passage 40. While the vehicle is stopping, the controller 5 turns on the power source of the blower fan 33 that blows air to the condenser 30. However, when the vehicle is traveling, the controller 5 turns off the power source of the blower fan 33 because the traveling air flows to the condenser 30. In the twentieth embodiment, when cooling the assembled battery 2, the controller 5 controls the three-way switching valve 71. By the operation of the three-way switching valve 71, the gas phase passage 50 located on the upper connection portion 15 side with respect to the three-way switching valve 71 communicates with the gas phase passage 50 located on the condenser 30 side with respect to the three-way switching valve 71, while the communication is blocked between the fluid passage 60 and the gas phase passage 50.

Thus, when cooling the assembled battery 2, the working fluid flows from the condenser 30 to the liquid phase passage 40, the lower tank 12, the heat exchanging portion 13, the upper tank 11, the gas phase passage 50, and the condenser 30 in this order. That is, a loop-shaped flow passage is formed through the device heat exchanger 10 and the condenser 30.

FIG. 30 shows the flows of the working fluid formed when the device temperature regulator 1 warms up the assembled battery 2 by solid line and broken line arrows. As described in the first embodiment, when warming up the assembled battery 2, the controller 5 turns on the energization of the heating portion 61 to actuate the heating portion 61. The controller 5 closes the fluid control valve 70, thereby blocking the flow of the working fluid in the liquid phase passage 40.

In the twentieth embodiment, when warming up the assembled battery 2, the controller 5 controls the three-way switching valve 71. By the operation of the three-way switching valve 71, the fluid passage 60 communicates with the gas phase passage 50 on the upper connection side with respect to the three-way switching valve 71, while the communication is blocked between the fluid passage 60 and the gas phase passage 50 on the condenser 30 side with respect to the three-way switching valve 71. Thus, when warming up the assembled battery 2, the working fluid flows from the fluid passage 60 to the upper tank 11, the heat exchanging portion 13, the lower tank 12, and the fluid passage 60 in this order. That is, the loop-shaped flow passage is formed through the device heat exchanger 10 and the fluid passage 60 without passing through the condenser 30.

### Twenty-First Embodiment

A twenty-first embodiment will be described. The twenty-first embodiment is obtained by changing the configuration of the device heat exchanger 10 in the first to twentieth embodiments. The twenty-first embodiment is substantially the same as each of the first to twentieth embodiments in other configurations. Thus, only the differences from the first to twentieth embodiments will be described.

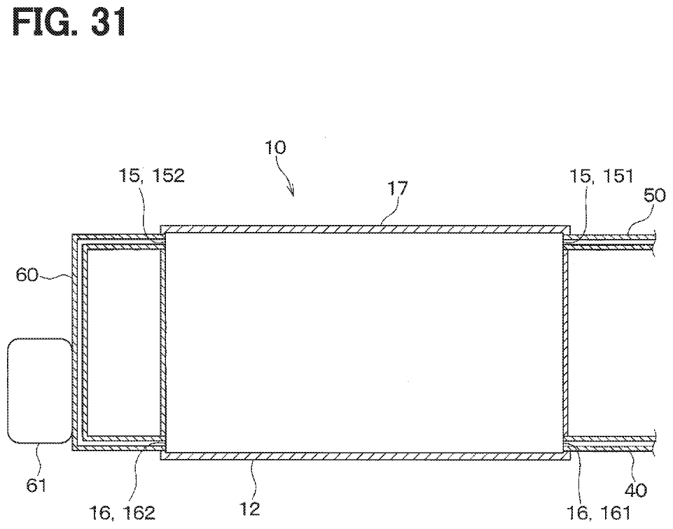

As shown in FIG. 31, the device heat exchanger 10 of the twenty-first embodiment does not have an upper tank, a lower tank, and a plurality of tubes. The device heat exchanger 10 of the twenty-first embodiment is formed by a single casing 17. Even the device heat exchanger 10 of the twenty-first embodiment can also exhibit the same operations and effects as the device heat exchanger 10 described in the first to twentieth embodiments.

### Twenty-Second Embodiment

A twenty-second embodiment will be described. The twenty-second embodiment is obtained by eliminating the cooling function from the device temperature regulator 1 in the first embodiment, and is substantially the same as the first embodiment in other configurations. Thus, only the differences from the first embodiment will be described below.

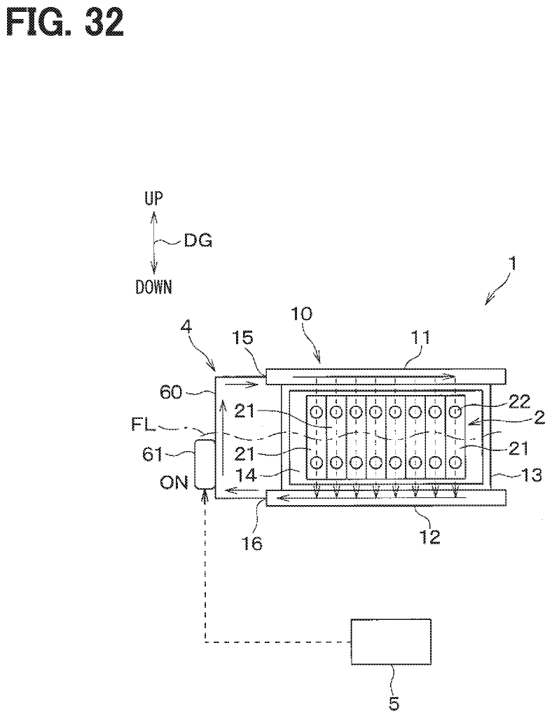

As shown in FIG. 32, the device heat exchanger 10 of the twenty-second embodiment does not include a condenser 30, a liquid phase passage 40, and a gas phase passage 50. The fluid circulation circuit 4 included in the device heat exchanger 10 of the twenty-second embodiment is configured as a fluid circuit in which the device heat exchanger 10 and the fluid passage 60 are closed.

The fluid passage 60 has one end thereof connected to the upper connection portion 15 of the device heat exchanger 10 and the other end thereof connected to the lower connection portion 16 of the device heat exchanger 10. The fluid passage 60 is provided with the heating portion 61 for heating the liquid-phase working fluid flowing through the fluid passage 60.

When warming up the assembled battery 2, the controller 5 turns on the energization of the heating portion 61 to actuate the heating portion 61. The working fluid heated by the heating portion 61 to become steam flows through the fluid passage 60 upward in the gravitational direction and then flows from the upper connection portion 15 into the upper tank 11 of the device heat exchanger 10. The gas-phase working fluid has the property of flowing toward a portion having a lower temperature. Thus, the gas-phase working fluid is divided into the plurality of tubes 131 in contact with the battery cells 21 having a low temperature and then condensed by heat exchange with each of the low-temperature battery cell 21. The battery cells 21 in this process are warmed up (i.e., heated) by the latent heat of condensation of the working fluid. Thereafter, the liquid-phase working fluids are merged together in the lower tank 12 of the device heat exchanger 10 and flow from the lower connection portion 16 to the fluid passage 60. As mentioned above, when warming up the assembled battery 2, the working fluid flows from the fluid passage 60 to the upper tank 11, the heat exchanging portion 13, the lower tank 12, and the fluid passage 60 in this order. That is, a loop-shaped flow passage is formed through the device heat exchanger 10 and the fluid passage 60.

The device temperature regulator 1 of the twenty-second embodiment can also exhibit the same operations and effects as the operations and effects exhibited during the warm-up by the device temperature regulator 1 described in the above first embodiment. The configuration of the twenty-second embodiment can also be appropriately combined with the configuration of any or all of the first to twenty-first embodiments mentioned above.

### Twenty-Third Embodiment

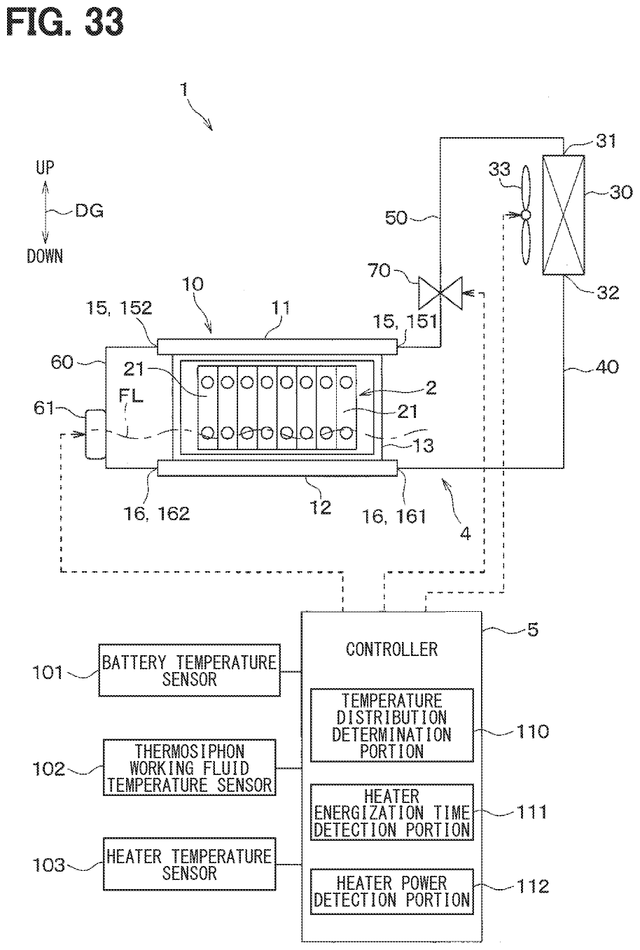

A twenty-third embodiment will be described with reference to FIGS. 33 to 39. As described above in the first to twenty-second embodiments, when the device temperature regulator 1 warms up the assembled battery 2 as the target device, the working fluid heated by the heating portion 61 into the gas phase flows from the fluid passage 60 into the device heat exchanger 10 via the upper connection portion 15. The gas-phase working fluid dissipates heat into the respective low-temperature battery cells 21 within the device heat exchanger 10 to be condensed into a liquid phase. At that time, within the device heat exchanger 10, the condensation amount of the working fluid is large in upper portions of the plurality of tubes 131, while the condensation amount of the working fluid is small in lower portions of the plurality of tubes 131 because the liquid-phase working fluid is retained in the bottom portions and the side walls of the tubes. Thus, the amount of heating by the latent heat of condensation of the working fluid is large in the upper portion of each battery cell 21, but the amount of heating is small in the lower portion of each battery cell 21, compared to the upper portion of the battery cell 21. Consequently, if variations in the temperature (that is, temperature distribution) between the upper portion and the lower portion of the battery cell 21 become large, current concentration might occur in the upper portion of the battery cell 21, which has the higher temperature, when charging and discharging the assembled battery 2.

For this reason, the twenty-third to twenty-sixth embodiments described below are intended to suppress the temperature distribution of the assembled battery 2 when the device temperature regulator 1 warms up the assembled battery 2.

As shown in FIG. 33, the configuration of the device temperature regulator 1 of the present embodiment is the same as the configuration described in the eighth embodiment. That is, the heating portion 61 is constituted of an electric heater which generates heat by energization.

FIG. 33 exemplifies the configurations of the controller 5 and the respective sensors connected to the controller 5. Signals transmitted from one or more battery temperature sensors 101, a working fluid temperature sensor 102, a heater temperature sensor 103, and the like are input to the controller 5. The one or more battery temperature sensors 101 detect the temperature of each or any of batteries. The working fluid temperature sensor 102 detects the temperature of the working fluid circulating in the thermosiphon circuit. The heater temperature sensor 103 detects the temperature of the heating portion 61. The controller 5 includes a temperature distribution determination portion 110 that determines the magnitude of the temperature distribution of the assembled battery 2, a heater energization time detection portion 111 that detects an energization time of the heating portion 61, a heater power detection portion 112 that detects the electric power supplied to the heating portion 61, and the like. The controller 5, the temperature distribution determination portion 110, the heater energization time detection portion 111, the heater power detection portion 112, and the like may be integrally or separately formed. This can also be applied to the embodiments described later.

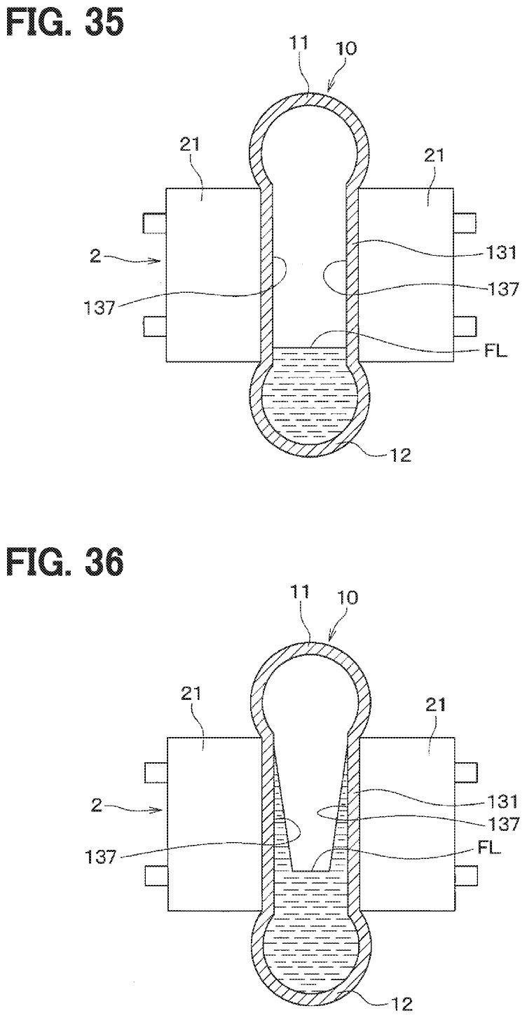

FIGS. 33 and 35 show the state of the device temperature regulator 1 before warming up the assembled battery 2. The controller 5 stops the energization of the heating portion 61. In this state, as shown in FIG. 35, the liquid level FL of the working fluid in the device heat exchanger 10 is located at a relatively low position in the height direction of the battery cell 21.

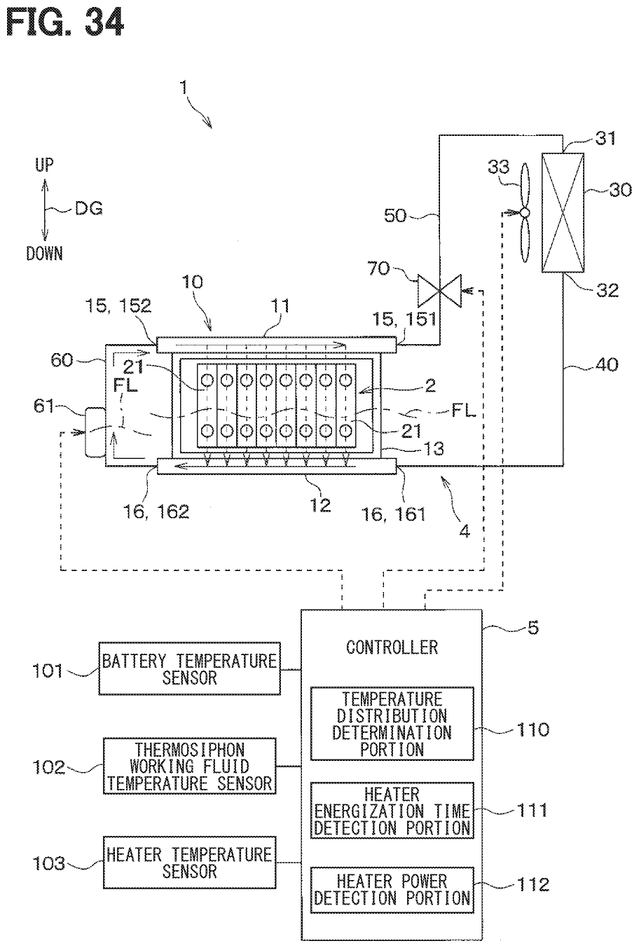

FIGS. 34 and 36 show the state in which the device temperature regulator 1 warms up the assembled battery 2. When warming up the assembled battery 2, the controller 5 turns on the energization of the heating portion 61 to heat the working fluid by using the heating portion 61. The controller 5 closes the fluid control valve 70, thereby blocking the flow of the working fluid in the gas phase passage 50.

FIG. 34 shows the flows of the working fluid formed when warming up the assembled battery 2 by solid line and broken line arrows. When the heating portion 61 heats the working fluid in the fluid passage 60, the working fluid in the fluid passage 60 evaporates to flow from the upper connection portion 15 into the upper tank 11 of the device heat exchanger 10. The gas-phase working fluid dissipates heat into the assembled batteries 2 to be condensed within the plurality of tubes 131 of the device heat exchanger 10. The battery cells 21 in this process are warmed up (i.e., heated) by the latent heat of condensation of the working fluid. Due to a head difference between the liquid level FL of the working fluid condensed in the device heat exchanger 10 and the liquid level FL of the working fluid in the fluid passage 60, the working fluid in the liquid phase of the device heat exchanger 10 flows from the lower tank 12 to the fluid passage 60 via the lower connection portion 16. The working fluid is heated and evaporates again by the heating portion 61 in the fluid passage 60 and then flows into the device heat exchanger 10. By such circulation of the working fluid, the device temperature regulator 1 can warm up the assembled battery 2.

As shown in FIG. 36, when warming up the assembled battery 2, the gas-phase working fluid is condensed in the plurality of tubes 131 of the device heat exchanger 10, and then the condensed working fluid flows downward in the gravitational direction along a side wall 137 in each tube 131. Consequently, the liquid film of the working fluid formed on the side wall 137 in the tube 131 is gradually thickened from the upper to lower side of the tube. Therefore, the liquid film of the working fluid is thin in an upper part of the inside of the device heat exchanger 10, so that the heating capacity exhibited by the latent heat of condensation of the working fluid for the battery cell 21 becomes relatively large. On the other hand, in a lower part of the device heat exchanger 10, the liquid film of the working fluid is thick, so that the heating capacity exhibited by the latent heat of condensation of the working fluid for the battery cell 21 becomes relatively small. In the lower part of the device heat exchanger 10, the liquid level FL of the working fluid is high, so that the heating capacity exhibited by the latent heat of condensation of the working fluid for the battery cell 21 becomes extremely small below the liquid level FL. Thus, the temperature distribution between the upper part and the lower part of each battery cell 21 gradually increases with the elapsed warm-up time.

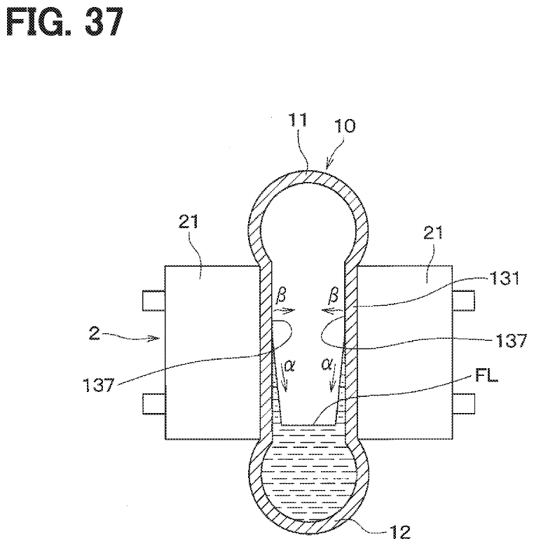

In the present embodiment, the controller 5 performs control to stop the energization of the heating portion 61 after a certain period of time has elapsed from the start of the warm-up of the assembled battery 2. Thus, the inflow of the working fluid from the fluid passage 60 to the device heat exchanger 10 is stopped. Consequently, the head difference between the liquid level FL in the device heat exchanger 10 and the liquid level FL in the fluid passage 60 is eliminated, so that the liquid level FL of the working fluid in the device heat exchanger 10 is lowered as shown in FIG. 37. As indicated by an arrow a in FIG. 37, the liquid film on the side wall 137 in the tube 131 of the device heat exchanger 10 flows downward. Furthermore, as indicated by an arrow 13 therein, the liquid film on the upper side wall in the tube 131 evaporates by heat exchange with a previously heated portion of the battery cell 21. Therefore, the liquid film on the side wall 137 in the tube 131 becomes thin, and consequently, an area of the side wall 137 in the tube 131 that is exposed to the gas-phase working fluid is widened. Thus, the working fluid can be condensed across a wide range from the upper portion to the lower portion of the tube 131. Consequently, the working fluid evaporated in the upper portion of the tube 131 with a relatively high temperature is condensed in the lower portion of the tube 131 with a relatively low temperature, so that the temperature distribution between the upper part and the lower part of each battery cell 21 gradually decreases. Because heat conduction also occurs inside each battery cell 21, the temperature equalization of each battery cell 21 is promoted over time.

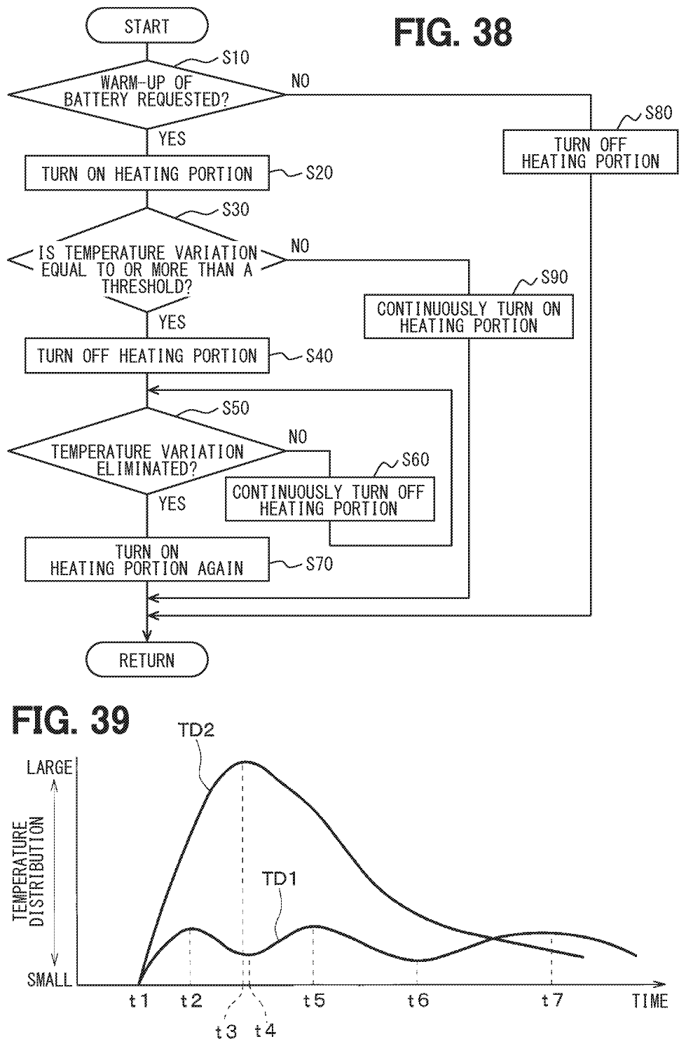

The controller 5 starts the energization of the heating portion 61 again after a certain period of time has elapsed from the stopping of the energization of the heating portion 61. In this way, the controller 5 can suppress an increase in the temperature distribution of the assembled battery 2 by executing warm-up of the assembled battery 2 while intermittently repeating the driving and stopping of the heating portion 61. Next, warm-up control processing performed by the controller 5 of the present embodiment will be described with reference to a flowchart of FIG. 38.

First, in step S10, the controller 5 determines whether a warm-up request for the assembled battery 2 is made. When a warm-up request for the assembled battery 2 is made, the controller 5 shifts its processing to step S20.

In step S20, the controller 5 starts the energization of the heating portion 61, and shifts the processing to step S30.

In step S30, the controller 5 determines whether the temperature distribution of the assembled battery 2 is equal to or more than a predetermined first temperature threshold. The first temperature threshold is a value set, for example, by an experiment or the like and previously stored in a memory of the controller 5.

Here, the temperature distribution determination portion 110 included in the controller 5 can detect the magnitude of the temperature distribution of the assembled battery 2 by the following method, based on signals and the like input from the respective sensors shown in FIG. 33.

In a first method, the controller 5 detects the magnitude of the temperature distribution of the assembled battery 2 based on the signals input from the plurality of battery temperature sensors 101 for detecting the temperature of the battery. The plurality of battery temperature sensors 101 are preferably installed in the upper part and the lower part of any or each of the battery cells 21. Thus, the controller 5 can directly detect the magnitude of the temperature distribution in the upper and lower parts of each battery cell 21.

In a second method, the controller 5 detects the magnitude of the temperature distribution of the assembled battery 2 based on the signals input from the heater temperature sensor 103 and from the working fluid temperature sensor 102. The heater temperature sensor 103 detects the temperature of the heating portion 61. The working fluid temperature sensor 102 detects the temperature of the working fluid circulating in the thermosiphon circuit of the device temperature regulator 1. As the temperature of the heating portion 61 becomes higher in comparison with the temperature of the working fluid circulating in the thermosiphon circuit, the heating capacity of the device temperature regulator 1 for the assembled battery 2 increases, so that the temperature distribution of the assembled battery 2 becomes larger.

In a third method, the controller 5 detects the magnitude of the temperature distribution of the assembled battery 2 based on the period of time during which the heating portion 61 continuously operates. The period of time during which the heating portion 61 continuously operates is a continuous energization ON time of the heating portion 61, which is detected by the heater energization time detection portion 111. The longer the period of time during which the heating portion 61 continuously operates, the larger the temperature distribution of the assembled battery 2 becomes.

The controller 5 can also detect the magnitude of the temperature distribution of the assembled battery 2 based on the period of time during which the heating portion 61 continuously stops its operation. The period of time during which the heating portion 61 continuously stops its operation is a continuous energization OFF time of the heating portion 61, which is detected by the heater energization time detection portion 111. The longer the period of time during which the heating portion 61 continuously stops its operation, the smaller the temperature distribution of the assembled battery 2 becomes.

In a fourth method, the controller 5 detects the magnitude of the temperature distribution of the assembled battery 2 based on the electric power supplied to the heating portion 61. The power supplied to the heating portion 61 is detected by the heater power detection portion 112. As the electric power supplied to the heating portion 61 becomes larger, the heating capacity of the device temperature regulator 1 for the assembled battery 2 increases, so that the temperature distribution of the assembled battery 2 becomes larger. As the electric power supplied to the heating portion 61 becomes smaller, the heating capacity of the device temperature regulator 1 for the assembled battery 2 decreases, so that the temperature distribution of the assembled battery 2 becomes small.

When the controller 5 determines that the temperature distribution of the assembled battery 2 is equal to or more than the predetermined first temperature threshold in step S30 of FIG. 38, the controller 5 shifts the processing to step S40.

In step S40, the controller 5 stops the energization of the heating portion 61. Thus, the inflow of the working fluid from the fluid passage 60 to the device heat exchanger 10 is stopped, so that the flow of the working fluid is stopped. Consequently, as shown in FIG. 37, the liquid level FL of the working fluid in the device heat exchanger 10 is lowered, thereby thinning the liquid film on the side wall 137 in the tube 131, resulting in a widened area of the side wall 137 in the tube 131 that is exposed to the gas-phase working fluid. Therefore, the working fluid can be condensed across a wide range from the upper portion to the lower portion of the tube 131. Consequently, the temperature distribution between the upper part and lower part of each battery cell 21 is gradually decreased. Because heat conduction also occurs inside each battery cell 21, the temperature distribution of each battery cell 21 decreases over time.

In step S50 following step S40, the controller 5 determines whether a temperature variation of the assembled battery 2 is eliminated. Specifically, the controller 5 determines whether the temperature distribution of the assembled battery 2 is equal to or less than a predetermined second temperature threshold. The second temperature threshold is a value set by, for example, an experiment or the like, and previously stored in the memory of the controller 5. When the controller 5 determines that the temperature distribution of the assembled battery 2 is equal to or more than the predetermined second temperature threshold, the controller 5 determines that the temperature variation of the assembled battery 2 is not eliminated and thus shifts the processing to step S60. The controller 5 maintains the state of stopping the energization of the heating portion 61 in step S60 and then shifts the processing to step S50. The processes of steps S50 and S60 are repeatedly performed until the temperature distribution of the assembled battery 2 is equal to or less than the predetermined second temperature threshold.

When the controller 5 determines that the temperature distribution of the assembled battery 2 is equal to or less than the predetermined second temperature threshold in step S50, the controller 5 determines that the temperature variation of the assembled battery 2 is eliminated and thus shifts the processing to step S70. In step S70, the controller 5 restarts the energization of the heating portion 61 and temporarily ends the processing. After a predetermined time has elapsed, the controller 5 repeatedly performs the above-mentioned processes again from step S10.

When the warm-up request for the assembled battery 2 is not made in the above-mentioned step S10, the controller 5 shifts the processing to the step S80 and temporarily ends the processing while stopping the energization of the heating portion 61. After the predetermined time has elapsed, the controller 5 repeatedly performs the above-mentioned processes again from step S10.

When the controller 5 determines that the temperature distribution of the assembled battery 2 is smaller than the predetermined first temperature threshold in step S30 mentioned above, the controller 5 shifts the processing to step S90, in which the controller continues the energization of the heating portion 61 and temporarily ends the processing. After the predetermined time has elapsed, the controller 5 repeatedly performs the above-mentioned processes again from step S10.

The operations and effects of the warm-up control processing of the present embodiment will be described with reference to the graph of FIG. 39.

FIG. 39 shows, by a solid line TD1, the transition of the temperature distribution of the assembled battery 2 under the warm-up control processing of the present embodiment. On the other hand, FIG. 39 shows, by a solid line TD2, the transition of the temperature distribution of the assembled battery 2 when the energization of the heating portion 61 is continuously ON during warm-up without performing the warm-up control processing of the present embodiment.

As indicated by the solid line TD2, the temperature distribution of the assembled battery 2 increases over time from time t1 to time t3 when the energization of the heating portion 61 is continuously ON during warm-up without performing the warm-up control processing of the present embodiment. At time t3, the temperature distribution of the assembled battery 2 becomes maximum. After the warm-up of the assembled battery 2 is completed at time t3, the energization of the heating portion 61 is stopped, and consequently the temperature distribution of the assembled battery 2 decreases over time.

As indicated by the solid line TD1, while performing the warm-up control processing of the present embodiment, the energization of the heating portion 61 is conducted from time t1 to time t2, from time t4 to time t5, and from time t6 to time t7, while the energization of the heating portion 61 is stopped from time t2 to time t4, from time t5 to time t6, and from time t7 and thereafter. In this way, when the on/off of the energization of the heating portion 61 is intermittently repeated during warm-up, the temperature distribution of the assembled battery 2 changes within a certain range. Therefore, the controller 5 can warm up the assembled battery 2 while suppressing an increase in the temperature distribution of the assembled battery 2 by intermittently repeating the driving and stopping of the heating portion 61 during warm-up of the assembled battery 2. Consequently, when the assembled battery 2 is charged and discharged, the device temperature regulator 1 can prevent the current concentration from occurring in a portion of the battery cell 21 having a high temperature, thereby preventing the deterioration and breakage of the assembled battery 2.

### Twenty-Fourth Embodiment

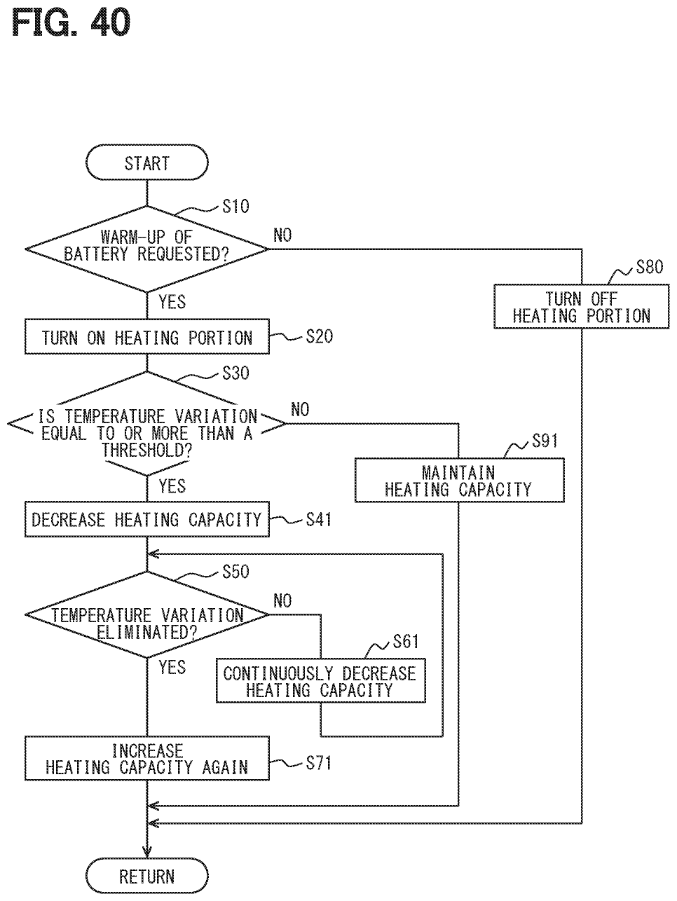

The twenty-fourth embodiment will be described with reference to FIGS. 40 to 43. The configuration of the device temperature regulator 1 of the present embodiment is the same as the configuration described in the twenty-third embodiment. However, this embodiment differs from the twenty-third embodiment described above in the warm-up control processing performed by the controller 5. In the twenty-third embodiment described above, the controller 5 suppresses an increase in the temperature distribution of the assembled battery 2 by the control that involves intermittently turning on and off the energization of the heating portion 61 during the warm-up of the assembled battery 2. On the other hand, in the present embodiment, the controller 5 suppresses an increase in the temperature distribution of the assembled battery 2 by the control that involves repeatedly increasing and decreasing the heating capacity of the heating portion 61 during warm-up of the assembled battery 2.

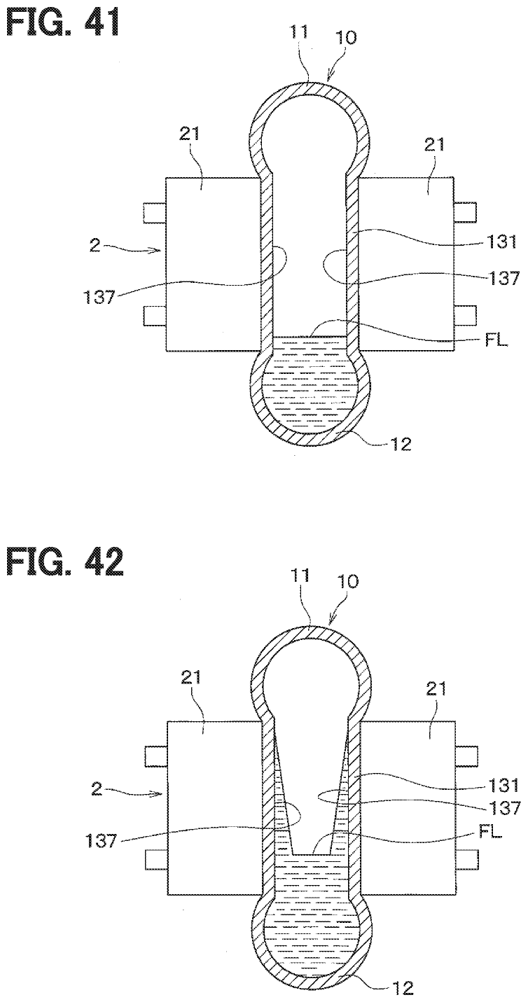

FIG. 41 shows the state of the device temperature regulator 1 before warming up the assembled battery 2. The controller 5 stops the energization of the heating portion 61. In this state, the liquid level FL of the working fluid in the device heat exchanger 10 is located at a relatively low position in the height direction of the battery cell 21.

FIG. 42 shows the state in which the device temperature regulator 1 warms up the assembled battery 2. When warming up the assembled battery 2, the controller 5 energizes the heating portion 61 to heat the working fluid by using the heating portion 61. When warming up the assembled battery 2, the gas-phase working fluid is condensed in the plurality of tubes 131 of the device heat exchanger 10, and then the condensed working fluid flows downward in the gravitational direction along the side wall 137 in each tube 131. Consequently, the liquid film of the working fluid formed on the side wall 137 in the tube 131 is gradually thickened from the upper to lower side of the tube. Therefore, in the upper part of the inside of the device heat exchanger 10, the liquid film of the working fluid is thin, so that the heating capacity exhibited by the latent heat of condensation of the working fluid for the battery cell 21 becomes large. On the other hand, in the lower part of the device heat exchanger 10, the liquid film of the working fluid is thick, so that the heating capacity exhibited by the latent heat of condensation of the working fluid for the battery cell 21 becomes relatively small. In the lower part of the device heat exchanger 10, the liquid level FL of the working fluid is high, so that the heating capacity exhibited by the latent heat of condensation of the working fluid for the battery cell 21 becomes extremely small below the liquid level FL. Thus, the temperature distribution between the upper part and the lower part of each battery cell 21 gradually increases with the elapsed warm-up time.

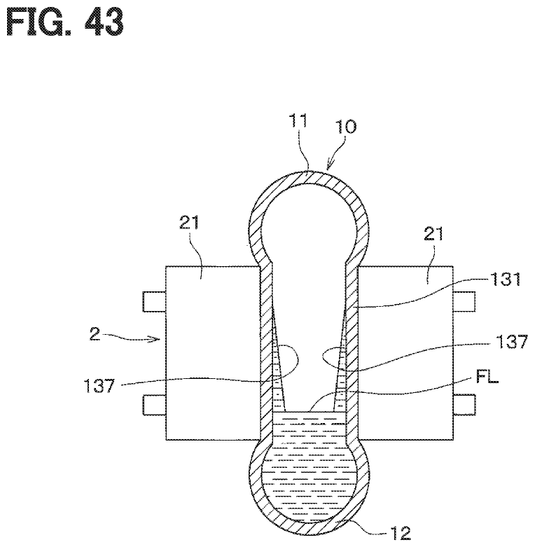

In the present embodiment, the controller 5 performs control to decrease the heating capacity of the heating portion 61 after a certain period of time has elapsed from the start of the warm-up of the assembled battery 2. Thus, the inflow amount of the working fluid from the fluid passage 60 into the device heat exchanger 10 is reduced, making the flow of the working fluid moderate. Consequently, as shown in FIG. 43, the liquid level FL of the working fluid in the device heat exchanger 10 is lowered. The liquid film on the side wall 137 within the tube 131 of the device heat exchanger 10 is thinned, thereby reducing a difference in the heating capacity exhibited by the latent heat of condensation of the working fluid between the upper and lower portions of the tube 131. That is, a difference in the heat exchange amount between the upper and lower portions of the tube 131 is reduced. The heat conduction also occurs inside each battery cell 21. Therefore, the temperature distribution between the upper part and the lower part of each battery cell 21 gradually decreases with the elapsed warm-up time from the start of decreasing the heating capacity.

The controller 5 performs control to increase the heating capacity of the heating portion 61 again after a certain period of time has elapsed from the decrease in the heating capacity of the heating portion 61. In this way, the controller 5 can suppress an increase in the temperature distribution of the assembled battery 2 by executing the warm-up of the assembled battery 2 while repeatedly increasing and decreasing the heating capacity of the heating portion 61.

The warm-up control processing performed by the controller 5 of the present embodiment will be described with reference to a flowchart of FIG. 40.

The processes from step S10 to step S30 are the same as those described in the twenty-third embodiment.

When the controller 5 determines that the temperature distribution of the assembled battery 2 is equal to or more than the predetermined first temperature threshold in step S30, the controller 5 shifts the processing to step S41. In step S41, the controller 5 decreases the amount of power supplied to the heating portion 61, thereby decreasing the heating capacity of the heating portion 61. Thus, the inflow amount of the gas-phase working fluid from the fluid passage 60 into the device heat exchanger 10 is reduced, making the flow of the working fluid moderate. Consequently, as shown in FIG. 43, the liquid level FL of the working fluid in the device heat exchanger 10 is lowered. The liquid film on the side wall 137 within the tube 131 of the device heat exchanger 10 is thinned, thereby reducing a difference in the heat exchange amount between the upper and lower portions of the tube 131. The heat conduction also occurs inside each battery cell 21. Therefore, the temperature distribution between the upper part and the lower part of each battery cell 21 gradually decreases over time.

In step S50 following step S41, the controller 5 determines whether a temperature variation of the assembled battery 2 is eliminated. When the controller 5 determines that the temperature variation of the assembled battery 2 is not eliminated, the controller 5 shifts the processing to step S61. The controller 5 maintains the state of decreasing the heating capacity of the heating portion 61 in step S61. The processes of steps S50 and S61 are repeatedly performed until the temperature variation of the assembled battery 2 is eliminated.

On the other hand, when the controller 5 determines that the temperature variation of the assembled battery 2 is eliminated in step S50, the controller 5 shifts the processing to step S71. In step S71, the controller 5 increases the heating capacity of the heating portion 61 again. Specifically, the controller 5 increases the amount of power supplied to the heating portion 61. After the process in step S71, the processing is temporarily ended. After a predetermined time has elapsed, the controller 5 repeatedly performs the above-mentioned processes again from step S10.

When the controller 5 determines that the temperature distribution of the assembled battery 2 is smaller than the predetermined first temperature threshold in step S30 mentioned above, the controller 5 shifts the processing to step S91, in which the controller continuously maintains the heating capacity of the heating portion 61. After the predetermined time has elapsed, the controller 5 repeatedly performs the above-mentioned processes again from step S10.

The warm-up control processing described in the present embodiment can exhibit the same operations and effects as the warm-up control processing in the twenty-third embodiment described above.

### Twenty-Fifth Embodiment

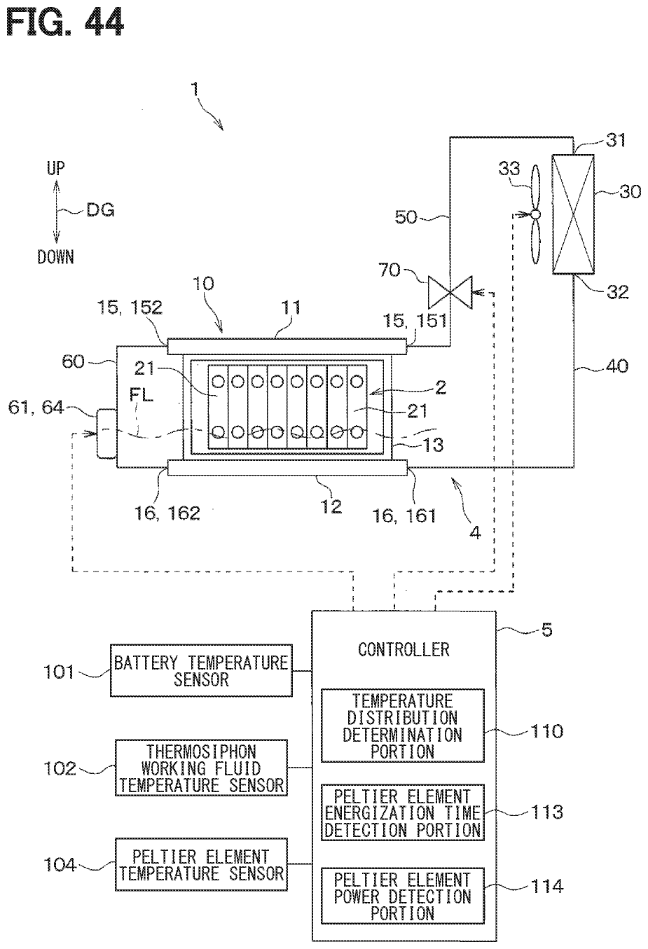

The twenty-fifth embodiment will be described with reference to FIG. 44. The twenty-fifth embodiment is obtained by employing a Peltier element 64 as the heating portion 61, in place of the electric heater, in the twenty-third and twenty-fourth embodiments described above.

FIG. 44 exemplifies the respective sensors connected to the controller 5.

Signals transmitted from the battery temperature sensor 101, the working fluid temperature sensor 102, a Peltier element temperature sensor 104 for detecting the temperature of the Peltier element 64, and the like are input to the controller 5. The controller 5 includes the temperature distribution determination portion 110, a Peltier element energization time detection portion 113 that detects an energization time of the Peltier element 64, a Peltier element power detection portion 114 that detects the electric power supplied to the Peltier element 64, and the like.

The warm-up control processing performed by the controller 5 of the present embodiment is the same as the warm-up control processing described in each of the twenty-third and twenty-fourth embodiments described above.

Here, in the present embodiment, the temperature distribution determination portion 110 included in the controller 5 can detect the magnitude of the temperature distribution of the assembled battery 2 based on signals and the like input from the respective sensors shown in FIG. 44 by the following method.

In a first method, the controller 5 detects the magnitude of the temperature distribution of the assembled battery 2 based on the signals input from the plurality of battery temperature sensors 101 for detecting the temperature of the battery. Thus, the controller 5 can directly detect the magnitude of the temperature distribution in each of the upper and lower parts of the battery cell 21.

In a second method, the controller 5 detects the magnitude of the temperature distribution of the assembled battery 2 based on the signals input from the Peltier element temperature sensor 104 and the working fluid temperature sensor 102. As the temperature of the Peltier element 64 becomes higher in comparison with the temperature of the working fluid circulating in the thermosiphon circuit, the heating capacity of the device temperature regulator 1 for the assembled battery 2 increases, so that the temperature distribution of the assembled battery 2 becomes larger.

In a third method, the controller 5 detects the magnitude of the temperature distribution of the assembled battery 2 based on the period of time during which the Peltier element 64 continuously operates or the period of time during which the Peltier element 64 continuously stops its operation. The longer the period of time during which the Peltier element 64 continuously operates, the larger the temperature distribution of the assembled battery 2 becomes. The longer the period of time during which the Peltier element 64 continuously stops its operation, the smaller the temperature distribution of the assembled battery 2 becomes.

In a fourth method, the controller 5 detects the magnitude of the temperature distribution of the assembled battery 2 based on the electric power supplied to the Peltier element 64. As the electric power supplied to the Peltier element 64 becomes larger, the heating capacity of the device temperature regulator 1 for the assembled battery 2 increases, so that the temperature distribution of the assembled battery 2 becomes larger.

The present embodiment can also exhibit the same operations and effects as those in the twenty-third and twenty-fourth embodiments described above.

### Twenty-Sixth Embodiment

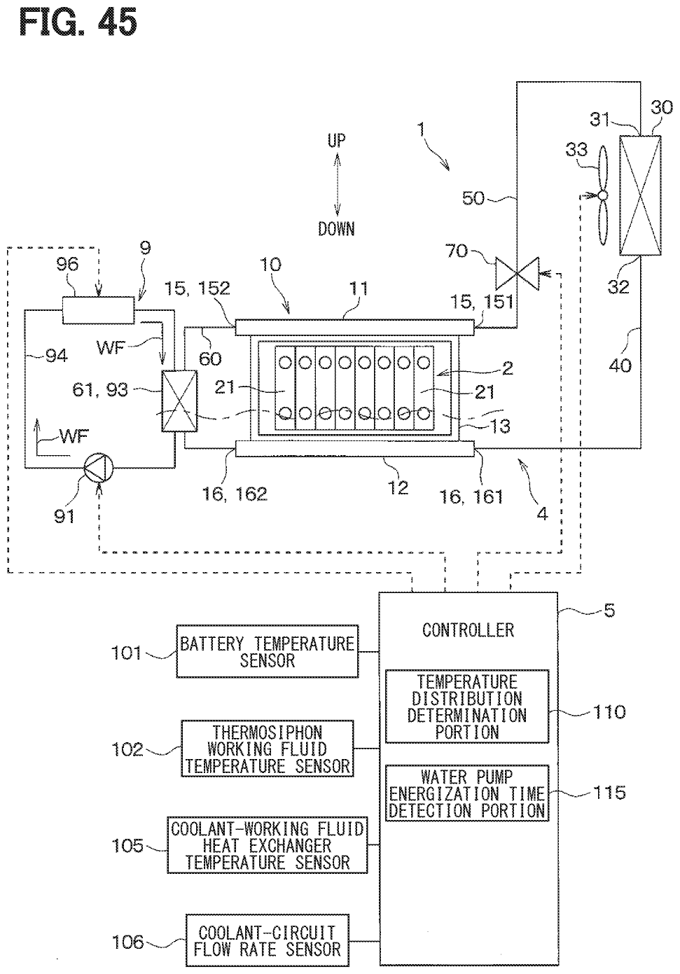

The twenty-sixth embodiment will be described with reference to FIG. 45. The present embodiment is obtained by changing the configuration regarding the heating portion 61 in the above-mentioned twenty-third to twenty-fifth embodiments. The heating portion 61 of the present embodiment is a coolant-working fluid heat exchanger 93 and is configured to cause the hot water to flow therethrough during warm-up of the assembled battery 2.

The device temperature regulator 1 of the present embodiment utilizes the coolant circuit 9. The coolant circuit 9 includes a water pump 91, a hot coolant heater 96, the coolant-working fluid heat exchanger 93, and a coolant pipe 94 connecting them. Water flows through the coolant circuit 9.

The water pump 91 pressure-feeds water and circulates the water in the coolant circuit 9 as indicated by the arrow WF of FIG. 45. The hot coolant heater 96 is capable of heating the water that flows through the coolant circuit 9 into hot water. The hot water flowing out of the hot coolant heater 96 flows into the coolant-working fluid heat exchanger 93. The coolant-working fluid heat exchanger 93 is a heat exchanger that exchanges heat between the working fluid flowing through the fluid passage 60 of the device temperature regulator 1 and the hot water flowing through the coolant circuit 9. That is, the coolant-working fluid heat exchanger 93 as the heating portion 61 of the present embodiment can heat the working fluid that flows through the fluid passage 60 of the device temperature regulator 1 by the hot water flowing through the coolant circuit 9. FIG. 45 exemplifies the respective sensors connected to the controller 5.

Signals transmitted from these sensors are input to the controller 5. These sensors include the battery temperature sensor 101, the working fluid temperature sensor 102, a coolant-working fluid temperature sensor 105 for detecting the temperature of water flowing through the coolant-working fluid heat exchanger 93, a coolant-circuit flow rate sensor 106 that detects the flow rate of water flowing through the coolant circuit 9, and the like. The controller 5 includes the temperature distribution determination portion 110, a water pump energization time detection portion 115 that detects the energization time of the water pump 91, and the like.

The warm-up control processing performed by the controller 5 of the present embodiment is the same as the warm-up control processing described in the twenty-third and twenty-fourth embodiments described above.

Here, in the present embodiment, the temperature distribution determination portion 110 included in the controller 5 can detect the magnitude of the temperature distribution of the assembled battery 2 based on signals and the like input from the respective sensors shown in FIG. 45 by the following method.

In a first method, the controller 5 detects the magnitude of the temperature distribution of the assembled battery 2 based on the signals input from the plurality of battery temperature sensors 101 for detecting the temperature of the battery. Thus, the controller 5 can directly detect the magnitude of the temperature distribution in each of the upper and lower parts of the battery cell 21.

In a second method, the controller 5 detects the magnitude of the temperature distribution of the assembled battery 2, based on a difference between the temperature of water flowing through the coolant-working fluid heat exchanger 93 detected by the coolant-working fluid temperature sensor 105 and the temperature of the assembled battery 2 detected by the battery temperature sensors 101. As the temperature of water flowing through the coolant-working fluid heat exchanger 93 (i.e., the temperature of hot water) becomes higher in comparison with the temperature of the assembled battery 2, the heating capacity for the assembled battery 2 increases, so that the temperature distribution of the assembled battery 2 becomes larger.

In a third method, the controller 5 detects the magnitude of the temperature distribution of the assembled battery 2 based on the flow rate of the water flowing through the coolant circuit 9 as well as the difference between the temperature of the water flowing through the coolant-working fluid heat exchanger 93 and the temperature of the assembled battery 2. The temperature of water flowing through the coolant-working fluid heat exchanger 93 is detected by the coolant-working fluid temperature sensor 105. The temperature of the assembled battery 2 is detected by the battery temperature sensors 101. The flow rate of the water flowing through the coolant circuit 9 is detected by the coolant-circuit flow rate sensor 106. As the flow rate of the water flowing through the coolant circuit 9 becomes higher, the heating capacity for the assembled battery 2 increases, so that the temperature distribution of the assembled battery 2 becomes larger. As the flow rate of the water flowing through the coolant circuit 9 becomes lower, the temperature distribution of the assembled battery 2 becomes smaller.

In a fourth method, the controller 5 detects the magnitude of the temperature distribution of the assembled battery 2 based on a difference between the temperature of the water flowing through the coolant-working fluid heat exchanger 93 and the temperature of the working fluid circulating in the thermosiphon circuit. The temperature of the water flowing through the coolant-working fluid heat exchanger 93 is detected by the coolant-working fluid temperature sensor 105 through the controller 5. The temperature of the working fluid circulating in the thermosiphon circuit is detected by the working fluid temperature sensor 102. As the temperature of the water flowing through the coolant-working fluid heat exchanger 93 becomes higher in comparison with the temperature of the working fluid circulating in the thermosiphon circuit, the heating capacity for the assembled battery 2 increases, so that the temperature distribution of the assembled battery 2 becomes larger.

In a fifth method, the controller 5 detects the magnitude of the temperature distribution of the assembled battery 2 based on the period of time during which the heating portion 61 continuously operates. The period of time during which the heating portion 61 continuously operates is a continuous energization ON time of the water pump 91, which is detected by the water pump energization time detection portion 115. The longer the period of time during which the water pump 91 continuously operates, the larger the temperature distribution of the assembled battery 2 becomes. The longer the period of time during which the water pump 91 continuously stops its operation, the smaller the temperature distribution of the assembled battery 2 becomes.

In the warm-up control processing performed by the controller 5 of the present embodiment, the controller 5 reduces the heating capacity of the heating portion 61 when the temperature distribution of the assembled battery 2 becomes larger. Specifically, the reduction of the heating capacity of the heating portion 6 is performed by decreasing the flow rate of the water from the water pump 91, by decreasing the heating capacity of the hot coolant heater 96, or the like. When the temperature distribution of the assembled battery 2 becomes large, the controller 5 stops the operation of the heating portion 61. Specifically, the stopping of the operation of the heating portion 61 is performed by stopping the operation of the water pump 91 or the like.

The present embodiment can also exhibit the same operations and effects as those in the twenty-third to twenty-fifth embodiments described above.

### Twenty-Seventh Embodiment

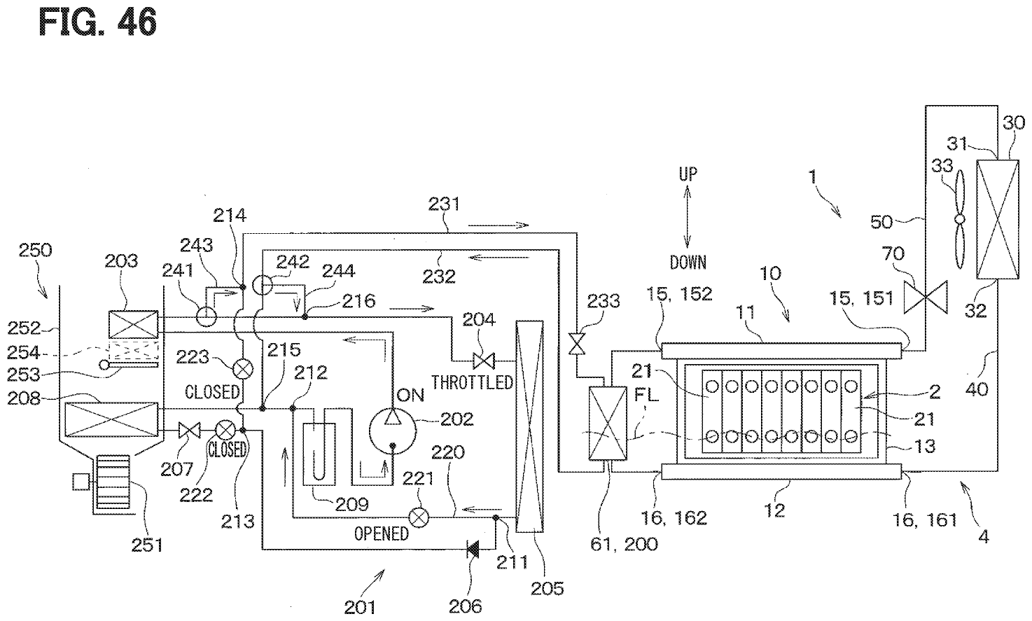

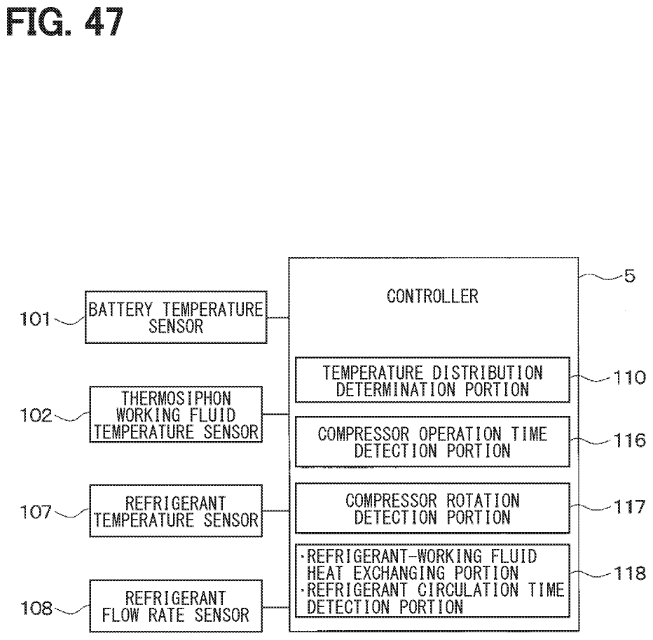

A twenty-seventh embodiment will be described with reference to FIGS. 46 and 47. The present embodiment is obtained by changing the configuration regarding the heating portion 61 in the above-mentioned twenty-third to twenty-sixth embodiments described above. The heating portion 61 of the present embodiment is a refrigerant-working fluid heat exchanger 200 and is configured to cause the refrigerant having a high temperature to flow therethrough during warm-up of the assembled battery 2. FIG. 46 omits the illustration of signal lines connecting the controller 5 and the respective devices, as well as the controller 5 and the sensors in order to prevent the complication of the figures. The configurations of the controller 5 and the sensors are shown in FIG. 47.

The device temperature regulator 1 of the present embodiment utilizes a heat pump cycle 201. The heat pump cycle 201 includes a compressor 202, an interior condenser 203, a first expansion valve 204, an exterior unit 205, a check valve 206, a second expansion valve 207, an evaporator 208, an accumulator 209, a refrigerant pipe connecting them, and the like.

A bypass pipe 220 connects a first branch portion 211 provided between the exterior unit 205 and the check valve 206 to a second branch portion 212 provided between the evaporator 208 and the accumulator 209. A first solenoid valve 221 is provided in the bypass pipe 220, and a second solenoid valve 222 is provided in a refrigerant pipe that connects the check valve 206 and the second expansion valve 207. The refrigerant-working fluid heat exchanger 200 as the heating portion 61 is connected to a first pipe 231 and a second pipe 232 for supplying the refrigerant to the refrigerant-working fluid heat exchanger 200. The first pipe 231 has one end thereof connected to the refrigerant-working fluid heat exchanger 200 and the other end thereof connected to a third branch portion 213 provided at any point of the refrigerant pipe that connects the check valve 206 and the second solenoid valve 222. A fourth branch portion 214 provided at any point of the first pipe 231 is connected to a pipe 243 that extends from a first three-way valve 241 provided between the interior condenser 203 and the first expansion valve 204. A third expansion valve 233 is provided at any point of the first pipe 231 between the fourth branch portion 214 and the refrigerant-working fluid heat exchanger 200. A third solenoid valve 223 is provided at any point of the first pipe 231 between the fourth branch portion 214 and the third branch portion 213.

The second pipe 232 has one end thereof connected to the refrigerant-working fluid heat exchanger 200 and the other end thereof connected to a fifth branch portion 215 provided at any point of the refrigerant pipe that connects the evaporator 208 and the second branch portion 212. A second three-way valve 242 is provided at any point of the second pipe 232. A pipe 244 extending from the second three-way valve 242 is connected to a sixth branch portion 216 provided between the first three-way valve 241 and the first expansion valve 204.

The interior condenser 203 and the evaporator 208, which are included in the heat pump cycle 201, constitute a part of a heating, ventilation and air-conditioning (HVAC) unit 250 for air-conditioning of the interior of the vehicle cabin. The HVAC unit 250 cools an air flowing from an air-conditioning blower 251 through a ventilation passage of an air-conditioning case 252 by the evaporator 208 and/or heats the air by the interior condenser 203, thereby blowing the resulting conditioned air into the vehicle cabin. The HVAC unit 250 includes an air mix door 253 between the evaporator 208 and the interior condenser 203. The HVAC unit 250 may include a heater core 254.

### <Operation During Warm-Up>

FIG. 46 shows the flows of the working fluid and refrigerant formed when the device temperature regulator 1 warms up the assembled battery 2, by solid line and broken line arrows. During the warm-up of the assembled battery 2, the controller 5 switches the first three-way valve 241 to cause part of the refrigerant to flow from the interior condenser 203 to the fourth branch portion 214 and also switches the second three-way valve 242 to cause the refrigerant to flow from the second pipe 232 to the sixth branch portion 216. The controller 5 throttles the first expansion valve 204, opens the first solenoid valve 221, closes the second solenoid valve 222 and the third solenoid valve 223, opens the third expansion valve 233 or appropriately throttles its opening degree, and turns on the compressor 202.

Thus, the refrigerant discharged from the compressor 202 circulates in the heat pump cycle 201 from the interior condenser 203 to the first expansion valve 204, the exterior unit 205, the first solenoid valve 221, the accumulator 209, and the compressor 202 in this order within the heat pump cycle 201. Part of the refrigerant circulating in the heat pump cycle 201 flows from the first three-way valve 241 to the first pipe 231, the third expansion valve 233, the refrigerant-working fluid heat exchanger 200, the second pipe 232, the second three-way valve 242, and the sixth branch portion 216. The refrigerant flowing from the first pipe 231 into the refrigerant-working fluid heat exchanger 200 is decompressed by the third expansion valve 233 to an appropriate temperature for warm-up of the battery and heats the working fluid flowing through the fluid passage 60 of the device temperature regulator 1. At this time, the working fluid flowing through the fluid passage 60 of the device temperature regulator 1 evaporates (i.e., vaporizes) in the refrigerant-working fluid heat exchanger 200, flows upward, and is then supplied from the upper connection portion 15 to the device heat exchanger 10. Thereafter, the working fluid inside the device heat exchanger 10 dissipates heat into the battery cells 21 to be condensed. Due to a head difference between the working fluid condensed in the device heat exchanger 10 and the working fluid in the fluid passage 60, the liquid-phase working fluid in the device heat exchanger 10 returns from the lower connection portion 16 to the refrigerant-working fluid heat exchanger 200 through the fluid passage 60.

When simultaneously performing the air-heating of the interior of the vehicle cabin by the HVAC unit 250 and the warm-up of the assembled battery 2, the opening degree of the third expansion valve 233 needs to be adjusted because the temperature required of the interior condenser 203 is different from the temperature required for the warm-up of the assembled battery 2. When warming up the assembled battery 2 only without any air-conditioning of the interior of the vehicle cabin by the HVAC unit 250, the amount of the refrigerant discharged from the compressor 202 may be adjusted to be an amount of the refrigerant required for the warm-up of the assembled battery 2, while opening the third expansion valve 233.

Although the device temperature regulator 1 in the present embodiment also employs the heat pump cycle 201 used for the air-conditioning of the interior of the vehicle cabin, the present embodiment is not limited thereto. Alternatively, another heat pump cycle dedicated for the heating portion 61 of the device temperature regulator 1 may be employed, aside from the heat pump cycle 201 for the air-conditioning of the interior of the vehicle cabin.

In the present embodiment, the working fluid flowing through the fluid passage 60 of the device temperature regulator 1 can also be cooled with the refrigerant flowing through the refrigerant-working fluid heat exchanger 200 using the heat pump cycle 201. However, the description thereof is omitted herein.

FIG. 47 exemplifies the respective sensors connected to the controller 5. Signals transmitted from the battery temperature sensors 101, the working fluid temperature sensor 102, a refrigerant temperature sensor 107, a refrigerant flow rate sensor 108, and the like are input to the controller 5. The refrigerant temperature sensor 107 detects the temperature of the refrigerant flowing through the refrigerant-working fluid heat exchanger 200. The refrigerant flow rate sensor 108 detects the flow rate of the refrigerant flowing through the heat pump cycle 201. The controller 5 includes the temperature distribution determination portion 110, a compressor operation time detection portion 116, a compressor rotation speed detection portion 117, a refrigerant circulation time detection portion 118, and the like. The compressor operation time detection portion 116 detects the operation time of the compressor 202. The compressor rotation speed detection portion 117 detects the rotation speed of the compressor 202. The refrigerant circulation time detection portion 118 detects the refrigerant circulation time of the refrigerant-working fluid heat exchanger 200.

The warm-up control processing performed by the controller 5 of the present embodiment is the same as the warm-up control processing described in the twenty-third and twenty-fourth embodiments described above.

Here, in the present embodiment, the temperature distribution determination portion 110 included in the controller 5 can detect the magnitude of the temperature distribution of the assembled battery 2 by the following method, based on signals and the like input from the respective sensors shown in FIG. 47.

Here, in a first method, the controller 5 detects the magnitude of the temperature distribution of the assembled battery 2 based on signals input from the plurality of battery temperature sensors 101 for detecting the temperature of the battery. Thus, the controller 5 can directly detect the magnitude of the temperature distribution in each of the upper and lower parts of the battery cell 21.

In a second method, the controller 5 detects the magnitude of the temperature distribution of the assembled battery 2 based on a difference between the temperature of the refrigerant flowing through the refrigerant-working fluid heat exchanger 200 detected by the refrigerant temperature sensor 107 and the temperature of the assembled battery 2 detected by the battery temperature sensors 101. As the temperature of the refrigerant flowing through the refrigerant-working fluid heat exchanger 200 becomes higher in comparison with the temperature of the assembled battery 2, the heating capacity for the assembled battery 2 increases, so that the temperature distribution of the assembled battery 2 becomes larger.

In a third method, the controller 5 detects the magnitude of the temperature distribution of the assembled battery 2 based on the flow rate of the refrigerant flowing in the heat pump cycle as well as the difference between the temperature of the refrigerant flowing through the refrigerant-working fluid heat exchanger 200 and the temperature of the assembled battery 2. The temperature of the refrigerant flowing through the refrigerant-working fluid heat exchanger 200 is detected by the refrigerant temperature sensor 107. The temperature of the assembled battery 2 is detected by the battery temperature sensors 101. The flow rate of the refrigerant flowing in the heat pump cycle is detected by the refrigerant flow rate sensor 108. As the flow rate of the refrigerant flowing in the heat pump cycle becomes higher, the heating capacity for the assembled battery 2 increases, so that the temperature distribution of the assembled battery 2 becomes larger. On the other hand, as the flow rate of the refrigerant flowing in the heat pump cycle becomes lower, the temperature distribution of the assembled battery 2 becomes smaller.

In a fourth method, the controller 5 detects the magnitude of the temperature distribution of the assembled battery 2 based on a difference between the temperature of the refrigerant flowing through the refrigerant-working fluid heat exchanger 200 and the temperature of the working fluid circulating in the thermosiphon circuit. The temperature of the refrigerant flowing through the refrigerant-working fluid heat exchanger 200 is detected by the refrigerant temperature sensor 107. The temperature of the working fluid circulating in the thermosiphon circuit is detected by the working fluid temperature sensor 102. As the temperature of the refrigerant flowing through the refrigerant-working fluid heat exchanger 200 becomes higher in comparison with the temperature of the working fluid circulating in the thermosiphon circuit, the heating capacity for the assembled battery 2 increases, so that the temperature distribution of the assembled battery 2 becomes larger.

In a fifth method, the controller 5 detects the magnitude of the temperature distribution of the assembled battery 2 based on the period of time during which the heating portion 61 continuously operates. The period of time during which the heating portion 61 continuously operates is a continuous operation time of the compressor 202, which is detected by the compressor operation time detection portion 116. The longer the period of time during which the compressor 202 continuously operates, the larger the temperature distribution of the assembled battery 2 becomes. The longer the period of time during which the compressor 202 continuously stops its operation, the smaller the temperature distribution of the assembled battery 2 becomes.

In a sixth method, the controller 5 detects the magnitude of the temperature distribution of the assembled battery 2 based on the rotation speed of the compressor 202. The rotation speed of the compressor 202 is detected by a compressor rotation speed detection portion 117. The higher the rotation speed of the compressor 202, the larger the temperature distribution of the assembled battery 2 becomes. The lower the rotation speed of the compressor 202, the smaller the temperature distribution of the assembled battery 2 becomes.

In a seventh method, the controller 5 detects the magnitude of the temperature distribution of the assembled battery 2, based on a circulation time of the refrigerant flowing through the refrigerant-working fluid heat exchanger 200. The circulation time of the refrigerant flowing through the refrigerant-working fluid heat exchanger 200 is detected by the refrigerant circulation time detection portion 118. The longer the circulation time of the refrigerant flowing through the refrigerant-working fluid heat exchanger 200, the larger the temperature distribution of the assembled battery 2 becomes. The longer the circulation blocking time of the refrigerant flowing through the refrigerant-working fluid heat exchanger 200, the smaller the temperature distribution of the assembled battery 2 becomes.

In the warm-up control processing performed by the controller 5 of the present embodiment, the controller 5 reduces the heating capacity of the heating portion 61 when the temperature distribution of the assembled battery 2 becomes larger. Specifically, the reduction of the heating capacity of the heating portion 61 is performed by reducing the rotation speed of the compressor 202 or the like. When the temperature distribution of the assembled battery 2 becomes large, the controller 5 stops the operation of the heating portion 61. Specifically, the stopping of the operation of the heating portion 61 is performed by stopping the operation of the compressor 202 or the like.

The present embodiment can also exhibit the same operations and effects as those in the twenty-third to twenty-sixth embodiments described above.

### Twenty-Eighth Embodiment

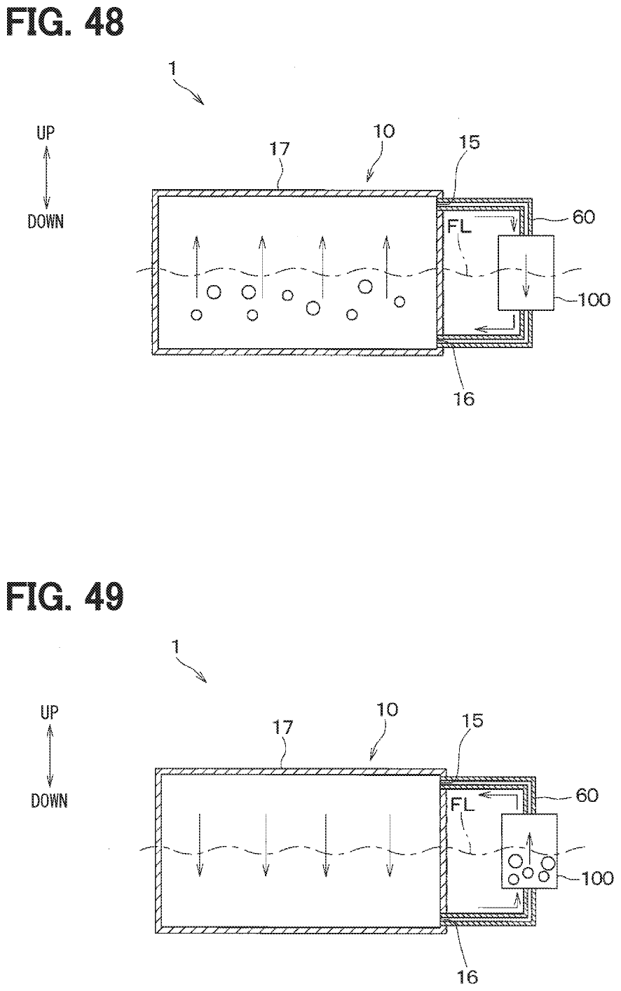

A twenty-eighth embodiment will be described with reference to FIGS. 48 and 49. In the twenty-eighth embodiment, the device temperature regulator 1 includes the device heat exchanger 10, the upper connection portion 15, the lower connection portion 16, the fluid passage 60, and a heat supply member 100. The device heat exchanger 10 may be formed by the single casing 17, in such a manner as that described in the twenty-first embodiment. Alternatively, the device heat exchanger 10 may be formed by the upper tank 11, the lower tank 12, and the heat exchanging portion 13 having a plurality of tubes, in such a manner as that described in the embodiments other than the twenty-first embodiment.

The upper connection portion 15 is positioned on the upper side in the gravitational direction of the device heat exchanger 10, while the lower connection portion 16 is positioned on the lower side in the gravitational direction of the device heat exchanger 10. Both the upper connection portion 15 and the lower connection portion 16 are pipe connection portions for causing the working fluid to flow into or from the device heat exchanger 10.

The fluid passage 60 is connected to cause the upper connection portion 15 to communicate with the lower connection portion 16. The heat supply member 100 provided in the fluid passage 60 is configured to be capable of selectively supplying cold heat or hot heat to the working fluid flowing through the fluid passage 60. A coolant-working fluid heat exchanger, a refrigerant-working fluid heat exchanger, a Peltier element, or the like can be adopted as the heat supply member 100, as described in the following embodiments. The heat supply member 100 is provided in the fluid passage 60 at the position in the height direction that overlaps the height of the liquid level FL of the working fluid inside the device heat exchanger 10. Thus, the heat supply member 100 can supply cold heat to the gas-phase working fluid flowing through the fluid passage 60 to condense the working fluid. Thus, the heat supply member 100 can supply hot heat to the liquid-phase working fluid flowing through the fluid passage 60 to evaporate the working fluid.

Next, the operation of the device temperature regulator 1 of the twenty-eighth embodiment will be described.

### <Operation During Cooling>

FIG. 48 shows the flows of the working fluid formed when the device temperature regulator 1 cools the assembled battery by solid line arrows. Note that FIGS. 48 and 49 do not illustrate any assembled battery. When cooling the assembled battery, the heat supply member 100 supplies the cold heat to the working fluid flowing through the fluid passage 60. Thus, when the working fluid in the fluid passage 60 condenses, the liquid-phase working fluid in the fluid passage 60 flows from the lower connection portion 16 into the device heat exchanger 10 due to the head difference between the liquid-phase working fluid condensed in the fluid passage 60 and the liquid-phase working fluid in the device heat exchanger 10. The working fluid in the device heat exchanger 10 absorbs heat from each battery cell 21 included in the assembled battery to evaporate. The battery cells 21 in this process are cooled by the latent heat of evaporation of the working fluid. Thereafter, the working fluids that has been brought into a gas phase flows from the upper connection portion 15 to the fluid passage 60.

When cooling the assembled battery, the working fluid flows from the fluid passage 60 to the lower connection portion 16, the device heat exchanger 10, the upper connection portion 15, and the fluid passage 60 in this order. That is, a loop-shaped flow passage is formed through the device heat exchanger 10 and the fluid passage 60.

### <Operation During Warm-Up>

FIG. 49 shows the flows of the working fluid formed when the device temperature regulator 1 warms up the assembled battery by solid line arrows. When warming up the assembled battery, the heat supply member 100 supplies the hot heat to the working fluid flowing through the fluid passage 60. Thus, the working fluid in the fluid passage 60 evaporates to flow from the upper connection portion 15 into the device heat exchanger 10. The gas-phase working fluid inside the device heat exchanger 10 dissipates heat into each battery cell included in the assembled battery to be condensed. During this process, the battery cells are warmed up. The liquid-phase working fluid in the device heat exchanger 10 flows from the lower connection portion 16 to the fluid passage 60, due to a head difference between the liquid-phase working fluid condensed in the device heat exchanger 10 and the liquid-phase working fluid in the fluid passage 60.

When warming up the assembled battery, the working fluid flows from the fluid passage 60 to the upper connection portion 15, the device heat exchanger 10, and the lower connection portion 16, and the fluid passage 60 in this order. That is, a loop-shaped flow passage is formed through the device heat exchanger 10 and the fluid passage 60.

The device temperature regulator 1 of the twenty-eighth embodiment described above exhibits the following operations and effects.

The device temperature regulator 1 of the twenty-eighth embodiment can perform both warm-up and cooling of the assembled battery by selectively supplying the cold heat or hot heat to the working fluid flowing through the fluid passage 60 using the heat supply member 100. Therefore, the device temperature regulator 1 can be reduced in size, weight and cost by decreasing the number of parts therein and simplifying the configuration of pipes and the like.

This device temperature regulator 1 is also configured to heat the working fluid flowing through the fluid passage 60 located outside the device heat exchanger 10 by using the heat supply member 100 when warming up the assembled battery, like the above-mentioned first to twenty-seventh embodiments. Thus, the steam of the working fluid vaporized in the fluid passage 60 is supplied to the device heat exchanger 10, so that variations in the steam temperature of the working fluid can be suppressed inside the device heat exchanger 10. Therefore, the device temperature regulator 1 can uniformly warm up the assembled battery. Consequently, the device temperature regulator can prevent the degradation in the input and output characteristics of the assembled battery and can also suppress the deterioration and breakage of the assembled battery.

That is, the device temperature regulator 1 forms the loop-shaped flow passage through which the working fluid flows when either cooling or warming up the assembled battery. Consequently, the liquid-phase working fluid and the gas-phase working fluid are prevented from flowing through one flow passage while facing each other. Therefore, the device temperature regulator 1 can perform the warm-up and cooling of the assembled battery with high efficiency by smoothly circulating the working fluid.

In the device temperature regulator 1 of the present embodiment, a space for providing the heat supply member 100 is ensured in the height direction of the fluid passage 60 that connects the upper connection portion 15 and the lower connection portion 16 in the device heat exchanger 10, thus reducing the need to provide pipes and parts under the device heat exchanger 10. Therefore, the device temperature regulator 1 can have improved mountability on the vehicle.

### Twenty-Ninth Embodiment

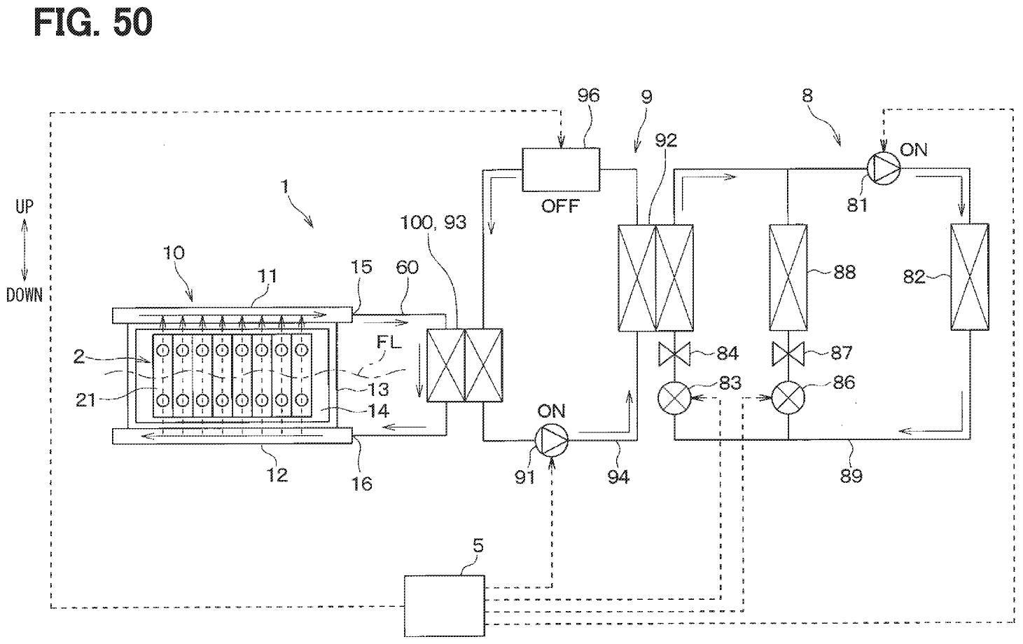

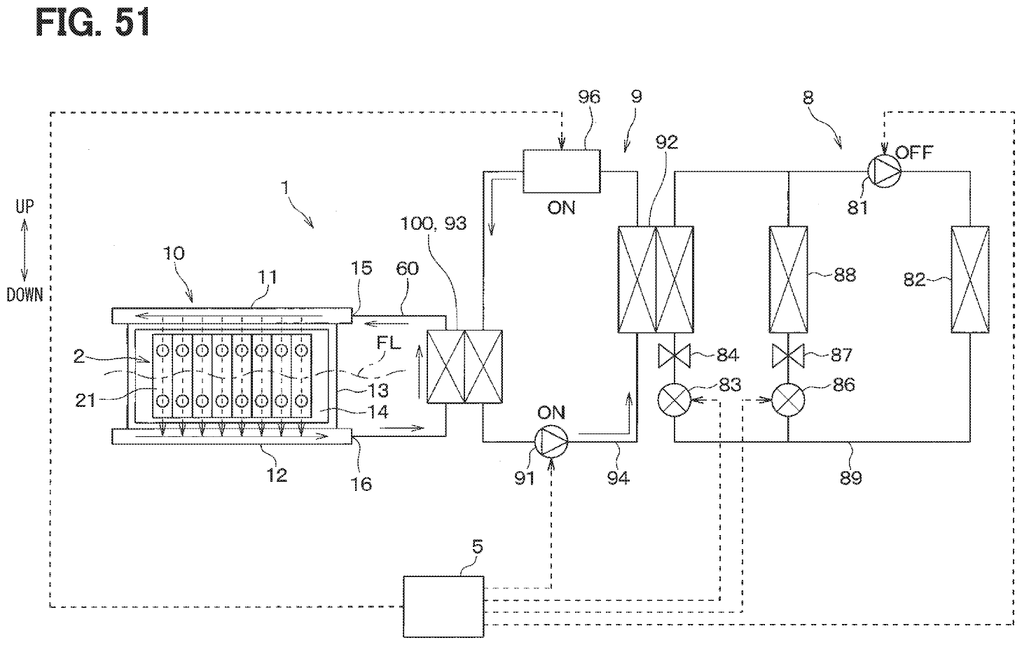

A twenty-ninth embodiment will be described with reference to FIGS. 50 and 51. The twenty-ninth embodiment is obtained by changing the configuration regarding the heat supply member 100 in the twenty-eighth embodiment.

The heat supply member 100 of the present embodiment is the coolant-working fluid heat exchanger 93 and is configured to be selectively switched such that the cold water flows when cooling the assembled battery 2 and that the hot water flows when warming up the assembled battery 2. The device heat exchanger 10 of the present embodiment includes the upper tank 11, the lower tank 12, the heat exchanging portion 13 having a plurality of tubes, and the like.

The device temperature regulator 1 of the present embodiment utilizes the coolant circuit 9. The coolant circuit 9 includes the water pump 91, the coolant radiator 92, the hot coolant heater 96, the coolant-working fluid heat exchanger 93, and the coolant pipe 94 connecting them. The coolant flows through the coolant circuit 9.

The water pump 91 pressure-feeds the coolant and circulates the coolant in the coolant circuit 9. The coolant radiator 92 in the coolant circuit 9 is a chiller that is integrally formed with the evaporator of the refrigeration cycle 8. The coolant radiator 92 is a heat exchanger that exchanges heat between the coolant flowing through the coolant circuit 9 and the low-pressure refrigerant flowing through the refrigeration cycle 8. Therefore, the coolant radiator 92 can cool the coolant flowing through the flow passage of the coolant radiator 92 by heat exchange with the refrigerant flowing through the evaporator included in the refrigeration cycle 8. The coolant flowing out of the coolant radiator 92 flows into the coolant-working fluid heat exchanger 93 via the hot coolant heater 96.

The coolant-working fluid heat exchanger 93 is a heat exchanger that exchanges heat between the working fluid flowing through the fluid passage 60 of the device temperature regulator 1 and the coolant flowing through the coolant circuit 9. The heat supply member 100 of the device temperature regulator 1 of the present embodiment is the coolant-working fluid heat exchanger 93 and can cool and heat the working fluid that flows through the fluid passage 60 of the device temperature regulator 1.

### <Operation During Cooling>

FIG. 50 shows the flows of the working fluid and coolant formed when the device temperature regulator 1 cools the assembled battery 2, by solid line and broken line arrows. When cooling the assembled battery 2, the controller 5 turns on the compressor 81 of the refrigeration cycle 8, opens a first flow rate restriction portion 83, turns off the hot coolant heater 96, and turned on the water pump 91. Thus, the coolant flowing through the coolant circuit 9 is cooled by the coolant radiator 92 integrally formed with the evaporator of the refrigeration cycle 8 and flows through the coolant circuit 9 to be supplied to the coolant-working fluid heat exchanger 93. Consequently, the working fluid flowing through the fluid passage 60 of the device temperature regulator 1 is condensed (i.e., liquefied) in the coolant-working fluid heat exchanger 93 and is then supplied from the lower connection portion 16 to the device heat exchanger 10 due to the head difference between the working fluid inside the device heat exchanger 10 and the working fluid in the fluid passage 60. Thereafter, the working fluid inside the device heat exchanger 10 absorbs heat from the battery cells 21 to evaporate and returns from the upper connection portion 15 to the coolant-working fluid heat exchanger 93 through the fluid passage 60.

### <Operation During Warm-Up>

FIG. 51 shows the flows of the working fluid and coolant formed when the device temperature regulator 1 warms up the assembled battery 2, by solid line and broken line arrows. When warming up the assembled battery 2, the controller 5 turns off the compressor 81 of the refrigeration cycle 8, turns on the hot coolant heater 96, and turned on the water pump 91. Thus, the coolant flowing through the coolant circuit 9 is heated by the hot coolant heater 96, flows through the coolant circuit 9, and is then supplied to the coolant-working fluid heat exchanger 93. At this time, the working fluid flowing through the fluid passage 60 of the device temperature regulator 1 evaporates (i.e., vaporizes) in the coolant-working fluid heat exchanger 93, flows upward, and is then supplied from the upper connection portion 15 to the device heat exchanger 10. Thereafter, the gas-phase working fluid inside the device heat exchanger 10 dissipates heat into the battery cells 21 to be condensed. Due to the head difference between the working fluid condensed in the device heat exchanger 10 and the working fluid in the fluid passage 60, the liquid-phase working fluid in the device heat exchanger 10 returns from the lower connection portion 16 to a coolant-working fluid heat exchanger 93 through the fluid passage 60.

In the twenty-ninth embodiment described above, the device temperature regulator 1 can utilize the coolant-working fluid heat exchanger 93 as the heat supply member 100 that selectively supplies the cold heat or hot heat. Consequently, the temperature of the low-pressure refrigerant flowing through the refrigeration cycle 8 can be set to a temperature that is different from the temperature of the coolant flowing through the coolant circuit 9. Thus, the device temperature regulator 1 can appropriately regulate the temperature of the low-pressure refrigerant flowing through the refrigeration cycle 8 as well as the temperature of the coolant flowing through the coolant circuit 9. Therefore, the amount of cold heat supplied from the coolant flowing through the coolant circuit 9 to the working fluid flowing through the condenser 30 of the device temperature regulator 1 is adjusted, so that the cooling capacity of the device temperature regulator 1 for the assembled battery 2 can be adjusted in accordance with the amount of heat generated from the assembled battery 2.

The device temperature regulator 1 can perform both warm-up and cooling of the assembled battery 2 by selectively supplying the cold heat or hot heat to the working fluid flowing through the fluid passage 60 using the coolant-working fluid heat exchanger 93 as the heat supply member 100. Therefore, the device temperature regulator 1 can be reduced in size, weight and cost by decreasing the number of parts therein and simplifying the configuration of pipes and the like.

In the twenty-ninth embodiment described above, the controller 5 turns off the compressor 81 of the refrigeration cycle 8 when warming up the assembled battery 2.

In a modification thereof, when a low-pressure side heat exchanger 88 of the refrigeration cycle 8 is intended to be used for the air-conditioning of the interior of the vehicle cabin, the compressor 81 may be turned on with the first flow rate restriction portion 83 closed, thereby stopping the supply of the refrigerant to the coolant radiator 92. The means for heating the coolant flowing through the coolant circuit 9 is not limited to the above-described hot coolant heater 96, and instead, a heat pump, waste heat from an in-vehicle device, or the like may be used.

### Thirtieth Embodiment

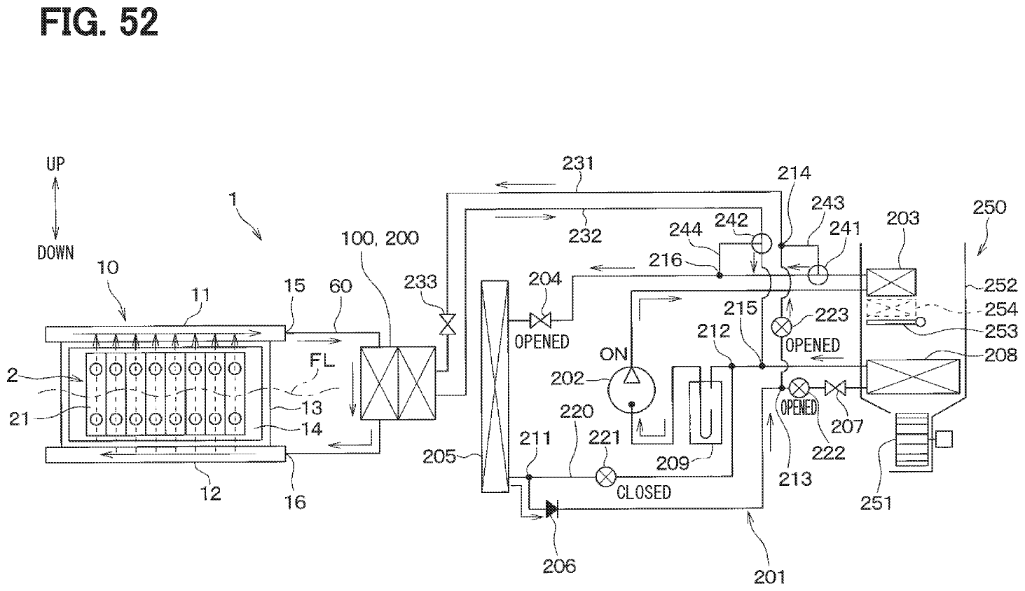

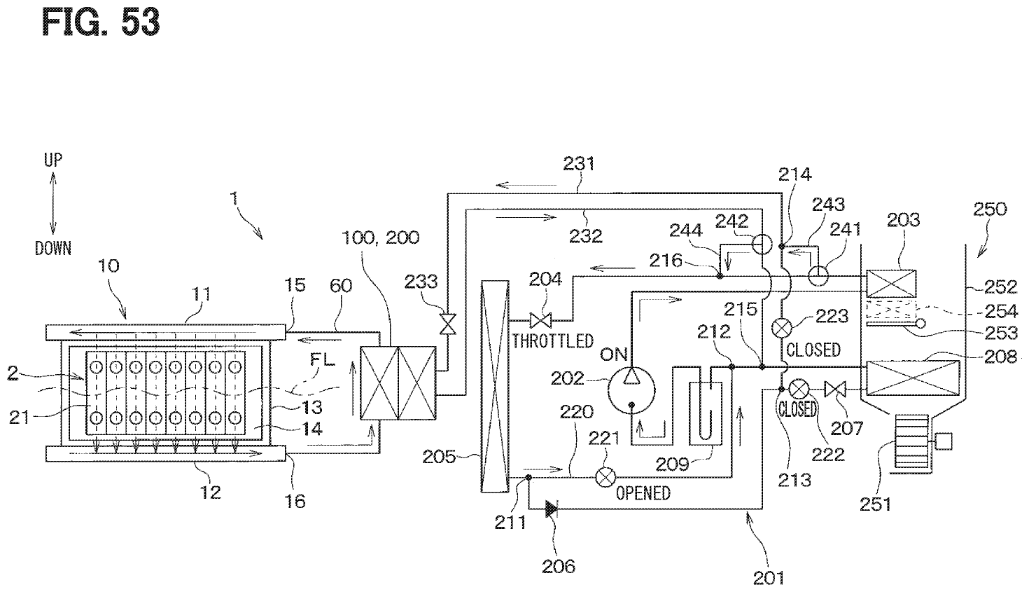

A thirtieth embodiment will be described with reference to FIGS. 52 and 53. The thirtieth embodiment is obtained by changing the configuration regarding the heat supply member 100 in the above-mentioned twenty-eighth and twenty-ninth embodiments. FIGS. 52 and 53 omit the illustration of the controller 5 and signal lines for connecting the controller 5 and the respective devices in order to prevent the complication of the figures.

The heat supply member 100 of the present embodiment is a refrigerant-working fluid heat exchanger 200. The heat supply member 100 is configured to be selectively switched such that the low-temperature and low-pressure refrigerant flows therethrough when cooling the assembled battery 2 and that the high-temperature and high-pressure refrigerant flows therethrough when warming up the assembled battery 2. The device heat exchanger 10 of the present embodiment includes the upper tank 11, the lower tank 12, and the heat exchanging portion 13 having a plurality of tubes.

The device temperature regulator 1 of the present embodiment utilizes the heat pump cycle 201. The heat pump cycle 201 includes the compressor 202, the interior condenser 203, the first expansion valve 204, the exterior unit 205, the check valve 206, the second expansion valve 207, the evaporator 208, the accumulator 209, a refrigerant pipe connecting these components, and the like.

The bypass pipe 220 connects the first branch portion 211 provided between the exterior unit 205 and the check valve 206 to the second branch portion 212 provided between the evaporator 208 and the accumulator 209. The first solenoid valve 221 is provided in the bypass pipe 220, and the second solenoid valve 222 is provided in a refrigerant pipe that connects the check valve 206 and the second expansion valve 207.

The refrigerant-working fluid heat exchanger 200 as the heat supply member 100 is connected to the first pipe 231 and the second pipe 232 for causing the refrigerant to flow to the refrigerant-working fluid heat exchanger 200. The first pipe 231 has one end thereof connected to the refrigerant-working fluid heat exchanger 200 and the other end thereof connected to the third branch portion 213 provided at any point of the refrigerant pipe that connects the check valve 206 and the second solenoid valve 222. The fourth branch portion 214 provided at any point of the first pipe 231 is connected to the pipe 243 that extends from the first three-way valve 241 provided between the interior condenser 203 and the first expansion valve 204. The third expansion valve 233 is provided at any point of the first pipe 231, between the fourth branch portion 214 and the refrigerant-working fluid heat exchanger 200. The third solenoid valve 223 is provided at any point of the first pipe 231 between the fourth branch portion 214 and the third branch portion 213.

The second pipe 232 has one end thereof connected to the refrigerant-working fluid heat exchanger 200 and the other end thereof connected to the fifth branch portion 215 provided at any point of the refrigerant pipe that connects the evaporator 208 and the second branch portion 212. The second three-way valve 242 is provided at any point of the second pipe 232. The pipe 244 extending from the second three-way valve 242 is connected to the sixth branch portion 216 provided between the first three-way valve 241 and the first expansion valve 204.

The interior condenser 203 and the evaporator 208, which are included in the heat pump cycle 201, constitute a part of the HVAC unit 250 for air-conditioning of the interior of the vehicle cabin. The HVAC unit cools an air flowing through a ventilation passage in the air-conditioning case 252 by the air-conditioning blower 251 using the evaporator 208, and heats the air using the interior condenser 203, thereby blowing the resulting conditioned air into the vehicle cabin. The HVAC unit 250 includes the air mix door 253 between the evaporator 208 and the interior condenser 203. The HVAC unit 250 may include the heater core 254.

### <Operation During Cooling>

FIG. 52 shows the flows of the working fluid and refrigerant formed when the device temperature regulator 1 cools the assembled battery 2, by solid line and broken line arrows. During the cooling of the assembled battery 2, the controller 5 switches the first three-way valve 241 to cause the refrigerant to flow from the interior condenser 203 to the first expansion valve 204 and also switches the second three-way valve 242 to cause the refrigerant to flow from the refrigerant-working fluid heat exchanger 200 to the fifth branch portion 215. The controller 5 opens the first expansion valve 204, closes the first solenoid valve 221, opens the second solenoid valve 222 and the third solenoid valve 223, throttles the third expansion valve 233, and turns on the compressor 202.

Thus, the refrigerant discharged from the compressor 202 circulates in the heat pump cycle 201 from the interior condenser 203 to the first expansion valve 204, the exterior unit 205, the check valve 206, the second solenoid valve 222, the second expansion valve 207, the evaporator 208, the accumulator 209, and the compressor 202 in this order within the heat pump cycle 201. Part of the refrigerant circulating in the heat pump cycle 201 flows from the third branch portion 213 to the first pipe 231, the third solenoid valve 223, the third expansion valve 233, the refrigerant-working fluid heat exchanger 200, the second pipe 232, and the fifth branch portion 215 in this order. The refrigerant flowing from the first pipe 231 into the refrigerant-working fluid heat exchanger 200 is decompressed by the third expansion valve 233 into a low-temperature and low-pressure refrigerant, thereby cooling the working fluid flowing through the fluid passage 60 of the device temperature regulator 1. At this time, the working fluid flowing through the fluid passage 60 is condensed (i.e., liquefied) in the refrigerant-working fluid heat exchanger 200 and is then supplied from the lower connection portion 16 to the device heat exchanger 10 due to the head difference between the working fluid inside the fluid passage 60 and the working fluid in the device heat exchanger 10. Thereafter, the working fluid inside the device heat exchanger 10 absorbs heat from the battery cells to evaporate and returns from the upper connection portion 15 to the refrigerant-working fluid heat exchanger 200 through the fluid passage 60.

### <Operation During Warm-Up>

FIG. 53 shows the flows of the working fluid and refrigerant formed when the device temperature regulator 1 warms up the assembled battery 2, by solid line and broken line arrows. During the warm-up of the assembled battery 2, the controller 5 switches the first three-way valve 241 to cause part of the refrigerant to flow from the interior condenser 203 to the fourth branch portion 214 and also switches the second three-way valve 242 to cause the refrigerant to flow from the second pipe 232 to the sixth branch portion 216. The controller 5 throttles the first expansion valve 204, opens the first solenoid valve 221, closes the second solenoid valve 222 and the third solenoid valve 223, opens the third expansion valve 233 or appropriately throttles its opening degree, and turns on the compressor 202.

Thus, the refrigerant discharged from the compressor 202 circulates in the heat pump cycle 201 from the interior condenser 203 to the first expansion valve 204, the exterior unit 205, the first solenoid valve 221, the accumulator 209, and the compressor 202 in this order within the heat pump cycle 201. Part of the refrigerant circulating in the heat pump cycle 201 flows from the first three-way valve 241 to the first pipe 231, the third expansion valve 233, the refrigerant-working fluid heat exchanger 200, the second pipe 232, the second three-way valve 242, and the sixth branch portion 216. The refrigerant flowing from the first pipe 231 into the refrigerant-working fluid heat exchanger 200 is decompressed by the third expansion valve 233 to an appropriate temperature for warm-up of the battery and heats the working fluid flowing through the fluid passage 60 of the device temperature regulator 1. At this time, the working fluid flowing through the fluid passage 60 of the device temperature regulator 1 evaporates (i.e., vaporizes) in the refrigerant-working fluid heat exchanger 200, flows upward, and is then supplied from the upper connection portion 15 to the device heat exchanger 10. Thereafter, the working fluid inside the device heat exchanger 10 dissipates heat into the battery cells 21 to be condensed. Due to a head difference between the working fluid condensed in the device heat exchanger 10 and the working fluid in the fluid passage 60, the liquid-phase working fluid in the device heat exchanger 10 returns from the lower connection portion 16 to the refrigerant-working fluid heat exchanger 200 through the fluid passage 60.

When simultaneously performing air-heating of the interior of the vehicle cabin by the HVAC unit 250 and the warm-up of the assembled battery 2, the opening degree of the third expansion valve 233 needs to be adjusted because the temperature required of the interior condenser 203 is different from the temperature required for the warm-up of the assembled battery 2. When warming up the assembled battery 2 only without any air-conditioning of the interior of the vehicle cabin by the HVAC unit 250, the amount of the refrigerant discharged from the compressor 202 may be adjusted to be an amount of the refrigerant required for the warm-up of the assembled battery 2, and the third expansion valve 233 may be opened.

In the thirtieth embodiment described above, the device temperature regulator 1 can utilize the coolant-working fluid heat exchanger 200 as the heat supply member 100 that selectively supplies the cold heat or hot heat. Thus, the amount of refrigerant circulating in the heat pump cycle 201 or the amount of refrigerant flowing from the heat pump cycle 201 to the refrigerant-working fluid heat exchanger 200 is adjusted, making it possible to adjust the amount of heat supplied to the working fluid flowing through the fluid passage 60 of the device temperature regulator 1. Even by adjusting the opening degree of the third expansion valve 233, the amount of heat supplied to the working fluid flowing through the fluid passage 60 of the device temperature regulator 1 can be adjusted. Therefore, the thirtieth embodiment can appropriately adjust the cooling capacity and warm-up capacity of the device temperature regulator 1 for the assembled battery 2 in accordance with the amount of heat generated by the assembled battery 2. The device temperature regulator 1 can perform both warm-up and cooling of the assembled battery 2 by selectively supplying the cold heat or hot heat to the working fluid flowing through the fluid passage 60 using the heat supply member 100. Therefore, the device temperature regulator 1 can be reduced in size, weight and cost by decreasing the number of parts therein and simplifying the configuration of pipes and the like.

Although the thirtieth embodiment described above uses the heat pump cycle 201 which is utilized for air-conditioning of the interior of the vehicle cabin, the present embodiment is not limited thereto. Alternatively, another heat pump cycle dedicated for the heat supply member 100 of the device temperature regulator 1 may be employed, aside from the heat pump cycle for the air-conditioning of the interior of the vehicle cabin.

### Thirty-First Embodiment

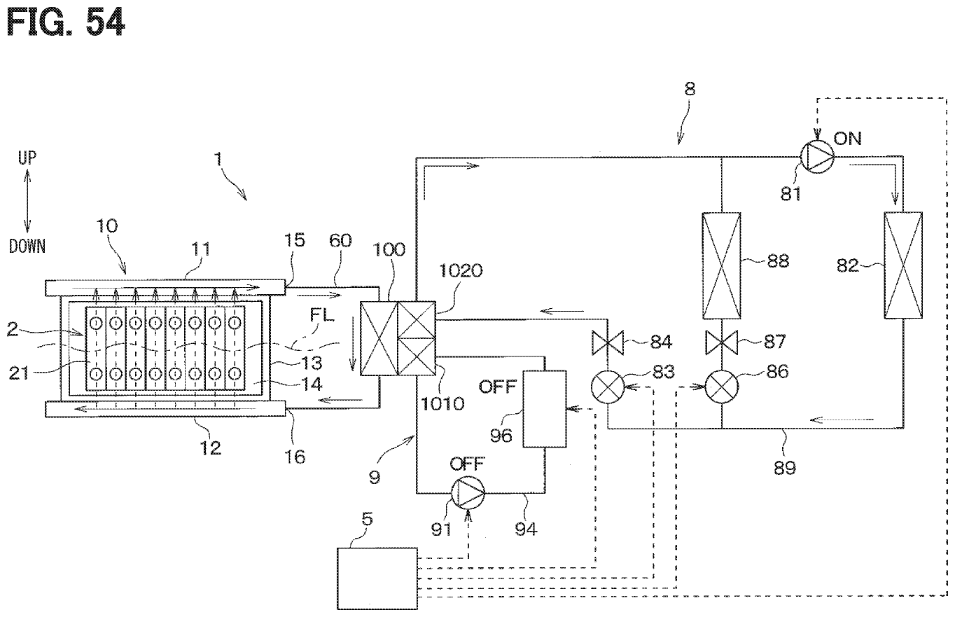

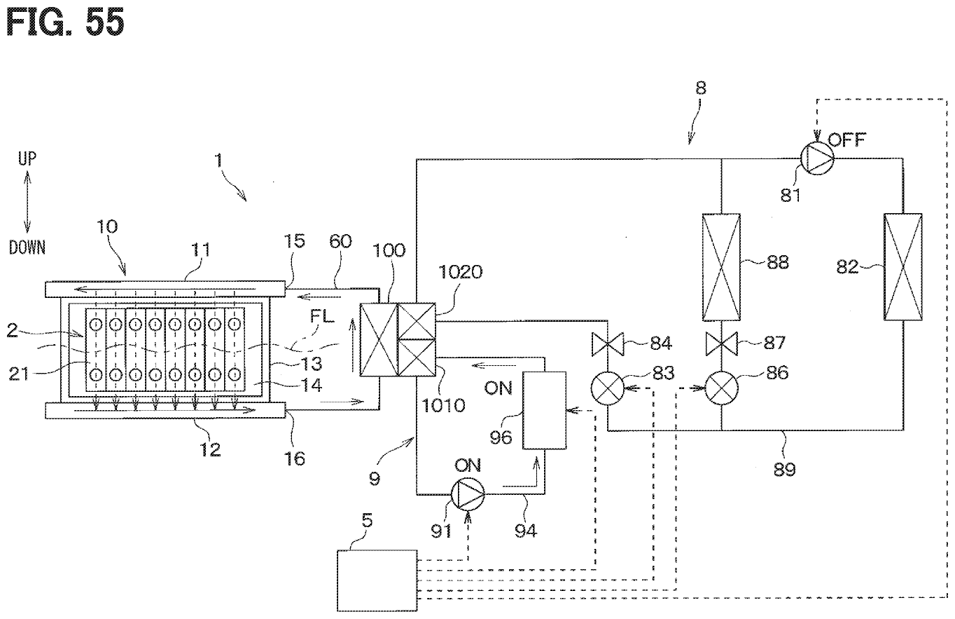

A thirty-first embodiment will be described with reference to FIGS. 54 and 55. The thirty-first embodiment is obtained by changing the configuration regarding the heat supply member 100 in the above-mentioned twenty-ninth embodiment. The heat supply member 100 of the present embodiment includes a coolant-working fluid heat exchanging portion 1010 and a refrigerant-working fluid heat exchanging portion 1020. The coolant-working fluid heat exchanging portion 1010 is disposed on the lower side in the gravitational direction of the heat supply member 100. Meanwhile, the refrigerant-working fluid heat exchanging portion 1020 is disposed on the upper side in the gravitational direction of the heat supply member 100.

The coolant-working fluid heat exchanging portion 1010 is configured to cause the hot water to flow therethrough during warm-up of the assembled battery 2. That is, the coolant-working fluid heat exchanging portion 1010 is an example of a hot heat supply mechanism capable of supplying hot heat to the working fluid flowing through the fluid passage 60. The refrigerant-working fluid heat exchanging portion 1020 is configured to cause the low-temperature and low-pressure refrigerant to flow therethrough during cooling of the assembled battery 2. That is, the refrigerant-working fluid heat exchanging portion 1020 is an example of a cold heat supply mechanism capable of supplying cold heat to the working fluid flowing through the fluid passage 60.

### <Operation During Cooling>

FIG. 54 shows the flows of the working fluid and refrigerant formed when the device temperature regulator 1 cools the assembled battery 2, by solid line and broken line arrows. When cooling the assembled battery 2, the controller 5 turns on the compressor 81 of the refrigeration cycle 8, opens the first flow rate restriction portion 83, and turns off the hot coolant heater 96 and the water pump 91. Thus, the refrigerant in the refrigeration cycle 8 flows from the compressor 81, the high-pressure side heat exchanger 82, the first flow rate restriction portion 83, the first expansion valve 84, the refrigerant-working fluid heat exchanging portion 1020, and the compressor 81 in this order. Therefore, the refrigerant dissipating its heat and condensed in the high-pressure side heat exchanger 82 is decompressed by the first expansion valve 84 into the low-temperature and low-pressure refrigerant, which is then supplied to the refrigerant-working fluid heat exchanging portion 1020 of the heat supply member 100. At this time, the gas-phase working fluid flowing through the fluid passage 60 of the device temperature regulator 1 is condensed (i.e., liquefied) in the refrigerant-working fluid heat exchanging portion 1020 of the heat supply member 100. Then, the working fluid is supplied from the lower connection portion 16 to the device heat exchanger 10 due to the head difference between the working fluid inside the device heat exchanger 10 and the working fluid in the fluid passage 60. Thereafter, the working fluid inside the device heat exchanger 10 absorbs heat from the battery cells 21 to evaporate and returns from the upper connection portion 15 to the heat supply member 100 through the fluid passage 60.

### <Operation During Warm-Up>

FIG. 55 shows the flows of the working fluid and coolant formed when the device temperature regulator 1 warms up the assembled battery 2, by solid line and broken line arrows. When warming up the assembled battery 2, the controller 5 turns off the compressor 81 of the refrigeration cycle 8 and turns on the hot coolant heater 96 and the water pump 91. Thus, the high-temperature coolant heated by the hot coolant heater 96 flows through the coolant circuit 9 to be supplied to the coolant-working fluid heat exchanging portion 1010 of the heat supply member 100. At this time, the liquid-phase working fluid flowing through the fluid passage 60 of the device temperature regulator 1 evaporates (i.e., vaporizes) in the coolant-working fluid heat exchanging portion 1010 of the heat supply member 100 and is then supplied from the upper connection portion 15 to the device heat exchanger 10. Thereafter, the gas-phase working fluid inside the device heat exchanger 10 dissipates heat into the battery cells 21 to be condensed. Due to the head difference between the working fluid condensed in the device heat exchanger 10 and the working fluid in the fluid passage 60, the liquid-phase working fluid in the device heat exchanger 10 returns from the lower connection portion 16 to the heat supply member 100 through the fluid passage 60.

In the thirty-first embodiment described above, the device temperature regulator can utilize the coolant-working fluid heat exchanging portion 1010 and the refrigerant-working fluid heat exchanging portion 1020, as the heat supply member 100. The coolant-working fluid heat exchanging portion 1010 functioning as the hot heat supply mechanism is disposed on the lower side in the gravitational direction of the heat supply member 100. Meanwhile, the refrigerant-working fluid heat exchanging portion 1020 functioning as the cold heat supply mechanism is disposed on the upper side in the gravitational direction of the heat supply member 100.

The heat supply member 100 is provided in the fluid passage 60 at the position in the height direction that overlaps the height of the liquid level FL of the working fluid inside the device heat exchanger 10. Consequently, the gas-phase working fluid is located in the upper portion of the heat supply member 100, while the liquid-phase working fluid is located on the lower portion of the heat supply member 100. Thus, when cooling the assembled battery 2, the cold heat is supplied to the upper portion of the heat supply member 100, so that the cold heat can be surely supplied to the gas-phase working fluid, thus promoting the condensation of the working fluid. When warming up the assembled battery 2, the hot heat is supplied to the lower portion of the heat supply member 100, so that the hot heat can be surely supplied to the liquid-phase working fluid, thus promoting the evaporation of the working fluid.

### Thirty-Second Embodiment

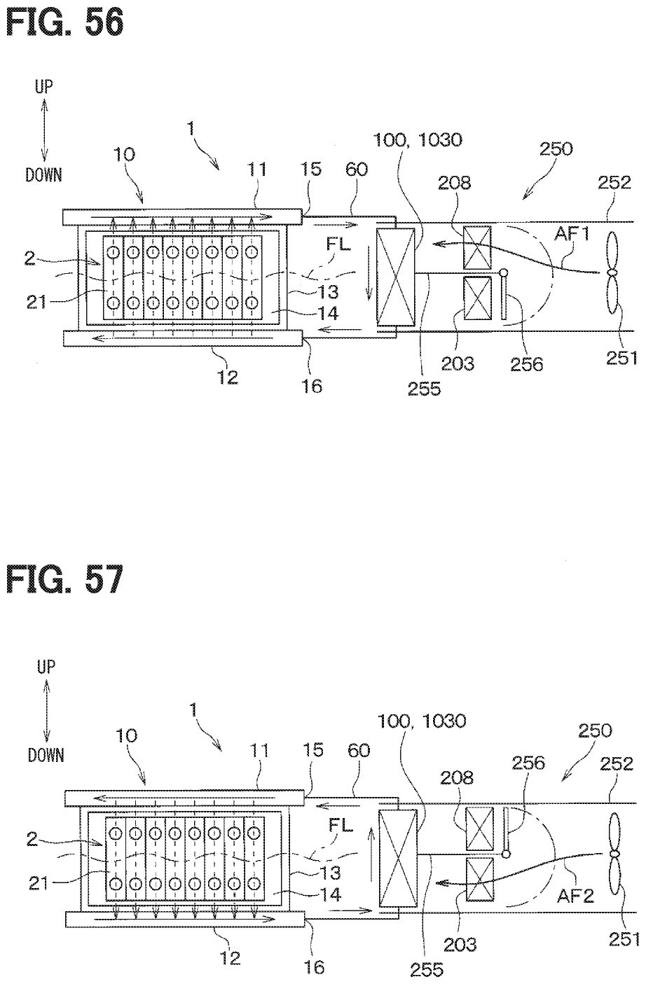

A thirty-second embodiment will be described with reference to FIGS. 56 and 57. The thirty-second embodiment is obtained by changing the configuration regarding the heat supply member 100. The heat supply member 100 of the present embodiment uses an air heat exchanger 1030. The air heat exchanger 1030 is configured such that the cold air is supplied to a portion on the upper side in the gravitational direction of the heat supply member 100 when cooling the assembled battery 2, while the hot air is supplied to a portion on the lower side in the gravitational direction of the heat supply member 100 when warming up the assembled battery 2.

The air heat exchanger 1030 is disposed in the HVAC unit 250. The interior condenser 203 and the evaporator 208 are provided in the air-conditioning case 252 of the HVAC unit 250. A heater core may be installed instead of the interior condenser 203, or a heater core may be installed together with the interior condenser 203. A partition plate 255 for separating the flow of air is provided between the interior condenser 203 and the evaporator 208. The air-conditioning blower 251 and a ventilation passage switching door 256 are provided on the upstream side of the interior condenser 203 and the evaporator 208.

The air heat exchanger 1030 may be disposed outside the air-conditioning case 252 of the HVAC unit 250. In such a case, a duct is provided such that the air having passed through the interior condenser 203 is supplied from the air-conditioning case 252 to the air heat exchanger 1030 and that the air having passed through the evaporator 208 is also supplied from the air-conditioning case 252 to the air heat exchanger 1030.

### <Operation During Cooling>

FIG. 56 shows the flows of the working fluid and air formed when the device temperature regulator 1 cools the assembled battery 2, by solid line and broken line arrows. When cooling the assembled battery 2, the controller 5 blocks the air flow on the interior condenser 203 side and allows the air flow on the evaporator 208 side, by a ventilation passage switching door 256. Thus, the air flows inside the air-conditioning case 252 as indicated by the arrow AF1, so that the air cooled by the evaporator 208 supplies the cold heat to the air heat exchanger 1030. At this time, the gas-phase working fluid flowing through the fluid passage 60 of the device temperature regulator 1 is condensed (i.e., liquefied) in the air heat exchanger 1030 and is then supplied from the lower connection portion 16 to the device heat exchanger 10 due to the head difference between the working fluid inside the device heat exchanger 10 and the working fluid in the fluid passage 60. Thereafter, the working fluid inside the device heat exchanger 10 absorbs heat from the battery cells 21 to evaporate and returns from the upper connection portion 15 to the air heat exchanger 1030 through the fluid passage 60.

### <Operation During Warm-Up>

FIG. 57 shows the flows of the working fluid and air formed when the device temperature regulator 1 warms up the assembled battery 2, by solid line and broken line arrows. When warming up the assembled battery 2, the controller 5 allows the air flow on the interior condenser 203 side and blocks the air flow on the evaporator 208 side, by the ventilation passage switching door 256. Thus, the air flows inside the air-conditioning case 252 as indicated by the arrow AF2, so that the air heated by the interior condenser 203 supplies the hot heat to the air heat exchanger 1030. At this time, the liquid-phase working fluid flowing through the fluid passage 60 of the device temperature regulator 1 evaporates (i.e., vaporizes) in the air heat exchanger 1030 and is then supplied from the upper connection portion 15 to the device heat exchanger 10. Thereafter, the gas-phase working fluid inside the device heat exchanger 10 dissipates heat into the battery cells 21 to be condensed. Due to the head difference between the working fluid condensed in the device heat exchanger 10 and the working fluid in the fluid passage 60, the liquid-phase working fluid in the device heat exchanger 10 returns from the lower connection portion 16 to the air heat exchanger 1030 through the fluid passage 60.

In the thirty-second embodiment described above, the device temperature regulator 1 can utilize the air heat exchanger 1030 as the heat supply member 100. The air heat exchanger 1030 is configured such that the hot heat is supplied to a portion on the lower side in the gravitational direction of the air heat exchanger 1030, while the cold heat air is supplied to a portion on the upper side in the gravitational direction of the air heat exchanger 1030. The heat supply member 100 is provided in the fluid passage 60 at the position in the height direction that overlaps the height of the liquid level FL of the working fluid inside the device heat exchanger 10. Consequently, the gas-phase working fluid is located in the upper portion of the heat supply member 100, while the liquid-phase working fluid is located on the lower portion of the heat supply member 100. Thus, when cooling the assembled battery 2, the cold heat is supplied to the upper portion of the air heat exchanger 1030, so that the cold heat can be surely supplied to the gas-phase working fluid, thus promoting the condensation of the working fluid. When warming up the assembled battery 2, the hot heat is supplied to the lower portion of the air heat exchanger 1030, so that the hot heat can be surely supplied to the liquid-phase working fluid, thus promoting the evaporation of the working fluid.

### Thirty-Third Embodiment

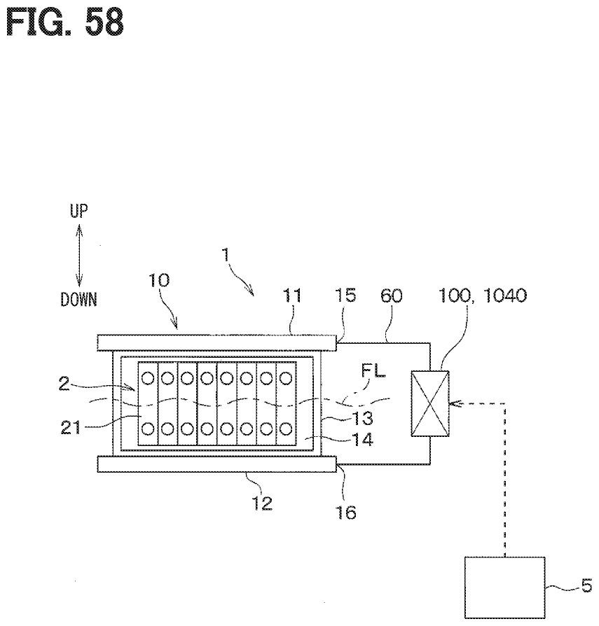

A thirty-third embodiment will be described. As shown in FIG. 58, the heat supply member 100 of the present embodiment is formed by a thermoelectric element 1040. Specifically, the thermoelectric element is, for example, a Peltier element. Also in this configuration, the heat supply member 100 can selectively supply the cold heat or the hot heat to the working fluid flowing through the fluid passage 60.

### Thirty-Fourth Embodiment

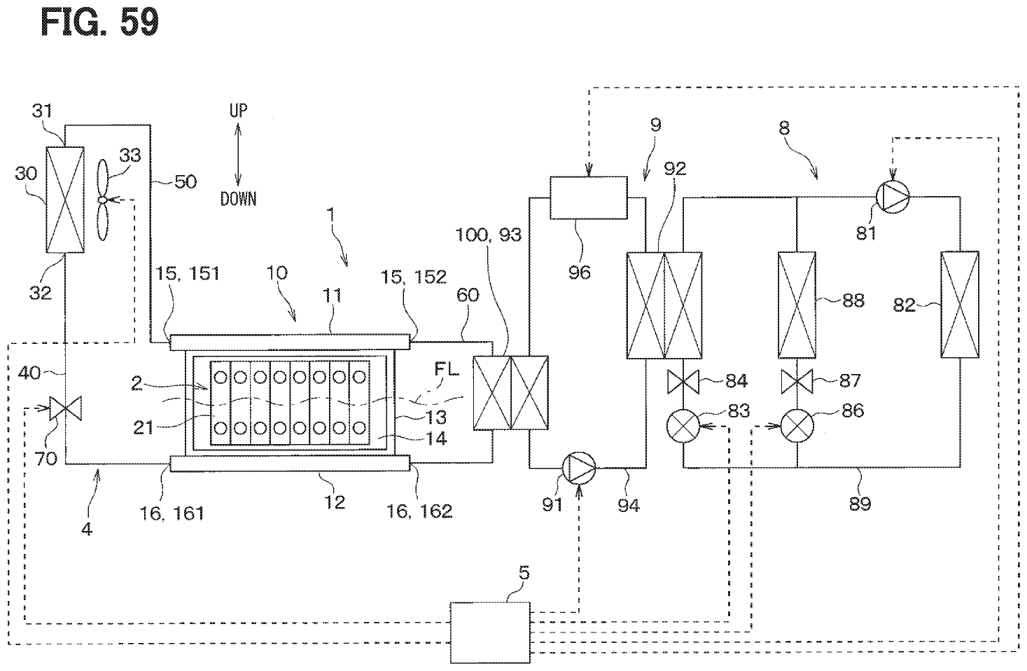

A thirty-fourth embodiment will be described. As shown in FIG. 59, the thirty-fourth embodiment is obtained by adding a condenser 30, a liquid phase passage 40, and a gas phase passage 50 to the configuration described in the twenty-ninth embodiment described above. The configurations of the condenser 30, the liquid phase passage 40, and the gas phase passage 50 are the same as those described in the first embodiment and the like, and thus their descriptions are omitted.

The thirty-fourth embodiment can select the cooling by the condenser 30 or the cooling by the heat supply member 100 depending on the cooling capacity required of the assembled battery 2, the state of a vehicle, or the like. In this way, the above-mentioned first to thirty-fourth embodiments can be arbitrarily combined together.

### OTHER EMBODIMENTS

The present disclosure is not limited to the above-mentioned embodiments, and various modifications and changes can be made to the embodiments as appropriate. The above-mentioned respective embodiments are not irrelevant to each other, and any combination of the embodiments may be implemented as appropriate, except when the combination seems obviously impossible. It is obvious that in the above-mentioned respective embodiments, the elements included in the embodiments are not necessarily essential particularly unless otherwise specified to be essential, except when clearly considered to be essential in principle, and the like. When referring to a specific number about a component in the above-mentioned respective embodiments, including the number, a numerical value, an amount, a range, and the like regarding the component, the component should not be limited to the specific number particularly unless otherwise specified to be essential and except when clearly limited to the specific number in principle. When referring to the shape of a component, the positional relationship between components, and the like in the above-mentioned respective embodiments, the component should not be limited to the shape, positional relationship, or the like unless otherwise specified and except when limited to the specific shape, positional relationship, or the like in principle.

(1) The above-mentioned embodiments have described an example of adopting a fluorocarbon refrigerant as the working fluid, but is not limited thereto. The working fluid may adopt other fluids, such as propane and carbon dioxide, for example.
(2) The above-mentioned embodiments have described an example of employing an electric heater as the heating portion 61, but is not limited thereto. The heating portion 61 may use means capable of heating, such as a heat pump or a Peltier element. The heating portion 61 may use waste heat from other in-vehicle heating devices, such as an SMR (system main relay), for example.
(3) The above-mentioned embodiments have described the assembled battery 2 as an example of the target device that has its temperature adjusted by the device temperature regulator 1, but is not limited thereto. The target device may be any device that requires cooling and warm-up, such as a motor, an inverter, and a charger.

According to a first aspect described in a part or all of the above-mentioned embodiments, a device temperature regulator for regulating a temperature of a target device by a phase change between a liquid phase and a gas phase of a working fluid includes: a device heat exchanger, an upper connection portion, a lower connection portion, a condenser, a gas phase passage, a liquid phase passage, a fluid passage, a heating portion, and a controller. The device heat exchanger is configured to be capable of exchanging heat between the target device and the working fluid such that the working fluid evaporates when cooling the target device and that the working fluid condenses when warming up the target device. The upper connection portion is provided in a portion on an upper side in a gravitational direction of the device heat exchanger, and the working fluid flows into or from the upper connection portion. The lower connection portion is provided in a portion of the device heat exchanger located on a lower side than the upper connection portion in the gravitational direction, and the working fluid flows into or from the lower connection portion. The condenser is disposed above the device heat exchanger in the gravitational direction, and condenses the working fluid by dissipating heat from the working fluid evaporated by the device heat exchanger. The gas phase passage communicates an inflow port through which a gas-phase working fluid flows into the condenser with the upper connection portion of the device heat exchanger. The liquid phase passage communicates an outflow port through which a liquid-phase working fluid flows from the condenser with the lower connection portion of the device heat exchanger. The fluid passage communicates the upper connection portion of the device heat exchanger with the lower connection portion of the device heat exchanger, without including the condenser on a route of the fluid passage. The heating portion is capable of heating the liquid-phase working fluid flowing through the fluid passage. The controller operates the heating portion when heating the target device and stops an operation of the heating portion when cooling the target device.

Thus, the working fluid condensed in the condenser flows from the lower connection portion into the device heat exchanger through the liquid phase passage by its own weight when the operation of the heating portion is stopped. The working fluid absorbs heat from the target device and evaporates within the device heat exchanger. The working fluid that has been brought into the gas phase flows from the upper connection portion to the condenser through the gas phase passage. The working fluid is condensed in the condenser again and flows into the device heat exchanger through the liquid phase passage. By such circulation of the working fluid, the device temperature regulator can cool the target device.

When the heating portion operates, the working fluid in the fluid passage evaporates to flow from the upper connection portion into the device heat exchanger. The gas-phase working fluid in the device heat exchanger dissipates heat into the target device to be condensed. The working fluid that has been brought into the liquid phase flows from the lower connection portion to the fluid passage. The working fluid is heated by the heating portion to evaporate again in the fluid passage and then flows into the device heat exchanger. By such circulation of the working fluid, the device temperature regulator can warm up the target device.

The device temperature regulator is configured to heat the working fluid in the fluid passage provided outside the device heat exchanger by using the heating portion when warming up the target device. Thus, the steam of the working fluid vaporized in the fluid passage is supplied to the device heat exchanger, so that variations in the steam temperature of the working fluid can be suppressed inside the device heat exchanger. Therefore, the device temperature regulator can uniformly warm up the target device. Consequently, when the target device is an assembled battery, the device temperature regulator can prevent the degradation in the input and output characteristics of the assembled battery and can also suppress the deterioration and breakage of the assembled battery.

In the device temperature regulator, when cooling the target device, the working fluid circulates from the condenser to the liquid phase passage, the lower connection portion, the device heat exchanger, the upper connection portion, the gas phase passage, and the condenser in this order. When warming up the target device, the working fluid circulates from the fluid passage to the upper connection portion, the device heat exchanger, the lower connection portion, and the fluid passage in this order. That is, the device temperature regulator forms a loop-shaped flow passage through which the working fluid flows when either cooling or warming up the target device. Consequently, the liquid-phase working fluid and the gas-phase working fluid are prevented from flowing through one flow passage while facing each other. Therefore, the device temperature regulator can perform the warm-up and cooling of the target device with high efficiency by smoothly circulating the working fluid.

In the device temperature regulator, a space for providing the heating portion is ensured in the height direction of the fluid passage that connects the upper connection portion and the lower connection portion in the device heat exchanger, thus reducing the need to provide the heating portion or the like under the device heat exchanger. Therefore, the device temperature regulator can improve its mountability on a vehicle.

According to a second aspect, the device temperature regulator further includes a heat dissipation suppressing portion capable of suppressing heat dissipation of the working fluid by the condenser. Thus, the heat dissipation of the working fluid by the condenser is suppressed by the heat dissipation suppressing portion when warming up the target device, and thereby the working fluid is prevented from circulating from the device heat exchanger to the gas phase passage, the condenser, and the liquid phase passage. Consequently, when warming up the target device, the working fluid can flow to the fluid passage, the upper connection portion, the device heat exchanger, the lower connection portion, and the fluid passage. Therefore, the device temperature regulator can perform the warm-up of the target device with high efficiency by smoothly circulating the working fluid.

According to a third aspect, the heat dissipation suppressing portion is a fluid control valve provided in the liquid phase passage or the gas phase passage. Thus, the fluid control valve blocks the flow of the working fluid in the liquid phase passage or gas phase passage, making it possible to suppress or substantially stop the heat dissipation of the working fluid by the condenser.

According to a fourth aspect, the heat dissipation suppressing portion is a door member capable of blocking ventilation of air passing through the condenser. Thus, the door member blocks the ventilation of the air passing through the condenser, thereby making it possible to suppress or substantially stop the heat dissipation of the working fluid by the condenser.

According to a fifth aspect, the device temperature regulator further includes a refrigeration cycle that includes a compressor, a high-pressure side heat exchanger, an expansion valve, a refrigerant-working fluid heat exchanger, a refrigerant pipe, and a flow rate restriction portion. The compressor compresses a refrigerant. The high-pressure side heat exchanger dissipates heat from the refrigerant compressed by the compressor. The expansion valve decompresses the refrigerant having dissipated heat by the high-pressure side heat exchanger. The refrigerant-working fluid heat exchanger exchanges heat between the refrigerant flowing out of the expansion valve and the working fluid flowing through the condenser. The refrigerant pipe connects the compressor, the high-pressure side heat exchanger, the expansion valve, and the refrigerant-working fluid heat exchanger. The flow rate restriction portion restricts a flow of the refrigerant passing through the refrigerant pipe. The heat dissipation suppressing portion is the flow rate restriction portion included in the refrigeration cycle and is capable of suppressing heat dissipation of the working fluid in the condenser by blocking the flow of the refrigerant passing through the refrigerant pipe.

According to a sixth aspect, the device temperature regulator further includes a coolant circuit that includes a water pump, a coolant radiator, a coolant-working fluid heat exchanger, and a coolant pipe. The water pump pressure-feeds a coolant. The coolant radiator dissipates heat from the coolant pressure-fed by the water pump. The coolant-working fluid heat exchanger exchanges heat between the coolant flowing out of the coolant radiator and the working fluid flowing through the condenser. The coolant pipe connects the water pump, the coolant radiator, and the coolant-working fluid heat exchanger. The heat dissipation suppressing portion is the water pump included in the coolant circuit and is capable of suppressing heat dissipation of the working fluid in the condenser by blocking the flow of the coolant passing through the coolant pipe.

According to a seventh aspect, a device temperature regulator for regulating a temperature of a target device by a phase change between a liquid phase and a gas phase of a working fluid includes: a device heat exchanger, an upper connection portion, a lower connection portion, a fluid passage, a heating portion, and a controller. The device heat exchanger is configured to be capable of exchanging heat between the target device and the working fluid such that the working fluid condenses when warming up the target device. The upper connection portion is provided in a portion on an upper side in a gravitational direction of the device heat exchanger, and the working fluid flows into or from the upper connection portion. The lower connection portion is provided in a portion of the device heat exchanger located on a lower side than the upper connection portion in the gravitational direction, and the working fluid flows into or from the lower connection portion. The fluid passage communicates the upper connection portion of the device heat exchanger with the lower connection portion of the device heat exchanger. The heating portion is capable of heating the liquid-phase working fluid flowing through the fluid passage. The controller operates the heating portion when heating the target device.

The device temperature regulator is configured to heat the working fluid in the fluid passage provided outside the device heat exchanger by using the heating portion when warming up the target device. Thus, the steam of the working fluid vaporized in the fluid passage is supplied to the device heat exchanger, so that variations in the steam temperature of the working fluid can be suppressed inside the device heat exchanger. Therefore, the device temperature regulator can uniformly warm up the target device. Consequently, when the target device is an assembled battery, the device temperature regulator can prevent the degradation in the input and output characteristics of the assembled battery and can also suppress the deterioration and breakage of the assembled battery.

In the device temperature regulator, when warming up the target device, the working fluid circulates from the fluid passage to the upper connection portion, the device heat exchanger, the lower connection portion, and the fluid passage in this order. That is, the device temperature regulator forms a loop-shaped flow passage through which the working fluid flows when warming up the target device. Consequently, the liquid-phase working fluid and the gas-phase working fluid are prevented from flowing through one flow passage while facing each other. Therefore, the device temperature regulator can perform the warm-up of the target device with high efficiency by smoothly circulating the working fluid.

In the device temperature regulator, a space for providing the heating portion is ensured in the height direction of the fluid passage that connects the upper connection portion and the lower connection portion in the device heat exchanger, thus reducing the need to provide the heating portion or the like under the device heat exchanger. Therefore, the device temperature regulator can improve its mountability on a vehicle.

According to an eighth aspect, the heating portion is provided in a portion of the fluid passage that extends vertically in the gravitational direction. Thus, the working fluid heated and vaporized by the heating portion quickly flows through the fluid passage upward in the gravitational direction. Consequently, the gas-phase working fluid is prevented from flowing backward from the fluid passage to the lower connection portion side. Therefore, the device temperature regulator can perform the warm-up of the target device with high efficiency by smoothly circulating the working fluid. According to a ninth aspect, the fluid passage includes a backflow suppression portion that extends downward in the gravitational direction with respect to the heating portion, between the heating portion and the lower connection portion of the device heat exchanger. Thus, the backflow suppression portion, which extends downward in the gravitational direction with respect to the heating portion, can prevent the working fluid heated and vaporized by the heating portion from flowing backward to the lower connection portion side. Therefore, when warming up the target device, the device temperature regulator can cause the working fluid to smoothly circulate from the fluid passage to the upper connection portion, the device heat exchanger, the lower connection portion, and the fluid passage in this order.

According to the tenth aspect, the fluid passage includes a liquid reservoir that stores the liquid-phase working fluid flowing through the fluid passage, at a point of a route of the fluid passage. Thus, the device temperature regulator can store, in the liquid reservoir, the amount of working fluid required to cool and warm up the target device.

According to an eleventh aspect, the liquid reservoir is formed by enlarging an inner diameter of a part of the route of the fluid passage. Thus, the liquid reservoir can be provided with a simple configuration in the fluid passage.

According to a twelfth aspect, at least a part of the liquid reservoir is located within a height range between the upper connection portion and the lower connection portion of the device heat exchanger. Thus, the device temperature regulator adjusts the height of the liquid level of the working fluid in the liquid reservoir, thereby making it possible to easily adjust the height of the liquid level of the working fluid inside the device heat exchanger.

According to a thirteenth aspect, the heating portion is provided in a position that enables heating of the liquid-phase working fluid stored in the liquid reservoir. Thus, the heating efficiency of the heating portion for the working fluid can be enhanced.

According to a fourteenth aspect, the controller heats the target device by repeatedly increasing and decreasing a heating capacity of the heating portion. Thus, when warming up the target device, the warm-up of the target device is promoted if the heating capacity of the heating portion increases, whereas the temperature distribution of the target device becomes small if the heating capacity of the heating portion decreases. Consequently, the controller can warm up the target device, while suppressing the temperature distribution of the target device by repeatedly increasing and decreasing the heating capacity of the heating portion when heating the target device. Therefore, in the case of using the assembled battery as the target device, the device temperature regulator can prevent the current concentration from occurring in a portion of the assembled battery that has a high temperature when the assembled battery is charged or discharged.

According to a fifteenth aspect, the controller has a function of determining a magnitude of a temperature distribution of the target device. The controller decreases the heating capacity of the heating portion when the temperature distribution of the target device is equal to or more than a predetermined first temperature threshold, and the controller increases the heating capacity of the heating portion when the temperature distribution of the target device is equal to or less than a predetermined second temperature threshold. Thus, the controller can prevent the temperature distribution of the target device from becoming larger than the predetermined first temperature threshold.

According to a sixteenth aspect, the controller determines the magnitude of the temperature distribution of the target device based on the heating capacity of the heating portion. Thus, as the heating capacity of the heating portion becomes larger, the flow rate of heat supplied from the heating portion to the target device via the working fluid increases, so that the temperature distribution of the target device becomes larger. On the other hand, as the heating capacity of the heating portion becomes smaller, the flow rate of heat supplied to the target device from the heating portion via the working fluid decreases, so that the temperature distribution of the target device becomes smaller. Therefore, the controller detects the heating capacity of the heating portion and thereby can determine the magnitude of the temperature distribution of the target device with a simple configuration.

According to a seventeenth aspect, the controller heats the target device by intermittently repeating driving and stopping of the heating portion. Thus, when warming up the target device, the warm-up of the target device is promoted by driving the heating portion, and the temperature equalization of the target device is promoted by stopping the driving of the heating portion. In this way, the controller can warm up the target device, while suppressing the temperature distribution of the target device by intermittently repeating the driving and stopping of the heating portion when heating the target device.

According to an eighteenth aspect, the controller has a function of determining a magnitude of a temperature distribution of the target device. The controller stops the operation of the heating portion when the temperature distribution of the target device is equal to or more than a predetermined first temperature threshold. The controller restarts the operation of the heating portion when the temperature distribution of the target device is equal to or less than a predetermined second temperature threshold. Thus, the controller can prevent the temperature distribution of the target device from becoming larger than the predetermined first temperature threshold.

According to a nineteenth aspect, the controller determines a magnitude of a temperature distribution of the target device based on a period of time during which the heating portion continuously operates or a period of time during which the heating portion continuously stops operating. Thus, as the period of time during which the heating portion continuously operates becomes longer, the amount of heat supplied from the heating portion to the target device via the working fluid increases, so that the temperature distribution of the target device becomes larger. On the other hand, as the period of time during which the heating portion continuously stops its operation becomes longer, the temperatures of the respective portions of the target device are equalized, so that the temperature distribution of the target device becomes smaller. Therefore, the controller detects the period of time during which the heating portion continuously operates or stops and thereby can determine the magnitude of the temperature distribution of the target device with a simple configuration.

According to a twentieth aspect, the controller determines a magnitude of a temperature distribution of the target device based on an electric power supplied to the heating portion. Thus, when the heating portion is, for example, a heater, a Peltier element, or the like, as the electric power supplied to the heating portion becomes larger, the flow rate of heat supplied from the heating portion to the target device via the working fluid increases, so that the temperature distribution of the target device becomes larger. On the other hand, as the electric power supplied to the heating portion becomes smaller, the flow rate of heat supplied from the heating portion to the target device via the working fluid decreases, so that the temperature distribution of the target device becomes smaller. Therefore, the controller detects the electric power supplied to the heating portion and thereby can determine the magnitude of the temperature distribution of the target device with a simple configuration.

According to a twenty-first aspect, the heating portion is a coolant-working fluid heat exchanger that is configured to cause hot water to flow when warming up the target device. The controller determines a magnitude of a temperature distribution of the target device based on a heating capacity of the working fluid exhibited by the coolant-working fluid heat exchanger. Thus, as the heating capacity of the working fluid exhibited by the coolant-working fluid heat exchanger becomes larger, the flow rate of heat supplied from the coolant-working fluid heat exchanger to the target device via the working fluid increases, so that the temperature distribution of the target device becomes larger. On the other hand, as the heating capacity of the working fluid exhibited by the coolant-working fluid heat exchanger becomes smaller, the flow rate of heat supplied from the coolant-working fluid heat exchanger to the target device via the working fluid decreases, so that the temperature distribution of the target device becomes smaller. Therefore, the controller detects the heating capacity of the working fluid exhibited by the coolant-working fluid heat exchanger and thereby can determine the magnitude of the temperature distribution of the target device with a simple configuration.

According to a twenty-second aspect, the controller determines a magnitude of a temperature distribution of the target device based on a difference between a temperature of the water flowing through the coolant-working fluid heat exchanger and a temperature of the target device. Thus, as the temperature of the water flowing through the coolant-working fluid heat exchanger (i.e., the temperature of hot water) becomes higher in comparison with the temperature of the target device, the flow rate of heat supplied from the coolant-working fluid heat exchanger to the target device increases, so that the temperature distribution of the target device becomes larger. As a difference between the temperature of water flowing through the coolant-working fluid heat exchanger and the temperature of the target device becomes smaller, the flow rate of heat supplied from the coolant-working fluid heat exchanger to the target device decreases, so that the temperature distribution of the target device becomes smaller. Therefore, the controller detects the temperature of the water flowing through the coolant-working fluid heat exchanger and the temperature of the target device and thereby can determine the magnitude of the temperature distribution of the target device with a simple configuration.

According to a twenty-third aspect, the controller determines a magnitude of a temperature distribution of the target device based on a difference between a temperature of the water flowing through the coolant-working fluid heat exchanger and a temperature of the target device, and on a flow rate of the water flowing through the coolant-working fluid heat exchanger. Thus, as the difference between the temperature of the water flowing through the coolant-working fluid heat exchanger and the temperature of the target device becomes larger, while the flow rate of the water flowing through the coolant-working fluid heat exchanger becomes higher, the flow rate of heat supplied from the coolant-working fluid heat exchanger to the target device increases, so that the temperature distribution of the target device becomes larger. On the other hand, as the difference between the temperature of the water flowing through the coolant-working fluid heat exchanger and the temperature of the target device becomes smaller, while the flow rate of the water flowing through the coolant-working fluid heat exchanger becomes lower, the flow rate of heat supplied from the coolant-working fluid heat exchanger to the target device decreases, so that the temperature distribution of the target device becomes smaller. Therefore, the controller detects the temperature of the water flowing through the coolant-working fluid heat exchanger, the temperature of the target device, and the flow rate of the water flowing through the coolant-working fluid heat exchanger, so that the controller can determine the magnitude of the temperature distribution of the target device with a simple configuration.

According to a twenty-fourth aspect, the heating portion is a refrigerant-working fluid heat exchanger that is configured to cause a refrigerant having a high temperature to flow when warming up the target device. The controller determines a magnitude of a temperature distribution of the target device based on a heating capacity of the working fluid exhibited by the refrigerant-working fluid heat exchanger. Thus, as the heating capacity of the working fluid exhibited by the refrigerant-working fluid heat exchanger becomes larger, the flow rate of heat supplied from the refrigerant-working fluid heat exchanger to the target device via the working fluid increases, so that the temperature distribution of the target device becomes larger. On the other hand, as the heating capacity of the working fluid exhibited by the refrigerant-working fluid heat exchanger becomes smaller, the flow rate of heat supplied from the refrigerant-working fluid heat exchanger to the target device via the working fluid decreases, so that the temperature distribution of the target device becomes smaller. Therefore, the controller detects the heating capacity of the working fluid exhibited by the refrigerant-working fluid heat exchanger and thereby can determine the magnitude of the temperature distribution of the target device with a simple configuration.

According to a twenty-fifth aspect, the controller determines a magnitude of a temperature distribution of the target device based on a difference between a temperature of the refrigerant flowing through the refrigerant-working fluid heat exchanger and a temperature of the target device. Thus, as the difference between the temperature of the refrigerant flowing through the refrigerant-working fluid heat exchanger and the temperature of the target device becomes larger, the flow rate of heat supplied from the refrigerant-working fluid heat exchanger to the target device increases, so that the temperature distribution of the target device becomes larger. On the other hand, as the difference between the temperature of the refrigerant flowing through the refrigerant-working fluid heat exchanger and the temperature of the target device becomes smaller, the flow rate of heat supplied from the refrigerant-working fluid heat exchanger to the target device decreases, so that the temperature distribution of the target device becomes smaller. Therefore, the controller detects the temperature of the refrigerant flowing through the refrigerant-working fluid heat exchanger and the temperature of the target device and thereby can determine the magnitude of the temperature distribution of the target device with a simple configuration.

According to a twenty-sixth aspect, the controller determines a magnitude of a temperature distribution of the target device based on a difference between a temperature of the refrigerant flowing through the refrigerant-working fluid heat exchanger and a temperature of the target device, and on a flow rate of the refrigerant flowing through the refrigerant-working fluid heat exchanger. Thus, as the temperature of the refrigerant flowing through the refrigerant-working fluid heat exchanger becomes higher than the temperature of the target device, while the flow rate of the refrigerant flowing through the refrigerant-working fluid heat exchanger becomes higher, the flow rate of heat supplied from the refrigerant-working fluid heat exchanger to the target device increases, so that the temperature distribution of the target device becomes larger. On the other hand, as the difference between the temperature of the refrigerant flowing through the refrigerant-working fluid heat exchanger and the temperature of the target device becomes smaller, while the flow rate of the refrigerant flowing through the refrigerant-working fluid heat exchanger becomes lower, the flow rate of heat supplied from the refrigerant-working fluid heat exchanger to the target device decreases, so that the temperature distribution of the target device becomes smaller. Therefore, the controller detects the temperature of the refrigerant flowing through the refrigerant-working fluid heat exchanger, the temperature of the target device, and the flow rate of the refrigerant flowing through the refrigerant-working fluid heat exchanger, so that the controller can determine the magnitude of the temperature distribution of the target device with a simple configuration.

According to a twenty-seventh aspect, a device temperature regulator for regulating a temperature of a target device by a phase change between a liquid phase and a gas phase of a working fluid includes a device heat exchanger, an upper connection portion, a lower connection portion, a fluid passage, and a heat supply member. The device heat exchanger is configured to be capable of exchanging heat between the target device and the working fluid such that the working fluid evaporates when cooling the target device and that the working fluid condenses when warming up the target device. The upper connection portion is provided in a portion on an upper side in a gravitational direction of the device heat exchanger, and the working fluid flows into or from the upper connection portion. The lower connection portion is provided in a portion of the device heat exchanger located on a lower side than the upper connection portion in the gravitational direction, and the working fluid flows into or from the lower connection portion. The fluid passage communicates the upper connection portion of the device heat exchanger with the lower connection portion of the device heat exchanger. The heat supply member is provided in the fluid passage at a position in the height direction that overlaps a height of a liquid level of the working fluid inside the device heat exchanger. The heat supply member is capable of selectively supplying cold heat or hot heat to the working fluid flowing through the fluid passage.

Thus, the device temperature regulator can perform both warm-up and cooling of the target device by selectively supplying the cold heat or hot heat to the working fluid flowing through the fluid passage using the heat supply member. Therefore, the device temperature regulator can be reduced in size, weight and cost by decreasing the number of parts therein and simplifying the configuration of pipes and the like.

Specifically, in the device temperature regulator, the working fluid in the fluid passage is condensed when the cold heat is supplied from the heat supply member to the working fluid flowing through the fluid passage while cooling the target device. Then, the liquid-phase working fluid in the fluid passage flows from the lower connection portion into the device heat exchanger due to a head difference between the liquid-phase working fluid condensed in the fluid passage and the liquid-phase working fluid in the device heat exchanger. The working fluid inside the device heat exchanger absorbs heat from the target device to evaporate, and then the working fluid that has been brought into the gas phase flows from the upper connection portion to the fluid passage. The working fluid in the fluid passage is cooled and condensed again by the heat supply member, and then flows from the lower connection portion into the device heat exchanger. By such circulation of the working fluid, the device temperature regulator can cool the target device.

The working fluid in the fluid passage evaporates to flow from the upper connection portion into the device heat exchanger when the hot heat is supplied from the heat supply member to the working fluid flowing through the fluid passage while warming up the target device. The gas-phase working fluid dissipates heat into the target device to be condensed within the device heat exchanger. The liquid-phase working fluid in the device heat exchanger flows from the lower connection portion to the fluid passage due to a head difference between the liquid-phase working fluid condensed in the device heat exchanger and the liquid-phase working fluid in the fluid passage. The working fluid is heated by the heat supply member to evaporate again in the fluid passage and then flows into the device heat exchanger. By such circulation of the working fluid, the device temperature regulator can warm up the target device.

The device temperature regulator is configured to heat the working fluid in the fluid passage provided outside the device heat exchanger by using the heat supply member when warming up the target device. Because of this configuration, the steam of the working fluid vaporized in the fluid passage is supplied to the device heat exchanger, so that variations in the steam temperature of the working fluid is suppressed inside the device heat exchanger. Therefore, the device temperature regulator can uniformly warm up the target device. Consequently, when the target device is an assembled battery, the device temperature regulator can prevent the degradation in the input and output characteristics of the assembled battery and can also suppress the deterioration and breakage of the assembled battery.

In the device temperature regulator, when cooling the target device, the working fluid circulates from the fluid passage to the lower connection portion, the device heat exchanger, the upper connection portion, and the fluid passage in this order. When warming up the target device, the working fluid circulates from the fluid passage to the upper connection portion, the device heat exchanger, the lower connection portion, and the fluid passage in this order. That is, the device temperature regulator forms a loop-shaped flow passage through which the working fluid flows when either cooling or warming up the target device. Consequently, the liquid-phase working fluid and the gas-phase working fluid are prevented from flowing through one flow passage while facing each other. Therefore, the device temperature regulator can perform the warm-up and cooling of the target device with high efficiency by smoothly circulating the working fluid.

In the device temperature regulator, a space for providing the heat supply member is ensured in the height direction of the fluid passage that connects the upper connection portion and the lower connection portion in the device heat exchanger, thus reducing the need to provide pipes and parts under the device heat exchanger. Therefore, the device temperature regulator can improve its mountability on a vehicle.

According to a twenty-eighth aspect, the heat supply member is a coolant-working fluid heat exchanger. The coolant-working fluid heat exchanger is configured to be selectively switched such that cold water flows to supply the cold heat to the working fluid when cooling the target device and that hot water flows to supply the hot heat to the working fluid when warming up the target device. Thus, the coolant-working fluid heat exchanger can be used as the heat supply member that selectively supplies the cold heat or hot heat.

According to a twenty-ninth aspect, the heat supply member is a refrigerant-working fluid heat exchanger. The refrigerant-working fluid heat exchanger is configured to be selectively switched such that a low-temperature and low-pressure refrigerant flows to supply the cold heat to the working fluid when cooling the target device and that a high-temperature and high-pressure refrigerant flows to supply the hot heat to the working fluid when warming up the target device. Thus, the refrigerant-working fluid heat exchanger can be used as the heat supply member that selectively supplies the cold heat or hot heat.

According to a thirtieth aspect, a cold heat supply mechanism capable of supplying the cold heat to the working fluid flowing through the fluid passage is disposed on an upper side in the gravitational direction of the heat supply member. A hot heat supply mechanism capable of supplying the hot heat to the working fluid flowing through the fluid passage is disposed on a lower side in the gravitational direction of the heat supply member. Thus, the cold heat is surely supplied from the refrigerant-working fluid heat exchanging portion to the gas-phase working fluid flowing through the fluid passage when cooling the target device, making it possible to promote the condensation of the working fluid. Thus, the hot heat is surely supplied from the coolant-working fluid heat exchanging portion to the liquid-phase working fluid flowing through the fluid passage when warming up the target device, making it possible to promote the evaporation of the working fluid.

According to a thirty-first aspect, the cold heat supply mechanism is a refrigerant-working fluid heat exchanging portion through which a low-temperature and low-pressure refrigerant flows when cooling the target device. Meanwhile, the hot heat supply mechanism is a coolant-working fluid heat exchanging portion through which hot water flows when warming up the target device. Thus, the refrigerant-working fluid heat exchanger can be used as the cold heat supply mechanism, while the coolant-working fluid heat exchanger can be used as the hot heat supply mechanism.

According to a thirty-second aspect, the heat supply member is an air heat exchanger and is configured such that cold air is supplied to a portion on an upper side in the gravitational direction of the heat supply member when cooling the target device, and that hot air is supplied to a portion on a lower side in the gravitational direction of the heat supply member when warming up the target device. Thus, the liquid-phase working fluid flowing through the air heat exchanger can be heated with the hot air when warming up the target device. The gas-phase working fluid flowing through the air heat exchanger can be cooled with the cold air when cooling the target device.

According to a thirty-third aspect, the heat supply member is formed by a thermoelectric element. Thus, the thermoelectric element, such as a Peltier element, can be used as the heat supply member that selectively supplies the cold heat or hot heat.

According to a thirty-fourth aspect, the device temperature regulator further includes a condenser, a gas phase passage, and a liquid phase passage. The condenser is disposed above the device heat exchanger in the gravitational direction, and condenses the working fluid by dissipating heat from the working fluid evaporated by the device heat exchanger. The gas phase passage communicates an inflow port through which a gas-phase working fluid flows into the condenser with the upper connection portion of the device heat exchanger. The liquid phase passage communicates an outflow port through which a liquid-phase working fluid flows from the condenser with the lower connection portion of the device heat exchanger. The above-mentioned fluid passage communicates the upper connection portion of the device heat exchanger with the lower connection portion of the device heat exchanger, without including the condenser on a route of the fluid passage. Thus, the device temperature regulator can add a cooling function of the target device using the condenser disposed above the device temperature regulator in the gravitational direction, to the warm-up function and the cooling function exhibited by the heat supply member for the target device.

What is claimed is:

1. A device temperature regulator configured to regulate a temperature of a target device by a phase change between a liquid phase and a gas phase of a working fluid, the device temperature regulator comprising:
a device heat exchanger configured to be capable of exchanging heat between the target device and the working fluid such that the working fluid evaporates when cooling the target device and that the working fluid condenses when warming up the target device;
an upper connection portion into or from which the working fluid flows, the upper connection portion being provided in a portion of the device heat exchanger at an upper side in a gravitational direction;
a lower connection portion into or from which the working fluid flows, the lower connection portion being provided in a portion of the device heat exchanger at a position lower than the upper connection portion in the gravitational direction;
a condenser disposed above the device heat exchanger in the gravitational direction, the condenser being configured to condense the working fluid by dissipating heat from the working fluid evaporated by the device heat exchanger;
a gas phase passage that communicates an inflow port through which a gas-phase working fluid flows into the condenser with the upper connection portion of the device heat exchanger;
a liquid phase passage that communicates an outflow port, through which a liquid-phase working fluid flows from the condenser, with the lower connection portion of the device heat exchanger;
a fluid passage that communicates the upper connection portion of the device heat exchanger with the lower connection portion of the device heat exchanger, without including the condenser on a route of the fluid passage;
a heating portion capable of heating the liquid-phase working fluid flowing through the fluid passage; and
a controller configured to operate the heating portion when heating the target device, and to stop an operation of the heating portion when cooling the target device.

2. The device temperature regulator according to claim 1, further comprising:
a heat dissipation suppressing portion configured to suppress heat dissipation of the working fluid by the condenser.

3. The device temperature regulator according to claim 2, wherein
the heat dissipation suppressing portion is a fluid control valve provided in the liquid phase passage or the gas phase passage.

4. The device temperature regulator according to claim 2, wherein
the heat dissipation suppressing portion is a door member capable of blocking ventilation of air passing through the condenser.

5. The device temperature regulator according to claim 2, further comprising:
a refrigeration cycle comprising:
a compressor configured to compress a refrigerant; a high-pressure side heat exchanger configured to dissipate heat from the refrigerant compressed by the compressor;
an expansion valve configured to decompress the refrigerant having dissipated heat by the high-pressure side heat exchanger;
a refrigerant-working fluid heat exchanger configured to exchange heat between the refrigerant flowing out of the expansion valve and the working fluid flowing through the condenser;
a refrigerant pipe connecting the compressor, the high-pressure side heat exchanger, the expansion valve and the refrigerant-working fluid heat exchanger; and
a flow rate restriction portion configured to restrict a flow of the refrigerant passing through the refrigerant pipe, wherein
the heat dissipation suppressing portion is the flow rate restriction portion included in the refrigeration cycle and is capable of suppressing heat dissipation of the working fluid in the condenser by blocking the flow of the refrigerant passing through the refrigerant pipe.

6. The device temperature regulator according to claim 2, further comprising:
a coolant circuit comprising:
a water pump configured to pressure-feed a coolant;
a coolant radiator configured to dissipate heat from the coolant pressure-fed by the water pump;
a coolant-working fluid heat exchanger configured to exchange heat between the coolant flowing out of the coolant radiator and the working fluid flowing through the condenser; and a coolant pipe connecting the water pump, the coolant radiator, and the coolant-working fluid heat exchanger, wherein
the heat dissipation suppressing portion is the water pump included in the coolant circuit and is capable of suppressing heat dissipation of the working fluid in the condenser by blocking the flow of the coolant passing through the coolant pipe.

7. A device temperature regulator configured to regulate a temperature of a target device by a phase change between a liquid phase and a gas phase of a working fluid, the device temperature regulator comprising:
a device heat exchanger configured to be capable of exchanging heat between the target device and the working fluid such that the working fluid condenses when warming up the target device;
an upper connection portion into or from which the working fluid flows, the upper connection portion being provided in a portion of the device heat exchanger at an upper side in a gravitational direction of the device heat exchanger;
a lower connection portion into or from which the working fluid flows, the lower connection portion being provided in a portion of the device heat exchanger at a position lower than the upper connection portion in the gravitational direction;
a fluid passage that communicates the upper connection portion of the device heat exchanger with the lower connection portion of the device heat exchanger;
a heating portion configured to be capable of heating the liquid-phase working fluid flowing through the fluid passage; and
a controller configured to operate the heating portion when heating the target device, wherein
the heating portion is provided in a portion of the fluid passage that extends vertically in the gravitational direction.

8. The device temperature regulator according to claim 1, wherein
the fluid passage includes a backflow suppression portion configured to extend downward in the gravitational direction with respect to the heating portion, between the heating portion and the lower connection portion of the device heat exchanger.

9. The device temperature regulator according to claim 1, wherein
the fluid passage includes a liquid reservoir configured to store the liquid-phase working fluid flowing through the fluid passage, at a point of a route in the fluid passage.

10. The device temperature regulator according to claim 9, wherein
the liquid reservoir is provided by enlarging an inner diameter of a part of the route of the fluid passage.

11. The device temperature regulator according to claim 9, wherein
at least a part of the liquid reservoir is located within a height range between the upper connection portion and the lower connection portion of the device heat exchanger.

12. The device temperature regulator according to claim 9, wherein
the heating portion is provided in a position that enables heating of the liquid-phase working fluid stored in the liquid reservoir.

13. The device temperature regulator according to claim 1, wherein
the controller is configured to heat the target device by repeatedly increasing and decreasing a heating capacity of the heating portion.

14. The device temperature regulator according to claim 13, wherein
the controller is configured to have a function of determining a magnitude of a temperature distribution of the target device,
the controller decreases the heating capacity of the heating portion when the temperature distribution of the target device is equal to or more than a predetermined first temperature threshold, and
the controller increases the heating capacity of the heating portion when the temperature distribution of the target device is equal to or less than a predetermined second temperature threshold.

15. The device temperature regulator according to claim 13, wherein
the controller is configured to determine the magnitude of the temperature distribution of the target device based on the heating capacity of the heating portion.

16. The device temperature regulator according to claim 1, wherein
the controller is configured to heat the target device by intermittently repeating driving and stopping of the heating portion.

17. The device temperature regulator according to claim 16, wherein
the controller is configured to have a function of determining a magnitude of a temperature distribution of the target device,
the controller stops an operation of the heating portion when the temperature distribution of the target device is equal to or more than a predetermined first temperature threshold, and
the controller restarts the operation of the heating portion when the temperature distribution of the target device is equal to or less than a predetermined second temperature threshold.

18. The device temperature regulator according to claim 16, wherein
the controller is configured to determine a magnitude of a temperature distribution of the target device based on a period of time during which the heating portion continuously operates or a period of time during which the heating portion continuously stops operating.

19. The device temperature regulator according to claim 13, wherein
the controller is configured to determine a magnitude of a temperature distribution of the target device based on an electric power supplied to the heating portion.

20. The device temperature regulator according to claim 13, wherein
the heating portion is a coolant-working fluid heat exchanger that is configured to cause a heated coolant to flow when warming up the target device, and
the controller is configured determine a magnitude of a temperature distribution of the target device based on a heating capacity of the working fluid exhibited by the coolant-working fluid heat exchanger.

21. The device temperature regulator according to claim 20, wherein
the controller is configured to determine a magnitude of a temperature distribution of the target device based on a difference between a temperature of the coolant flowing through the coolant-working fluid heat exchanger and a temperature of the target device.

22. The device temperature regulator according to claim 20, wherein
the controller is configured to determine a magnitude of a temperature distribution of the target device based on a difference between a temperature of the coolant flowing through the coolant-working fluid heat exchanger and a temperature of the target device, and on a flow rate of the coolant flowing through the coolant-working fluid heat exchanger.

23. The device temperature regulator according to claim 13, wherein
the heating portion is a refrigerant-working fluid heat exchanger that is configured to cause a refrigerant having a high temperature to flow when warming up the target device, and
the controller is configured to determine a magnitude of a temperature distribution of the target device based on a heating capacity of the working fluid exhibited by the refrigerant-working fluid heat exchanger.

24. The device temperature regulator according to claim 23, wherein
the controller is configured to determine a magnitude of a temperature distribution of the target device based on a difference between a temperature of the refrigerant flowing through the refrigerant-working fluid heat exchanger and a temperature of the target device.

25. The device temperature regulator according to claim 23, wherein
the controller is configured to determine a magnitude of a temperature distribution of the target device based on a difference between a temperature of the refrigerant flowing through the refrigerant-working fluid heat exchanger and a temperature of the target device, and on a flow rate of the refrigerant flowing through the refrigerant-working fluid heat exchanger.

26. A device temperature regulator configured to regulate a temperature of a target device by a phase change between a liquid phase and a gas phase of a working fluid, the device temperature regulator comprising:
a device heat exchanger configured to be capable of exchanging heat between the target device and the working fluid such that the working fluid evaporates when cooling the target device and that the working fluid condenses when warming up the target device;
an upper connection portion into or from which the working fluid flows, the upper connection portion being provided in a portion of the device heat exchanger at an upper side in a gravitational direction;
a lower connection portion into or from which the working fluid flows, the lower connection portion being provided in a portion of the device heat exchanger at a position lower than the upper connection portion in the gravitational direction;
a fluid passage that communicates the upper connection portion of the device heat exchanger with the lower connection portion of the device heat exchanger; and
a heat supply member provided in the fluid passage at a position in a height direction that overlaps a height of a liquid level of the working fluid inside the device heat exchanger, the heat supply member being capable of selectively supplying cold heat or hot heat to the working fluid flowing through the fluid passage.

27. The device temperature regulator according to claim 26, wherein
the heat supply member is a coolant-working fluid heat exchanger and is configured to be selectively switched such that cold coolant flows to supply the cold heat to the working fluid when cooling the target device and that hot coolant flows to supply the hot heat to the working fluid when warming up the target device.

28. The device temperature regulator according to claim 26, wherein
the heat supply member is a refrigerant-working fluid heat exchanger and is configured to be selectively switched such that a low-temperature and low-pressure refrigerant flows to supply the cold heat to the working fluid when cooling the target device and that a high-temperature and high-pressure refrigerant flows to supply the hot heat to the working fluid when warming up the target device.

29. The device temperature regulator according to claim 26, wherein
a cold heat supply mechanism capable of supplying the cold heat to the working fluid flowing through the fluid passage is disposed on an upper side in the gravitational direction of the heat supply member, and a hot heat supply mechanism capable of supplying the hot heat to the working fluid flowing through the fluid passage is disposed on a lower side in the gravitational direction of the heat supply member.

30. The device temperature regulator according to claim 29, wherein
the cold heat supply mechanism is a refrigerant-working fluid heat exchanging portion through which a low-temperature and low-pressure refrigerant flows when cooling the target device, and
the hot heat supply mechanism is a coolant-working fluid heat exchanging portion through which hot coolant flows when warming up the target device.

31. The device temperature regulator according to claim 26, wherein
the heat supply member is an air heat exchanger and is configured such that cold air is supplied to a portion on an upper side in the gravitational direction of the heat supply member when cooling the target device, and that hot air is supplied to a portion on a lower side in the gravitational direction of the heat supply member when warming up the target device.

32. The device temperature regulator according to claim 26, wherein
the heat supply member is made of a thermoelectric element.

33. The device temperature regulator according to claim 26, further comprising:
a condenser disposed above the device heat exchanger in the gravitational direction, the condenser being configured to condense the working fluid by dissipating heat from the working fluid evaporated by the device heat exchanger;
a gas phase passage that communicates an inflow port through which a gas-phase working fluid flows into the condenser with the upper connection portion of the device heat exchanger; and
a liquid phase passage that communicates an outflow port through which a liquid-phase working fluid flows from the condenser with the lower connection portion of the device heat exchanger, wherein
the fluid passage communicates the upper connection portion of the device heat exchanger with the lower connection portion of the device heat exchanger without including the condenser on a route of the fluid passage.
